(19) United States
(12) Patent Application Publication
(10) Pub. No.: US 2014/0035995 A1
(43) Pub. Date: Feb. 6, 2014

(54) AEROSOL JET PRINTABLE METAL CONDUCTIVE INKS, GLASS COATED METAL CONDUCTIVE INKS AND UV-CURABLE DIELECTRIC INKS AND METHODS OF PREPARING AND PRINTING THE SAME

(71) Applicants: Joe Chou, San Mateo, CA (US); Michael Mcallister, Rutherford, NJ (US); Philippe Schottland, Sparta, NJ (US)

(72) Inventors: Joe Chou, San Mateo, CA (US); Michael Mcallister, Rutherford, NJ (US); Philippe Schottland, Sparta, NJ (US)

(73) Assignee: Sun Chemical Corporation, Parsippany, NJ (US)

(21) Appl. No.: 13/992,532

(22) PCT Filed: Dec. 7, 2011
(86) PCT No.: PCT/US2011/063847

§ 371 Date: Oct. 15, 2013

Related U.S. Application Data
(60) Provisional application No. 61/420,404, filed on Dec. 7, 2010.
(60) Provisional application No. 61/424,381, filed on Dec. 17, 2010.
(60) Provisional application No. 61/442,478, filed on Feb. 14, 2011.
(60) Provisional application No. 61/450,163, filed on Mar. 8, 2011.

(51) Int. Cl. C09D 11/00; B41J 2/01

(52) U.S. Cl. CPC C09D 11/52; B41J 2/01
USPC 347/20; 252/512; 252/514; 252/513; 252/515

(57) ABSTRACT

Provided are aerosol jet uncoated and coated (e.g., glass-coated) metal conductive ink compositions that can be deposited onto a substrate using, for example, aerosol jet printing and direct-write methods such as Aerosol Jet (e.g., Optomec M ³D) deposition and methods of aerosol jet deposition of the aerosol jet uncoated and coated metal conductive ink compositions. Also provided are aerosol jet UV curable dielectric ink compositions that exhibit transparency, storage stability, and very good print quality and print stability, thereby enabling the formation of very fine dielectric features on a variety of substrates.

### RELATED APPLICATIONS

Benefit of priority is claimed to U.S. Provisional Application Ser. No. 61/420,404, filed Dec. 7, 2010, entitled “AEROSOL JET METAL CONDUCTIVE INKS & A METHOD OF PREPARING AND PRINTING SAME,” to Joe Chou, Michael McAllister and Philippe Schottland; and to U.S. Provisional Application Ser. No. 61/424,381, filed Dec. 17, 2010, entitled “AEROSOL JET GLASS METAL CONDUCTIVE INKS AND METHOD OF PREPARING AND PRINTING SAME,” to Joe Chou and Philippe Schottland; and to U.S. Provisional Application Ser. No. 61/442,478, filed Feb. 14, 2011, entitled “AEROSOL JET METAL CONDUCTIVE INKS & A METHOD OF PREPARING AND PRINTING SAME,” to Joe Chou, Michael McAllister and Philippe Schottland; and to U.S. Provisional Application Ser. No. 61/450,163, filed Mar. 8, 2011, entitled “AEROSOL PRINTABLE UV-CURABLE DIELECTRIC INK,” to Joe Chou and Michael McAllister.

Where permitted, the subject matter of each of the above-referenced applications is incorporated by reference in its entirety.

### FIELD OF THE INVENTION

The invention relates to aerosol jet ink compositions for aerosol jet printing, including aerosol jet metal conductive inks, aerosol jet glass coated metal conductive inks and aerosol jet UV curable dielectric inks, that can be deposited onto a substrate using, for example, aerosol direct-write methods such as aerosol jet (e.g., Optomec M³D) deposition; and methods of preparing and using aerosol jet metal conductive inks, aerosol jet glass coated metal conductive inks and aerosol jet UV curable dielectric inks.

### BACKGROUND

The energy, electronics, and display industries rely on the coating and patterning of conductive materials to form circuits, conductive lines or features on organic and inorganic substrates. Currently, the primary printing method for producing conductive patterns on organic and inorganic substrates for features larger than about 100 μm is screen printing. Thin film and etching methods are the primary methods for features smaller than about 100 μm.

Inkjet printing of conductors has been explored, but the approaches to date have been inadequate for producing well-defined features with good electrical properties. The low viscosity compositions of inkjet inks have not been as extensively developed as have the high viscosity screen printing compositions. For example, US Patent Publication No. 20060189113 and International patent application publication WO 2006/076613 describe ink jet inks having a viscosity between 10 to 30 cP and a surface tension of less than 60 dyne/cm. In traditional inkjet inks, particle size must be less than about 100 nm, preferably less than 80 nm; the ink viscosity needs to be about 10-20 cP; the surface tension needs to be less than about 60 dyne/cm; and the metal loading needs to be about 20% or less.

In recent years, an emerging technology, the aerosol jet printing process, such as the Aerosol Jet M³D system developed by Optomec, was developed to fill a neglected middle ground in microelectronic fabrication to create crucial micron-sized (10-100 μm) conductive lines, features, interconnects, components, and devices on organic and inorganic substrates. The aerosol jet printing process, which is distinct from ink jet, utilizes aerodynamic focusing to precisely deliver fluid and nano-material formulations that can be optionally post-treated. The required ink properties for aerosol jet (M³D) printing are very different from the properties required for inkjet printing.

There is very limited disclosure in the prior art regarding inks designed for aerosol jet printing, particularly for inks containing uncoated or coated metal particles. For example, US Patent Publication No. US20110059230 describes a hot melt aerosol jet printing ink that is heated to a temperature of at least above 40° C. in order to keep the viscosity of the ink low, where the ink solidifies upon impinging on a non-heated substrate. US Patent Publication No. US20110059230 describes its aerosol jet ink as containing conductive particles or metal oxides and a thermoplastic polymer, where the thermoplastic polymer provides a viscosity of the ink at room temperature that is greater than or equal to 200 Pa·s (20,000 cP), preferably in the range of 200 to 5,000 Pa·s (20,000 to 500,000 cP) in order to avoid the ink running on the substrate upon application. US Patent Publication No. US20110059230 states that its aerosol delivery system uses a heated atomizer gas and heated aerosol transport and heated focusing gas in order to maintain the viscosity of its ink at an operating temperature of between approximately 40° C. to 70° C. in the atomizer so that its thermoplastic polymer has a low enough viscosity to allow atomization of the ink. Upon contact with the unheated substrate, the thermoplastic polymer in the ink solidifies, purportedly preventing any running of the ink when applied to the substrate. An obvious disadvantage to this system is the requirement that the aerosol jet printing system be heated to deliver the ink to the substrate.

Thus, a need exists for aerosol jet printable inks containing uncoated or coated (e.g., glass-coated) metal particles for the printing and patterning of conductive materials to faun circuits, conductive lines and/or features on organic and inorganic substrates to be used in electronics, displays, and other applications to take advantage of the emerging aerosol printing technology.

There are many commercially available UV curable inks for inkjet printing applications. UV curable inkjet dielectric inks are usually designed for “drop-on-demand” inkjet printing where each print head nozzle ejects droplets typically in the range of about 1 to 100 picoliters. For comparison, drop volumes in aerosol jet printing generally are between about 0.5 and 100 femtoliters. Inkjet inks typically contain some low boiling point/high vapor pressure solvents and have a viscosity typically in the range of 1 cP to 20 cP, and generally less than 20 cP.

For example, US Patent Publication No. US20090227719 describes inkjet inks that contain epoxy, ferroelectric ceramic powders and solvent. US Patent Publication No. US20050137281 describes inkjet inks that contain styrenic polymers, typically cyano-functional styrenic polymers, with relatively high dielectric constants, and optionally inorganic particles. Other printable dielectric materials are described, e.g., in US Patent Publication Nos. US20100098838; US20090227719; US20090163615; US 20080269373; US20080160194; US20080085369; US20070248838; US20070215393; US20060047014; US 20050137281; US20050069718; and US20030175411; and in U.S. Pat. Nos. 7,833,334; 7,794,790; 7,524,528; and 7,402,617. Such inkjet inks have not been shown to be compatible with aerosol jet printing. Thus, dielectric inks that are better suited specifically for aerosol jet printing must be specially formulated.

Thus, a need exists for aerosol jet printable UV curable dielectric inks for the fabrication of dielectric features to be used in electronics, displays, and other applications to take advantage of the emerging aerosol printing technology.

### SUMMARY OF THE INVENTION

Provided herein are aerosol jet printable inks containing uncoated or coated (e.g., glass-coated) metal particles for the printing and patterning of conductive materials to form circuits, conductive lines and/or features on organic and inorganic substrates. Also provided are aerosol jet printable UV curable dielectric inks for the printing and patterning of fabrication of dielectric features on organic and inorganic substrates to be used in electronics, displays, and other applications.

It has been found that when used for aerosol jet printing, such as M³D printing, the aerosol jet inks of the present invention will maintain good printability with good printed line dimension stability for extended print runs (e.g., from a few hours up to several days, and possibly longer). The aerosol jet inks of the present invention can be used on many different substrates, such as for example silicon; silicon nitride; glass; indium tin oxide (ITO); ITO-coated glass; various polymers such as polyethylene naphthalate (PEN), polyetherimides, polyamide and polyamide-imides; and combinations thereof.

### BRIEF DESCRIPTION OF THE DRAWINGS

FIG. 1 is a schematic of an aerosol jet (Optomec M³D) printing process.

FIG. 2 shows a dielectric jumper diagram. In the diagram, the light gray squares represent ITO pads; the dark grey rectangle represents dielectric ink; and the black line represents over-printed conductive metal ink. Here the left and right ITO pads are connected by a patterned ITO bridge. The top and bottom ITO pads are connected by a printed metal ink, with the inventive dielectric ink insulating the metal jumper from the underlying ITO.

FIG. 3 shows the particle size distribution of the silver metal particles of Example 1 prior to heat aging (50° C.) stability testing (for 1 week). The key metrics are D50 (50% particle size distribution) and D90 (90% particle size distribution).

FIG. 4 shows the particle size distribution of the silver metal particles of Example 1 after heat aging (50° C.) stability testing (for 1 week). Minimal changes of D50 and D90 are seen after heat aging which demonstrates good stability of the inventive inks.

FIG. 5 shows the particle size distribution of the silver metal particles of Example 1 prior to a 10 hour print trial.

FIG. 6 shows the particle size distribution of the silver metal particles of Example 1 after 10 hours of continuous printing. Minimal changes of D 50 and D 90 are seen after 10 hours, thus demonstrating the long print run stability of the inventive inks.

FIG. 7 shows minimal change in printed line dimension of the aerosol jet ink of Example 1 printed on UV Curable Dielectric Polymer Coated Glass, with 150 micron tip after 10 minutes printing at 22° C. The printed line is 117 micron wide. Set parameter: 60 sccm-750 sccm-760 sccm-80 mm/s; Real parameter: 58 sccm-748 sccm-760 sccm-80 mm/s.

FIG. 8 shows minimal change in printed line dimension of the aerosol jet ink of Example 1 printed on UV Curable Dielectric Polymer Coated Glass, with 150 micron tip after 10 hours of continuous printing at 22° C. The printed line is 118 micron wide. Set parameter: 60 sccm-750 sccm-760 sccm-80 mm/s; Real parameter: 58 sccm-748 sccm-760 sccm-80 mm/s.

FIG. 9 shows a high quality printed line of the aerosol jet ink of Formulation 1 printed on a Glass Coupon with a 150 micron tip, 10 micron wide, at 25° C. Set parameter: 10 sccm-500 sccm-530 sccm-40 mm/s; Real parameter: 9 sccm-506 sccm-526 sccm-40 mm/s.

FIG. 10 shows a high quality printed line of the aerosol jet ink of Formulation 1 printed on a UC Curable Acrylic Polymer Coated Glass Coupon with a 100 micron tip, 10 micron wide, at 25° C. Set parameter: 10 sccm-500 sccm-533 sccm-40 mm/s; Real parameter: 9 sccm-506 sccm-529 sccm-40 mm/s.

FIG. 11 shows a high quality printed line of the aerosol jet ink of Formulation 1 printed on an ITO Coupon with a 100 micron tip, 14 micron wide, at 25° C. Set parameter: 10 sccm-500 sccm-535 sccm-40 mm/s; Real parameter 9 sccm-506 sccm-535 sccm-40 mm/s.

FIG. 12 is a graph showing sintering temperature versus resistivity of a printed line of aerosol jet ink of Formulation 1, demonstrating that the conductivity of the line is excellent (5 to 35 μΩcm @ 170° C. to 200° C.).

FIG. 13 is a graph showing sintering temperature versus resistivity of a printed line of aerosol jet ink of Formulation 10, demonstrating that the conductivity of the line is excellent (4.2 to 18 μΩcm @ 140° C. to 200° C.).

FIG. 14 shows the particle size distribution of the silver metal particles of Formulation 19 prior to heat age (50° C.) stability testing (for 1 week). As shown in the Figure, D50 (50% particle size distribution)=14 nm, D90 (90% particle size distribution)=25 nm and D100 (100% particle size distribution)=38 nm.

FIG. 15 shows the particle size distribution of the silver metal particles of Formulation 19 after heat age (50° C.) stability testing (for 1 week). D50=12 nm; D90=22 nm; and D100=36 nm. Minimal changes of D50 and D 90 are seen after heat aging, demonstrating the good stability of the inventive inks.

FIG. 16 shows the particle size distribution of the silver metal particles of Formulation 19 prior to a 10 hour print trial. D50=15 nm; D90=25 nm; and D100=38 nm.

FIG. 17 shows the particle size distribution of the silver metal particles of Formulation 19 after 10 hours of continuous printing. D50=13 nm; D90=27 nm; and D100=39 nm. Minimal changes of D50 and D 90 are seen after 10 hours, demonstrating the long print run stability of the inventive inks.

FIG. 18 shows a printed line of ink of Formulation 19 printed on UV curable Acrylic Polymer Coated Glass, using a 150 micron tip, 40 micron wide after 10 minutes printing at 22° C. Set parameters: 35 sccm 650 sccm 670 sccm 20 mm/s; Real parameters: 34 sccm 656 sccm 670 sccm 20 mm/s. As seen in the Figure, after 10 minutes of printing, there is minimal change in printed line dimension (40 micron wide).

FIG. 19 shows a printed line of ink of Formulation 19 printed on UV curable Acrylic Polymer Coated Glass, using a 150 micron tip, 40 micron wide after 10 hours of continuous printing at 22° C. Set parameters: 35 sccm 650 sccm 670 sccm 20 mm/s; Real parameters: 34 sccm 656 sccm 670 sccm 20 mm/s. As shown in the Figure, there is minimal change in printed line dimension (40 micron wide) after 10 hours of continuous printing.

FIG. 20 shows a high quality printed line of ink of Formulation 19 printed on a Glass Coupon using a 100 micron tip, 10 micron wide, at 25° C. Set parameters: 35 sccm 650 sccm 670 sccm 35 mm/s; Real parameters: 34 sccm 656 sccm 670 sccm 35 mm/s.

FIG. 21 shows a high quality printed line of ink of Formulation 19 printed on a UV Curable Polymer Coupon using a 100 micron tip, 10 micron wide, at 25° C. Set parameters: 35 sccm 650 sccm 670 sccm 35 mm/s; Real parameters: 34 sccm 656 sccm 670 sccm 35 mm/s.

FIG. 22 shows a high quality printed line of ink of Formulation 19 printed on an ITO Coupon using a 150 micron tip, 40 micron wide, at 25° C. Set parameters: 35 sccm 650 sccm 670 sccm 20 mm/s; Real parameters: 34 sccm 656 sccm 670 sccm 20 mm/s.

FIG. 23 shows a high quality printed line of ink of Formulation 19 printed on a UV Curable Dielectric Polymer using a 100 micron tip, 10 micron wide, at 25° C. Set parameters: 35 sccm 650 sccm 670 sccm 35 mm/s; Real parameters: 34 sccm 656 sccm 670 sccm 35 mm/s.

FIG. 24 is a graph that shows particle size distribution for an aerosol jet printing ink composition containing commercially available glass coated silver particles (CSN27 before 1 week storage at 50° C.

FIG. 25 is a graph that shows particle size distribution for an aerosol jet printing ink composition containing commercially available glass coated silver particles (CSN27 after 1 week storage at 50° C.

FIG. 26 is a graph showing sintering temperature profiles of several aerosol jet ink compositions.

FIG. 27 is a magnified image of a print of aerosol jet ink composition of Formulation 25 printed on a multicrystalline SiNₓ coated wafer using a 200 micron tip (30 micron wide). Set parameters: 40 sccm-950 sccm-1100 sccm-105 mm/s.

FIG. 28 shows a print of aerosol jet ink composition of Formulation 25 printed on a multicrystalline SiNₓ coated wafer using a 200 micron tip (30 micron wide). Set parameters: 40 sccm-950 sccm-1100 sccm-105 mm/s.

FIG. 29 is a print of aerosol jet ink composition of Formulation 27 ink printed on a multicrystalline SiNₓ coated wafer using a 250 micron tip (29 micron wide). Set parameters: 70 sccm-750 sccm-775 sccm-60 mm/s

FIG. 30 shows a TLM pattern on which one glass coated silver paste was printed.

FIG. 31 is a graph that demonstrates room temperature storage stability of aerosol jet printing ink compositions containing various dispersants (surfactants) and commercially available glass coated silver particles (CSN17, Cabot Corp., Billerica, Mass. USA or Cabot Superior MicroPowders, Albuquerque, N. Mex. USA), the graph showing the % solid precipitation (sedimentation) over time from 24 hours to 6 weeks.

FIG. 32 is a graph that demonstrates room temperature storage stability of aerosol jet printing ink compositions containing various dispersants (surfactants) and commercially available glass coated silver particles (CSN27, Cabot Corp., Billerica, Mass. USA or Cabot Superior MicroPowders, Albuquerque, N. Mex. USA), the graph showing the % solid precipitation (sedimentation) after 6.5 weeks.

FIG. 33 shows a line of UV curable dielectric aerosol jet ink composition of Formulation 32 printed on a glass coupon after 10 minutes of printing using a 150 micron tip, 30 micron wide. Set parameters: 45 sccm, 750 sccm, 850 sccm, 18 mm/s.

FIG. 34 shows a line of UV curable dielectric aerosol jet ink composition of Formulation 32 printed on a glass coupon after 10 hours of printing using a 150 micron tip, 30 micron wide. Set parameter: 45 sccm, 750 sccm, 850 sccm, 18 mm/s.

FIG. 35 shows a line of UV curable dielectric aerosol jet ink composition of Formulation 33 printed on a glass coupon after 10 minutes of printing using a 150 micron tip, 31 micron wide. Set parameters: 50 sccm, 1020 sccm, 1085 sccm, 22 mm/s.

FIG. 36 shows a line of UV curable dielectric aerosol jet ink composition of Formulation 33 on printed a glass coupon after 10 hours of printing using a 150 micron tip, 31 micron wide. Set parameters: 50 sccm, 1020 sccm, 1085 sccm, 22 mm/s.

FIG. 37 shows a line of UV curable dielectric aerosol jet ink composition of Formulation 34 printed on a glass coupon after 10 minutes of printing using a 150 micron tip, 137 micron wide. Set parameters 20 sccm, 950 sccm, 1000 sccm, 4 mm/s.

FIG. 38 shows a line of UV curable dielectric aerosol jet ink composition of Formulation 34 printed on a glass coupon after 10 hours of printing using a 150 micron tip, 138 micron wide. Set parameters 20 sccm, 950 sccm, 1000 sccm, 4 mm/s.

FIG. 39 shows a line of UV curable dielectric aerosol jet ink composition of Formulation 32 ink printed on ITO using a 150 micron tip, 30 micron wide. Set parameters: 45 sccm, 750 sccm, 850 sccm, 18 mm/s.

FIG. 40 shows a line of UV curable dielectric aerosol jet ink composition of Formulation 33 printed on ITO using a 150 micron tip, 68 micron wide. Set parameters: 20 sccm, 1250 sccm, 1300 sccm, 30 mm/s.

FIG. 41 shows a line of UV curable dielectric aerosol jet ink composition of Formulation 34 printed on ITO using a 150 micron tip, 83 micron wide. Set parameters: 25 sccm, 950 sccm, 1000 sccm, 10 mm/s.

FIGS. 42A and 42B show a line of UV curable dielectric aerosol jet ink composition of Formulation 32 printed on a glass substrate after 250° C. thermal treatment for 30 minutes (A) before tape test and (B) after tape test.

FIGS. 43A and 43B show a line of UV curable dielectric aerosol jet ink composition of Formulation 34 printed on a glass substrate after 250° C. thermal treatment for 30 minutes (A) before tape test and (B) after tape test.

FIG. 44 shows a print example of Sun Chemical U6700 silver ink printed on top of the UV Curable Dielectric aerosol jet ink composition of Formulation 32 on coated glass using a 100 micron tip, 10 micron wide. Set parameters: 10 sccm, 500 sccm, 533 sccm, 40 mm/s; actual flow rates: 9 sccm, 506 sccm, 529 sccm, 40 mm/s.

FIG. 45 shows a print example of Sun Chemical U6700 silver ink printed on top of the UV Curable Dielectric aerosol jet ink composition of Formulation 33 on coated glass using a 100 micron tip, 10 micron wide. Set parameters: 35 sccm, 650 sccm, 670 sccm, 35 mm/s; actual flow rates: 34 sccm, 656 sccm, 670 sccm, 35 mm/s.

FIG. 46 shows a print example of Sun Chemical U6700 silver ink printed on top of the UV Curable Dielectric aerosol jet ink composition of Formulation 34 on coated glass using a 150 micron tip, 15 micron wide. Set parameters: 75 sccm, 600 sccm, 610 sccm, 60 mm/s.

FIGS. 47A, 47B and 47C each shows a line of UV curable dielectric aerosol jet ink composition of Formulation 32 printed on an ITO/glass substrate. The darker gray horizontal area in the image is the glass, the lighter gray horizontal areas above and below the glass area are ITO, and the vertical line in the image is the printed UV curable dielectric aerosol jet ink composition. In FIG. 47A, the ITO/glass substrate was untreated prior to printing. In FIG. 47B, the ITO/glass substrate was subjected to IPA ultrasonic treatment for 5 minutes prior to printing. In FIG. 47C, the ITO/glass substrate was subjected to nitrogen plasma treatment for 5 minutes followed by an IPA rinse prior to printing.

### DETAILED DESCRIPTION OF THE INVENTION

It is to be understood that the foregoing general description and the following detailed description are exemplary and explanatory only and are not restrictive of any subject matter claimed.

The section headings used herein are for organizational purposes only and are not to be construed as limiting the subject matter described.

### I. DEFINITIONS

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose.

In this application, the use of the singular includes the plural unless specifically stated otherwise.

In this application, the use of “or” means “and/or” unless stated otherwise. As used herein, use of the term “including” as well as other forms, such as “includes,” and “included,” is not limiting.

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

As used herein, “optional” or “optionally” means that the subsequently described event or circumstance does or does not occur, and that the description includes instances where said event or circumstance occurs and instances where it does not. For example, an optional component in a system means that the component may be present or may not be present in the system.

As used herein, “sccm” refers to standard cubic centimeter per minute.

As used herein, the term “dispersant” refers to a dispersant, as that term is known in the art, that is a surface active agent added to a suspending medium to promote the distribution and separation of fine or extremely fine solid particles. Exemplary dispersants include branched and unbranched secondary alcohol ethoxylates, ethylene oxide/propylene oxide copolymers, nonylphenol ethoxylates, octylphenol ethoxylates, polyoxylated alkyl ethers, alkyl diamino quaternary salts and alkyl polyglucosides.

As used herein, the term “surface active agent” refers to a chemical, particularly an organic chemical, that modifies the properties of a surface, particularly its interaction with a solvent and/or air. The solvent can be any fluid.

As used herein, the term “surfactant” refers to surface active molecules that absorb at a particle/solvent, particle/air, and/or air/solvent interfaces, substantially reducing their surface energy. The term “detergent” is often used interchangeably with the term “surfactant.” Surfactants generally are classified depending on the charge of the surface active moiety, and can be categorized as cationic, anionic, nonionic and amphoteric surfactants.

As used herein, an “anti-agglomeration agent” refers to a substance, such as a polymer, that shields (e.g., sterically and/or through charge effects) metal particles from each other to at least some extent and thereby substantially prevents a direct contact between individual nanoparticles thereby minimizing or preventing agglomeration.

As used herein, the term “adsorbed” includes any kind of interaction between a compound, such as a coating, a dispersant or an anti-agglomeration agent, and a metal particle surface that manifests itself in at least a weak bond between the compound and the surface of a metal particle.

As used herein, the term “polymerization initiator” refers to a chemical that can start a polymerization reaction upon exposure to electromagnetic radiation. A polymerization initiator can be a photoinitiator or a thermal initiator. A photoinitiator is a chemical that initiates polymerization reaction by the use of light. Exemplary photoinitiators include benzoin methyl ether, diethoxyacetophenone, a benzoylphosphine oxide, 1-hydroxycyclohexyl phenyl ketone and Darocur and Irgacur types, preferably Darocur 1173®, Darocur 2959®, and CIBA IRGACURE® 2959. A thermal initiator is a chemical that initiates polymerization reaction by the use of heat energy.

As used herein, the term “particle” refers to a small mass that can be composed of any material, such as a metal, e.g., conductive metals including silver, gold, copper, iron and aluminum), alumina, silica, glass or combinations thereof, such as glass-coated metal particles, and can be of any shape, including cubes, flakes, granules, cylinders, rings, rods, needles, prisms, disks, fibers, pyramids, spheres, spheroids, prolate spheroids, oblate spheroids, ellipsoids, ovoids and random non-geometric shapes. The particles can be isotropic or anisotropic. Anisotropic particles can have a length and a width. Typically the particles can have a diameter or width or length between 1 nm to 2500 nm. For example, the particles can have a diameter (width) of 1000 nm or less.

As used herein, the term “diameter” refers to a diameter, as that term is known in the art, and includes a measurement of width or length of an anisotropic particle. As used throughout the specification, diameter refers to D90 diameter, which means that 90% of the particles have a diameter of this value or less.

As used herein, “minimal change” means a change from an initial condition to a final condition that varies by no more than 10%.

As used herein, an “aerosol jet ink” refers to an ink formulated to be compatible for printing using an aerosol jet printing process, such as an aerosol jet M³D printing process.

As used herein, the term “compatibility” is a collective term for combined adhesion and performance properties.

As used herein, a “high boiling point solvent” is a solvent that has a boiling point solvent a boiling point of 100° C. or more at atmospheric pressure.

As used herein, a “low vapor pressure solvent” is a solvent that has a vapor pressure of 1 mmHg or less at room temperature.

As used herein, a “high vapor pressure solvent” is a solvent that has a vapor pressure greater than 1 mmHg at room temperature.

As used herein, “adhesion” refers to the property of a surface of a material to stick or bond to the surface of another material. Adhesion can be measured, e.g., by ASTM D3359-08.

As used herein, an “adhesion promoter” refers to a compound that promotes or facilitates adhesion of one substance to another.

As sued herein, the term “resistivity entitlement” refers to essentially complete sintering or coalescence of the particles as indicated by no further decrease in resistivity when exposed to further sintering.

As used herein, “transparent” means substantially transmitting visible light.

As used herein, “D50” refers to the median value of particle diameter. For example if D50=1 μm, there are 50% particles larger than 1 μm and 50% smaller than 1 μm.

As used herein, “D90” refers to the 90% value of particle diameter. For example if D90=1 μm, 90% of the particles are smaller than 1 μm.

In the examples, and throughout this disclosure, all parts and percentages are by weight and all temperatures are in ° C., unless otherwise indicated.

### II. AEROSOL JET PRINTING

In recent years, an emerging technology, Aerosol Jet M³D printing process, such as the system developed by Optomec, was developed to fill a neglected middle ground in microelectronic fabrication to create crucial micron-sized (10-100 μm) conductive lines, features, interconnects, components, and devices. This process offers significant cost, time and quality benefits across a broad spectrum of electronics, display and energy industries. This new printing technique can be described as “additive manufacturing.” During additive manufacturing, material is deposited layer by layer to build up structures or features, in contrast to traditional subtractive manufacturing methods, which use masking and etching processes to remove material to achieve the final form.

The aerosol jet printing process, such as the system developed by Optomec, has gained acceptance in the industry due to its ability to produce a wide range of electronic, structural and biological patterns onto almost any substrate. The aerosol jet printing process, which is distinct from ink jet printing processes, utilizes aerodynamic focusing to precisely deliver fluid and nano-material formulations that can be optionally post-treated, e.g., exposed to a sintering process. Sintering can be achieved using a conduction oven, an IR oven/furnace, by induction (heat induced by electromagnetic waves) or using light (“photonic”) curing processes, such as a highly focused laser or a pulsed light sintering system (e.g., available from Xenon Corporation (Wilmington, Mass. USA) or from NovaCentrix (Austin, Tex. USA)).

The resulting patterns can have features that are less than 10 microns wide, with layer thicknesses from tens of nanometers to several microns. Wide nozzle print heads are also available which enable efficient patterning of larger size features and surface coating applications. Advantages of aerosol jet printing systems include:
Printed feature sizes to 10 microns;
Thin Layer Deposits from 100 nm;
Diversity of Materials and Substrates that can be used;
Ink composition viscosities from 1 cP to 1,000 cP or greater;
Nano-material deposition capability;
Non-planar printing Capability; and
Low temperature processing.

Advantages of additive manufacturing processes as compared to subtractive manufacturing processes include:
1. Digital printing (Direct CAD or software driven processing). This eliminates expensive hard-tooling, masks, vertical/horizontal integration and leads to fewer overall manufacturing steps.
2. Greater product design and manufacturing flexibility. This benefit offers the potential for revolutionary new end use products with improved performance based on novel size, geometries, materials and material combinations.
3. Time compression and increased manufacturing agility. CAD or software driven, and fewer tool processes accelerate product development, manufacturing and allow greater flexibility in mass customization.
4. Improved efficiency and lower costs. This benefit arises because hard-tooling and mask costs are eliminated for manufacturing. Process costs for operator input, supplier chain complexity and work flows are reduced.
5. Green technology. Direct printing processes use raw materials more efficiently than traditional methods. This significantly reduces waste levels. Toxic chemicals required in subtractive manufacturing processes are not required with additive manufacturing process.

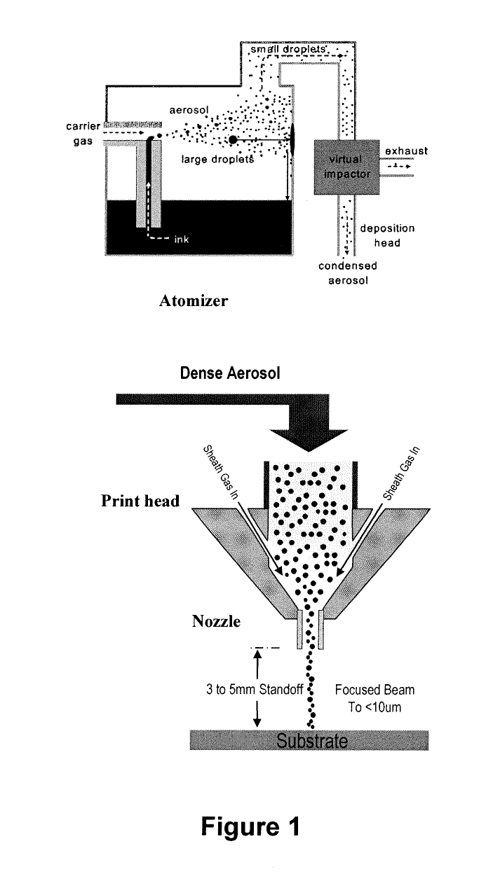

A basic aerosol printing system consists of two key components, as shown in FIG. 1:
An atomizer module for atomizing liquid raw materials (mist generation); and
A virtual impactor module for focusing the aerosol and depositing the droplets (in-flight processing).

The aerosol jet printing process uses aerodynamic focusing for the high-resolution deposition of colloidal suspensions and/or chemical precursor solutions. The aerosol jet printing process begins with a mist generator that atomizes a source material. Mist generation generally is accomplished using an ultrasonic or pneumatic atomizer. The aerosol stream is then focused using a flow deposition head, which forms an annular, co-axial flow between the aerosol stream and a sheath gas stream (see FIG. 1). Particles in the resulting aerosol stream can then be refined in a virtual impactor and further treated on the fly to provide optimum process flexibility. The co-axial flow exits the print head through a nozzle directed at the substrate. The aerosol stream of the deposition material can be focused, deposited, and patterned onto a planar or 3D substrate. The aerosol jet print head is capable of focusing an aerosol stream to as small as a tenth of the size of the nozzle orifice (typically 100 μm).

Aerosol jet printing operating temperatures can be adjusted by the operator. The aerosol jet printer can be used at room temperature (e.g., 25° C.), or at elevated temperatures, such as between 30° C. and 100° C., including 30° C., 35° C., 40° C., 45° C., 50° C., 55° C., 60° C., 65° C., 70° C., 75° C., 80° C., 85° C., 90° C., 95° C. and 100° C.

The deposition process is CAD driven; the process directly writes the required pattern from a standard .dxf (drawing exchange format) file. Patterning can be accomplished by attaching the substrate to a computer-controlled platen, or by translating the flow guidance head while the substrate position remains fixed. The relatively large (>5 mm) standoff distance from the deposition head to the substrate allows accurate deposition on non-planar substrates, over existing structures and into channels.

Once deposited, the materials may undergo a thermal or chemical post-treatment to attain final electrical (e.g., electrical conductivity) and mechanical properties (such as resistance properties) and adhesion to the substrate. Depending on the application, either conventional sintering or curing can be used for low temperature or high temperature substrates. Aerosol jet printing systems can locally process the deposition, e.g., by using a laser treatment process, that permits the use of substrate materials with very low temperature tolerances, such as polymers. The end result is a high-quality thin film (for example as fine as 10 nm) with excellent edge definition and near-bulk metal properties.

Aerosol jet printing, such as Optomec M³D printing, can print 5 times smaller features than inkjet printing, with much higher yield per nozzle, higher deposition rate and metal loading. Aerosol jet printing, such as Optomec M³D printing also covers a wider range of ink viscosity and can provide better print edge definition and offers 3-D and non-planar substrate printing. Aerosol jet printing, such as Optomec M³D can print 10 times narrower lines than screen printing with less substrate breakage and better “up time.”

Although the Optomec M³D system is used to exemplify aerosol jet printing throughout this application, it is understood that the aerosol jet printing inks of the present invention also are suitable for other aerosol jet printing systems.

In the prior art, few aerosol jet printer metal conductive ink formulations were found. Cabot Corporation has patent applications drawn to metal nano compositions for organic coated nano metal particle synthesis, formulations and inkjet printing. For example, US patent application 20060189113 describes conductive ink formulations for inkjet printers. In the application, there is no description of the required ink properties for aerosol jet (M³D) printing, which are very different from inkjet printing.

In conventional inkjet printing inks, the ink viscosity needs to be about 10-20 cP. The viscosity of an aerosol jet printing ink can be as high as 2500 cP, although it generally is less than 2500 cP, and depending on the application and the jet configuration, the viscosity of an aerosol jet printing ink can be less than 1000 cP or less than about 650 cP or less than about 200 cP. Inkjet inks also normally contain lower solids content (<20%) than aerosol jet printing inks. As such, inks suitable for aerosol jet printing are preferably specifically formulated for use in the aerosol jet printing process.

Tests performed using the inks exemplified in US patent application 20060189113 (the '113 application), containing ethanol (30-40%), glycerol (20-30%) and ethylene glycol (35%-45%), plus PVP coated silver ink (20% load) in an M³D printer, demonstrated that that these ink formulations failed after 3 hours of printing. This is due to the loss of ethanol resulting in an increase in the viscosity and solid content of the ink, which ultimately results in significantly decreased printing rate and changes in printed line dimension. In addition, the metal particle size range in the '113 application is much narrower (80 to 200 nm, preferably less than 80 nm) than the particle size range in the present inventive aerosol jet conductive inks (1 to 2000 nm, preferably 5 to 500 nm), because the M³D printer with a printer nozzle tip up to 300 μm can handled much bigger metal particles. The '113 application discloses that 90% of the particles in its ink have to be spherical. In the present invention, the shape of the metal particles is not so limited—e.g., flake particles can be used in addition to spherical particles. In the aerosol jet ink compositions provided herein, metal particle size is less than 2500 nm, preferably, metal particle size is less than 2000 nm, more preferably less than about 1000 nm, most preferably less than about 500 nm.

In the present invention, it has been determined that for aerosol jet printing inks, the solvent vapor pressure needs to be lower than 1 mmHg; the solvents of the aerosol jet printing ink compositions provided herein preferably have a vapor pressure less than 1, more preferably less than 0.1 mmHg. In the '113 application, there is no disclosure that the solvent vapor pressure needs to be lower than 1 mmHg. The viscosity of the inks exemplified in the '113 application, such as Example 3, is 10 to 30 cP. The inventive aerosol jet printing inks of the present invention can range up to 2500 cP because of aerosol jet printer (e.g., M³D) printer capacity but typically are less than 1000 cP. The ink surface tension of the inks exemplified in the '113 application cannot go above 60 dyne/cm, while the inventive inks disclosed herein can handle a much wider range of surface tension (1-250 dyne/cm). Overall, the '113 application discloses inks mainly based on organic polymer coated nano particles for use in inkjet printing technology. The inks described in the '113 application are not suitable for aerosol jet printing, such as M³D aerosol jet printing.

In addition to the inks exemplified in the '113, tests also were performed using commercially available metal conductive inkjet inks. These inks typically contain low boiling point and high vapor pressure solvents and therefore are not suitable for extended print times common in aerosol jet printing due to significant solvent loss and resultant printability problems.

In traditional inkjet inks, particle size must be less than about 100 nm, preferably less than 80 nm; the ink viscosity needs to be about 10-20 cP; the surface tension needs to be less than about 60 dyne/cm; and the metal loading needs to be about 20% or less. In M³D printing inks, the particle size can range from about 1 to 2000 nm, preferably smaller than about 500 nm; the viscosity can range from about 0.7-2500 cP; the metal loading can be up to about 90%; the surface tension of the ink also can cover a much wider range, which can be much higher than 60 dyne/cm. The vapor pressure for the solvent used for aerosol jet printing, such as using the M³D aerosol jet printer, is preferably lower than about 1 mmHg, more preferably lower than about 0.1 mmHg to meet print requirements.

Traditional inkjet formulations generally are not suitable for aerosol jet deposition due to the low viscosity of inkjet inks and the presence of high vapor pressure solvents that are stripped off more quickly during printing. Thus, the inks described in the present application are tailored specifically for aerosol jet printers. There are several technical requirements specific to aerosol jet printers. The first is that the vapor pressure of all aerosol jet printing ink components would preferably be <0.1 torr. The suitable viscosity range for aerosol jet printing is between 1 and 2500 cP and preferably higher than 20 cP in order to achieve fine line and higher aspect ratio in combination with high print speed. For inkjet printing, this viscosity requirement is much lower, approximately <10 cP.

There are many commercially available UV curable inks for inkjet printing applications. UV curable inkjet dielectric inks are usually designed for “drop-on-demand” inkjet printing. These inkjet inks typically contain low boiling point/high vapor pressure solvents or monomer and are therefore not well suited for aerosol jet printing due to significant solvent or monomer loss resulting in compositional and viscosity changes during printing. The inkjet dielectric inks also normally require lower viscosity (typically in the range of 1 to 20 cP) than those for aerosol jet printing.

The inventive inks described in the present application are formulated specifically for aerosol jet printing, such as M³D printing, and preferably exhibit a shelf-life of up to 1 year or more. With sonication, the coated or uncoated metal particles in the inventive conductive inks provided herein that may settle during storage easily can be re-dispersed to their original particle size distribution. When used for aerosol jet printing, such as M³D aerosol jet printing, the aerosol jet printing ink compositions of the present invention will maintain good printability with good printed line dimension stability for extended print runs (of a few hours up to several days, or longer). The inks of the present invention can be used on many different substrates, such as for example silicon; silicon nitride; polyethylene naphthalate (PEN); polyetherimides; polyamide; polyamide-imides; glass; indium tin oxide (ITO); ITO-coated glass; and various polymers. The electrically conductive features formed according to the present invention can have good electrical properties, about 2 to 3 times the resistivity of the pure bulk metal, under good sintering conditions.

In addition to the aforementioned advantages of additive manufacturing, aerosol jet printing offers additional advantages as shown below:

| Aerosol jet Features | Aerosol jet Benefits |
|---|---|
| Non-contact printing | Eliminate solder joints |
| Thin layer deposits from 10 nm | Lighter weight electronics |
| Nanomaterial deposition capability | Green technology |
| Conformal printing on 3D surfaces | Trusted manufacturing |
| Many materials & substrates: adhesives; | Reduced product development |
| conductors; functional inks/coatings | time |
| | Circuits can be direct printed |
| Fine line printing (<10 microns) | Cost effective for low volume |
| | manufacture |
| | Same tool used for |
| | development/MFG/MRO |

Applications of aerosol jet printing include flexible displays, EMI shielding, solder-free electronics, high efficiency solar cells, and embedded components: sensors; resistors; printed antennae.

Ideally, a metal particle-containing aerosol jet ink and its associated deposition technique for the fabrication of electrically conductive features would combine a number of attributes. The conductive feature would have high conductivity, preferably close to that of the pure bulk metal. The processing temperature would be low enough to allow formation of conductors on a variety of inorganic and organic substrates. The deposition technique would allow deposition onto surfaces that are planar and non-planar. The conductive ink also would have good adhesion to the substrate. The composition would preferably be aerosol jet printable, allowing the introduction of cost-effective deposition for production of devices for energy, electronics, and display industries such as solar cell, PC board, semiconductor and displays applications. The coated or uncoated metal particle-containing aerosol jet ink compositions provided herein possess these attributes.

### III. AEROSOL JET PRINTABLE METAL AND COATED METAL CONDUCTIVE INKS

It is an object of the present invention to provide aerosol jet printable metal and coated (such as with glass or metal oxides or treated with organic polymers) metal conductive ink compositions that produce fine conducting lines and are useful for feature printing. It also is an object of the present invention to provide methods of making the aerosol jet printable metalized and glass-coated metal printing inks. It also is an object of the present invention to provide aerosol jet printing methods utilizing the inventive conductive inks.

The aerosol jet printable uncoated metal and coated metal conductive inks of this embodiment exhibit good storage stability, good long-term printing stability, suitability and compatibility to various substrates. These inks can be printed to form very fine lines (10 microns) with good edge definition and excellent conductivity (close to the resistivity of the bulk conductor) after sintering by heating or laser treatment.

In the aerosol jet printable uncoated or coated metal conductive inks provided herein, the metal particles can be treated with an organic or a polymer substance (dispersant) that can adsorb to the surface of the particles to stabilize the metal particles. The aerosol jet printable inks also can include untreated coated or uncoated metal particles and the aerosol jet printable ink can include a dispersant to stabilize the untreated coated or uncoated metal particles.

A. Aerosol Jet Metal and Coated Metal Conductive Ink Components

The aerosol jet uncoated and coated metal conductive ink compositions provided herein are formulated to be printable on an aerosol jet printing device, such as is described in U.S. Pat. Nos. 7,658,163; 7,270,844 and 7,108,894, the disclosure of each of which is incorporated by reference in its entirety. Exemplary commercial aerosol jet printing devices are the M³D® Aerosol Jet Printing Systems of Optomec (Optomec, Inc., Albuquerque, N. Mex. USA).

Metal Particles:

The metal particles in the aerosol metal conductive ink compositions provided herein generally exhibit a low bulk resistivity from about 0.5 μΩ·cm to 50 μΩ·cm, preferably from at or about 1 μΩ·cm to 30 μΩ·cm, or 0.5 μΩ·cm to 5 μΩ·cm, most preferably from at or about 1 μΩ·cm to 20 μΩ·cm. Non-limiting examples of metals that can be included in the aerosol metal conductive ink compositions of the present invention include, e.g., silver, gold, copper, nickel, palladium, cobalt, chromium, platinum, tantalum indium, tungsten, tin, zinc, lead, chromium, ruthenium, tungsten, iron, rhodium, iridium and osmium. Gold has a bulk resistivity of 2.25 μΩ·cm. Copper has a bulk resistivity of 1.67 μΩ·cm. Silver, with bulk resistivity of 1.59 μΩ·cm, being the most conductive metal, is the most preferred metal particle, and, similarly, glass-coated silver is the most preferred glass-coated metal particle.

The metal particles can be uncoated or can be coated, such as with glass or metal oxides or with other metals, and the uncoated or coated particles can be surface treated, such as with an organic or polymer substance, such as a dispersant. Exemplary metal oxides that can be included in a coating on the metal particles include aluminum oxides, antimony pentoxide, copper oxides, gold oxides, indium oxides, iron oxides, lanthanum oxides, molybdenum oxides, selenium oxides, silver oxides, tantalum oxides, titanium oxides, tin oxides, tungsten oxides, vanadium pentoxide, zinc oxides and zirconium oxides and combinations thereof. The metal particles also can be coated with a metal. For example, copper metal particles can be coated with silver, providing a less expensive alternative to pure silver particles and that can be more conductive and environmentally stable than pure copper particles. Other metals than can be used as coatings include gold, copper, aluminum, zinc, iron, platinum and combinations thereof.

In the present invention, dispersants optionally can be used. Any dispersants known in the art can be used. Exemplary dispersants include those described in co-owned US 2009/0142526, which is incorporated herein by reference in its entirety. The dispersant can be included in the ink composition, or the particles can be surface treated with the dispersant. The present invention encompasses uncoated metal particles surface-treated with dispersants and untreated uncoated metal particles, as well as coated metal particles, such as glass-coated metal particles, surfaced treated with a dispersant or untreated with dispersants. Dispersant can improve ink stability, especially when using uncoated metals. Dispersant can be included in the ink formulation.

For example, the metal particles can be coated with an organic or a polymeric compound. Such surface coating of the metal particles can minimize or eliminate the need for a dispersant to disperse the coated particles in an organic solvent. For example, the metal particles can be treated with as a polymeric compound that acts as an anti-agglomeration substance to prevent significant agglomeration of the particles. In conventional metallic inks, the small metal particles typically have a strong tendency to agglomerate and form larger secondary particles (agglomerates) because of their high surface energy. Through steric and/or electronic effects of the anti-agglomeration substance, the dispersed polymer-coated metal particles are less prone to agglomeration. This minimization or elimination of agglomeration also tends to minimize or prevent sedimentation and thus provides a metal ink that exhibits good storage and printing stability. In compositions in which the metal particles are surface treated with a dispersant or anti-agglommerant, although the need for added dispersant in the ink formula is minimized or eliminated, it is understood that dispersant could be added to the composition containing uncoated or coated metal particles surface-treated with dispersant if desired, e.g., to further enhance performance properties of the ink.

The amount of metal, e.g., in the form of coated or uncoated metal particles, in the aerosol metal conductive ink compositions of the present invention is preferably between 10 to 90% by weight of the ink composition, more preferably between 30-90% by weight of the ink composition and particularly 40-90% by weight of the ink composition. For example, the amount of metal in the aerosol metal conductive ink compositions provided herein can be in an amount that is 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5%, 30%, 30.5%, 31%, 31.5%, 32%, 32.5%, 33%, 33.5%, 34%, 34.5%, 35%, 35.5%, 36%, 36.5%, 37%, 37.5%, 38%, 38.5%, 39%, 39.5%, 40%, 40.5%, 41%, 41.5%, 42%, 42.5%, 43%, 43.5%, 44%, 44.5%, 45%, 45.5%, 46%, 46.5%, 47%, 47.5%, 48%, 48.5%, 49%, 49.5%, 50%, 50.5%, 51%, 51.5%, 52%, 52.5%, 53%, 53.5%, 54%, 54.5%, 55%, 55.5%, 56%, 56.5%, 57%, 57.5%, 58%, 58.5%, 59%, 59.5%, 60%, 60.5%, 61%, 61.5%, 62%, 62.5%, 63%, 63.5%, 64%, 64.5%, 65%, 65.5%, 66%, 66.5%, 67%, 67.5%, 68%, 68.5%, 69%, 69.5%, 70%, 70.5%, 71%, 71.5%, 72%, 72.5%, 73%, 73.5%, 74%, 74.5%, 75%, 75.5%, 76%, 76.5%, 77%, 77.5%, 78%, 78.5%, 79%, 79.5%, 80%, 80.5%, 81%, 81.5%, 82%, 82.5%, 83%, 83.5%, 84%, 84.5%, 85%, 85.5%, 86%, 86.5%, 87%, 87.5%, 88%, 88.5%, 89%, 89.5% OR 90% by weight of the ink composition.

Dispersant

While is may be absent in the inventive inks, a dispersant can be present and can serve as an agent to stabilize the dispersion of the metal particles or coated metal particles, such as a glass-coated metal particles, in the ink. A dispersant can provide a steric or electrical barrier to prevent metal particles or coated metal particles, such as glass-coated metal particles, from agglomeration and sedimentation during storage and printing. The dispersant can disperse the uncoated or coated metal particles, reduce and stabilize uncoated or coated metal particle size distribution, improve ink storage stability and improve ink long-term printing stability.

The aerosol coated (such as with glass) or uncoated metal conductive ink compositions for aerosol jet printing (such as for use in a Optomec M³D aerosol jet printing system) can be formulated to contain metal powder particles or glass-coated metal particles and a high boiling point and low vapor pressure solvent or mixture of solvents. The metal particles and glass-coated metal particles can be treated with a dispersant, or a particle dispersant can be included in the ink composition. The aerosol metal conductive ink compositions provided herein also can contain additives such as an adhesion promoter, a rheology modifier, a crystallization inhibitor, a surfactant, a defoaming agent, a biocide or combinations thereof. The components chosen and the amount of components included in a composition can be selected to provide an aerosol metal or coated metal, such as glass-coated metal, conductive ink composition with a targeted adhesion to a selected substrate, or a targeted viscosity or surface tension or combination thereof. Selection of a dispersant can depend on the solvent and the nature of the uncoated or coated metal particle surface. The DLVO theory (The Theory of Colloidal Flocculation) can be applied to help in selection of the correct dispersant. DLVO theory mathematically expresses a balance between attractive forces attributed to van der Waals forces and repulsive forces attributed to like electrical charges on the surfaces of interacting particles. Other types of interaction forces, e.g., steric repulsion and attraction due to dissolved polymer, can be incorporated into the basic theory at least semi-quantitatively.

The dispersant can include ionic polyelectrolytes or non-ionic nonelectrolytes. The dispersants can disperse particles by electrostatic repulsion according to the well known DLVO (Derjaguin, Landau, Verwey and Overbeek) theory. Polymeric nonionic nonelectrolytes generally disperse particles by steric hindrance whose magnitude depends upon the molecular weight or the length of the polymer chain, that is, the distance the polymer extends from the particle surface. Polymeric polyelectrolytes can disperse particles by a combination of electrostatic and steric repulsion. Particle-particle attraction, which can lead to agglomeration, flocculation and/or sedimentation, can depend upon electrostatic attraction of the particles or the cancellation of the repulsion of the particles, thereby allowing Van der Waals forces of attraction to dominate the system.

The Van der Waals potential generally causes particles of the same material to be attractive when the surrounding fluid has a different dielectric constant. To keep the particles apart, low density matter that does not significantly contribute to the van der Waals potential can be used to surface-treat the particles to cause an increase in the free energy when the particles interact. The surface treatment can shield either a portion or all of the attractive van der Waals potential. When the electrostatic double layer method (approximated by the DLVO theory) is used to produce a repulsive potential, the surface treatment can include introduction of counter-ions. When a steric approach is used, the surface treatment can include introduction of molecules, e.g., linear molecules bonded to the surface that extend into the surrounding fluid.

Any dispersant compatible with the other materials in the ink formulations that reduces or prevents agglomeration or sedimentation of uncoated or coated metal particles, such as glass-coated metal particles, can be used. Examples of preferred dispersants include but are not limited to: copolymers with acidic groups, such as the BYK® series, which include phosphoric acid polyester (DISPERBYK®111), block copolymer with pigment affinic groups (DISPERBYK®2155), alkylolammonium salt of a copolymer with acidic groups (DISPERBYK®180), structured acrylic copolymer (DISPERBYK®2008), structured acrylic copolymer with 2-butoxyethanol and 1-methoxy-2-propanol (DISPERBYK®2009), JD-5 series and JI-5 series, including Sun Chemical SunFlo P92-25193 and SunFlo SFDR255 (Sun Chemical Corp., Parsippany, N.J. USA), Solsperse™ hyperdispersant series (Lubrizol, Wickliffe, Ohio USA) including Solsperse™ 33000, Solsperse™ 32000, Solsperse™ 35000, Solsperse™ 20000, which are solid polyethyleneimine cores grafted with polyester hyperdispersant, and polycarboxylate ethers such as these in the Ethacryl series (Lyondell Chemical Company, Houston, Tex. USA), including Ethacryl G (water-soluble polycarboxylate copolymers containing polyalkylene oxide polymer), Ethacryl M (polyether polycarboxylate sodium salt), Ethacryl 1000, Ethacryl 1030 and Ethacryl HF series (water-soluble polycarboxylate copolymers).

Other presently preferred dispersants are those described in co-owned U.S. patent application Ser. No. 12/301,743, filed May 25, 2007, published as US Pat. Pub. US20090142526 which is incorporated herein in its entirety by reference. Broadly, dispersants that are the reaction product of at least one dianhydride with at least two different reactants, each of which contains a primary or secondary amino, hydroxyl or thiol functional group, and at least one of which reactants is polymeric, can be used. They can contain a unit or units represented by the formulae:

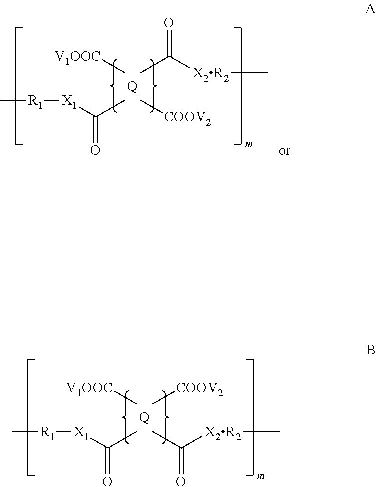

or both, in which Q is a carbon-containing linking group which may be linear, branched or cyclic aliphatic or aromatic group, or combination thereof, and can be saturated or unsaturated (isolated or conjugated), and can contain H, O, N, S, P, Si and/or halogen atoms in addition to carbon, X₁ and X₂ are NZ, O or S, and m is an integer from 1 to about 10. X₁ or X₂ is preferably NZ. Each V₁ and V₂ independently is hydrogen or a residue of an entity reactive with COOH, such as an organic or inorganic cation. Each R₁, R₂ and/or Z independently is hydrogen or a linear, branched or cyclic aliphatic or aromatic group, as well as such groups containing O, N, S, P, Si, halogen and/or metal ion in their main chain or in a side chain, and can be saturated or unsaturated (isolated or conjugated), such as alkylene, alkenylene, arylene, heteroarylene, and heterocyclic groups, or combinations thereof, which can contain ether, ester, carbonate, ketone, amino, amide, urea, urethane, C≡N and/or C═P moieties, or combinations thereof, provided that at least one R₁, R₂ or Z is polymeric. Polymeric materials are those containing a polymeric group comprising the same repeating monomer units (homopolymer) or multiple monomer units (copolymer), or both, where the monomer can be any type of monomer. Such copolymers can be further classified as random, alternating, graft, branched, block, and comb-like or combination thereof. The Q, R₁, R₂ and/or Z groups can be unsubstituted or substituted with one or more functional groups, which can be characterized as containing other atoms in addition to carbon and hydrogen. Each of the terminal groups of the dispersant will depend on the reactant(s) employed and can be independently hydrogen, halogen and/or any monovalent group corresponding to R. Examples of those dispersants where the wavy line ( [symbol] ) indicates a polymeric moiety and does not indicate any particular number of atoms, functionalities, substituents or structures, include:

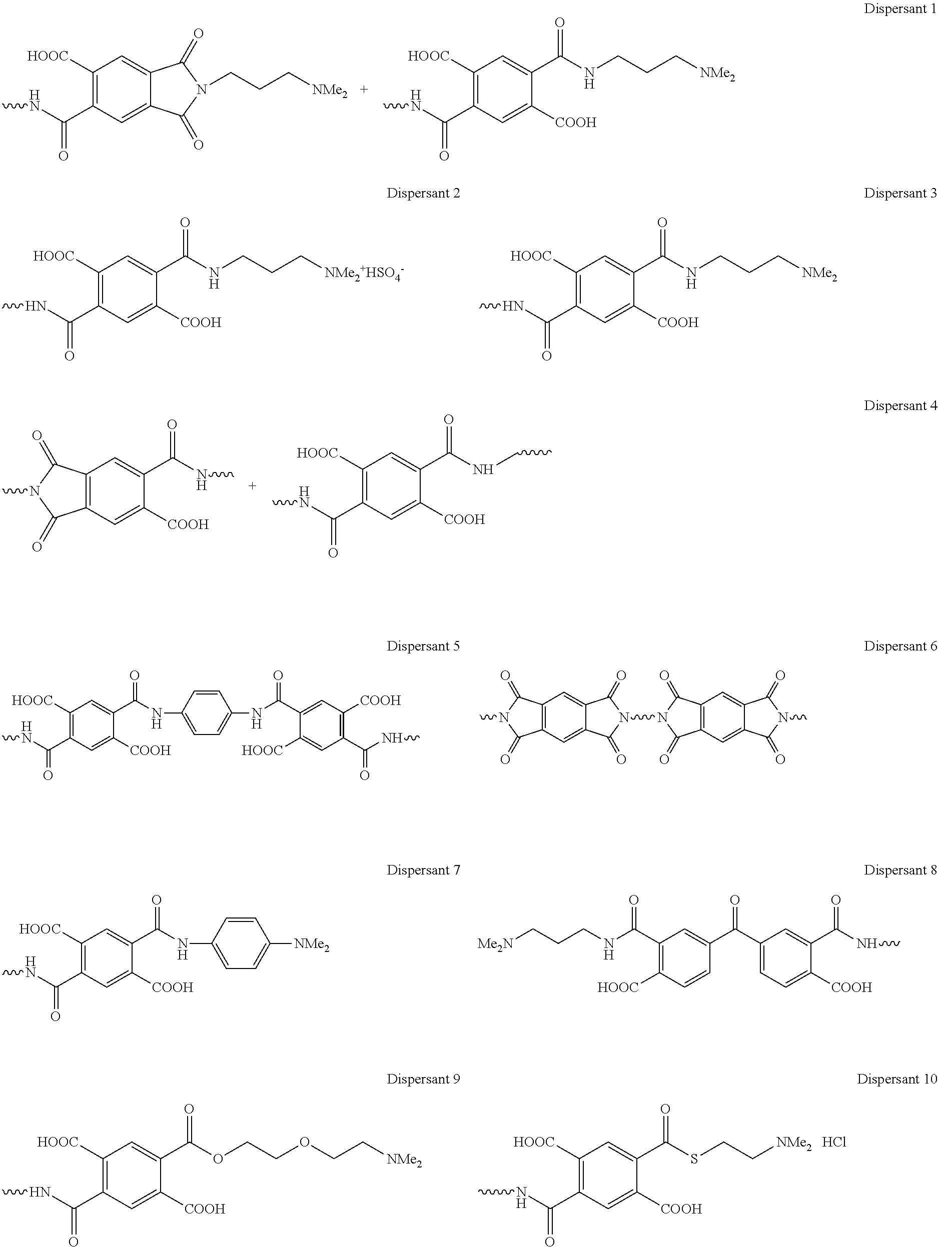

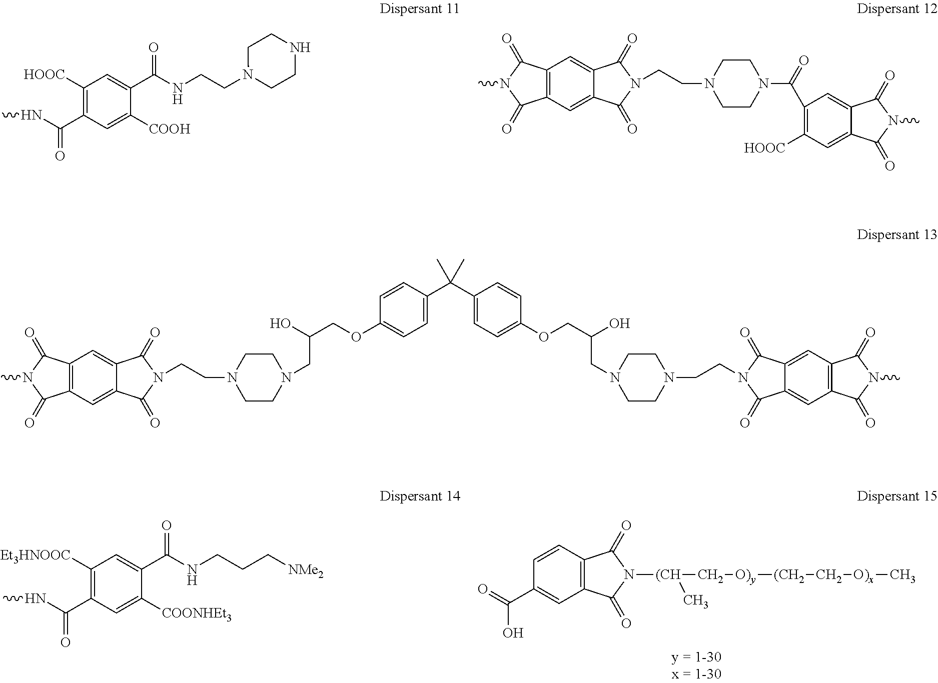

For some dispersants, the wavy line and its attached N atom

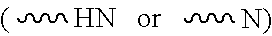

can represent a polymer containing one or two primary or secondary amine end groups. Exemplary moieties include poly(alkylene oxide)amines in which the alkylene oxide group contains 1 to 5 carbon atoms. Those containing 2 or 3 carbon atoms are preferred and are well known and commercially available materials. These amines contain a polyether backbone that can be based on propylene oxide, ethylene oxide or combinations thereof. For some dispersants, the wavy line and its attached N atom

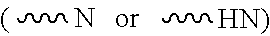

can represent a polyether amine, an amine-terminated polypropylene glycol, a polyether diamine, or a polyether triamine. Such amines can include a polypropylene glycol, polyethylene glycol or a polytetramethylene glycol backbone. For example,

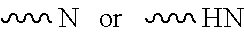

can represent:

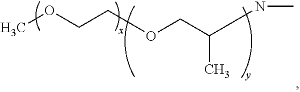

where x=0-60 and y=0-60. In some instances, x+y is between 5 and 60, preferably between 10 and 45. In some instances, x is selected from among 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 and 60, and y is selected from among 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 and 60. In a preferred embodiment, x is selected from among 3, 4, 5, 6, 7, 8, 9 and 10 and y is selected from among 25, 26, 27, 28, 29, 30, 31, 32, 33, 34 and 35 more preferably x is 6 and y is 29.

The moiety

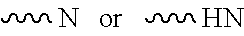

also can represent:

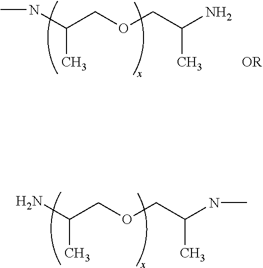

where x=2-70. In some instances, x is selected from among 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 543, 55, 56, 57, 58, 59, 60, 61, 62, 63, 64, 65, 66, 67, 68, 69 or 70.

In some embodiments, the dispersant is Dispersant 3 or Dispersant 15 or combinations thereof, where

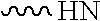

represents:

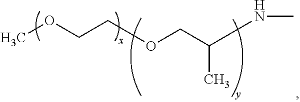

where x+y is between 5 and 60, preferably between 10 and 45. In some instances, x is selected from among 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 and 60, and y is selected from among 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 and 60. In a preferred embodiment, x is selected from among 5, 6, 7, 8, 9 and 10 and y is selected from among 25, 26, 27, 28, 29 and 30, more preferably x is 6 and y is 29.

The amount of dispersant in the present inventive ink compositions can be between 0.2 to 20% by weight of the composition, preferably between 1 to 10% by weight. For example, the ink composition can include a dispersant that is 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9% or 10.0% by weight of the ink composition.

Anti-Agglomeration Agent

The aerosol jet metal particle containing ink compositions provided herein also can include an anti-agglomeration agent, which inhibits agglomeration of the coated or uncoated metal particles. Due to their small size and their high surface energy, micron or nanoparticles or metal can exhibit a strong tendency to agglomerate and form larger secondary particles (agglomerates). The metal particles of the ink composition can include an anti-agglomeration agent, such as a coating of the metal particle, or at least a part of the surface of the metal particle, with an anti-agglomeration agent.

The anti-agglomeration agent can be or contain a polymer, preferably an organic polymer. The polymer can be a homopolymer or a copolymer. The organic polymer can be a reducing agent. Exemplary anti-agglomeration agents include as monomers one or a combination of polyvinyl pyrrolidone, vinyl pyrrolidone, vinyl acetate, vinyl imidazole and vinyl caprolactam.

The anti-agglomeration agent generally acts by shielding (e.g., sterically and/or through charge effects) the metal particles from each other to at least some extent and thereby substantially prevents a direct contact between individual metal particles. The anti-agglomeration agent preferably is adsorbed on the surface of the metal particles, such as by formation of a bong or through ionic interactions. Preferably, if absorbed via formation of a bond, the bond is a non-covalent bond, but still is strong enough for the anti-agglomeration agent on the metal particle to withstand a washing operation. In particular, it is preferred that merely washing the metal particles with the solvent at room temperature will not remove more than a minor amount (e.g., less than about 10 percent, or less than about 5 percent, or less than about 1 percent) of the anti-agglomeration agent that is in intimate contact with and interacting with the metal particle surface. The anti-agglomeration agent does not have to be present as a continuous coating surrounding the entire surface of a metal particle. Rather, in order to prevent a substantial amount of agglomeration of the metal particles, it often will be sufficient for the anti-agglomeration agent to be present on only a portion of the surface of a metal particle.

The amount of anti-agglomeration agent, when present in the inventive ink compositions provided herein, can be between 0.05 to 20% by weight of the composition, preferably between 0.1% to 10% by weight of the composition or 0.5% to 5% by weight of the composition. For example, the ink composition can include a dispersant that is 0.05%, 0.075%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, 9.0%, 9.1%, 9.2%, 9.3%, 9.4%, 9.5%, 9.6%, 9.7%, 9.8%, 9.9% or 10.0% by weight of the ink composition.

### Particle Size

The particles can be isotropic or anisotropic. Anisotropic particles can have a length and a width. Typically the particles can have a diameter or width or length between 1 nm to 2500 nm. For example, the particles can have a diameter (width) of 1000 nm or less. The particle diameter (as determined by a light scattering method) of the uncoated or coated metal particle, such as a glass-coated particle, is preferably between 1 nm to 1000 nm. Particle diameter size from 1000 nm up to 2000 nm is possible but may not effectively pass through the atomizer if larger than 2000 nm. As atomizer technology unfolds, it may be possible or even preferred to use metal flakes above 2000 nm for certain applications. The dispersed average particle diameter preferably is between 1 nm to 1000 nm. More preferably, the average particle diameter of the uncoated or coated metal particle is within the range of about 5 nm to 500 nm or 500 nm to 1000 nm. The average particle diameter of the uncoated or coated metal particle can be within the range of about 5 nm to 50 nm, or 10 nm to 250 nm, or 25 nm to 250 nm, or 50 nm to 150 nm, or 30 nm to 100 nm, or 250 nm to 500 nm, or 750 nm to 1000 nm.

The particles can be cubes, flakes, granules, cylinders, rings, rods, needles, prisms, disks, fibers, pyramids, spheres, spheroids, prolate spheroids, oblate spheroids, ellipsoids, ovoids or random non-geometric shapes. In particular, the particles can be spherical, spheroidal or flakes.

Particle Size Distribution

Another preferred property of the uncoated or coated, surface treated or untreated metal particles is the size distribution of the particles. A narrow particle size distribution is advantageous for the inventive aerosol jet ink composition as a narrow particle size distribution produces good print line uniformity, deposition rate stability, print line dimension stability and the ability to form surface features having a fine line width, high resolution and high packing density. In general, the narrower the particle size distribution, the more stable the ink will be over the course of long print runs. Large particle size distribution can cause metal particle separation during atomization and can result in inconsistent printing rate and line dimension. The coated or uncoated metal particle size distribution preferably undergoes very little change before and after printing. Single and bimodal particle size distributions are both acceptable as long as the particle size distribution before and after printing does not vary significantly, such as demonstrating a variance in particle size distribution that is less than 10%, or less than 5%, or less than 1% from the particle size distribution of the ink composition prior to printing.

Particle Coatings

The metal particles can be uncoated or coated. For example, metal particles can be coated with glass, such as SiO₂. The uncoated or coated metal particles can be untreated or can be surface-treated with one or more organic substances or polymers or combinations thereof (e.g., for dispersion stability).

Glass

The metal particles of the inventive ink composition can be coated with glass. Glass-coated metal particles are known in the art and can be prepared by any of the methods known in the art, such as described in U.S. Pat. Nos. 7,621,976 and 6,870,047; US App Pub 20110059017, and in Ruys et al., “The nanoparticle-coating process: a potential sol-gel route to homogeneous nanocomposites,” Materials Science and Engineering A265: 202-207 (1999); Brown & Doom, “Optimization of the Preparation of Glass-Coated Dye-Tagged Metal Nanoparticles as SERS Substrates,” Langmuir 24: 2178-2185 (2008); and Brown & Doom, “A Controlled and Reproducible Pathway to Dye-Tagged, Encapsulated Silver Nanoparticles as Substrates for SERS Multiplexing,” Langmuir 24: 2277-2280 (2008). In general, a metal particle can be reacted with a glass precursor and subjected to conditions under which the glass precursor forms a glass coating on the metal particle. Such surface coatings can be prepared using a microemulsion approach, a hetero-coagulation approach or solution coating, e.g., seeded growth principle. Any glass precursor known in the art can be used. The glass precursors include glass-forming components. Examples of glass precursors include oxides, glass frit, silicates, such as tetraethyl orthosilicate, and other inorganic glass components (e.g., such as those described in U.S. Pat. No. 5,837,025) and combinations thereof. The oxides can include an oxide of alumina, aluminum, barium, beryllium, bismuth, chromium, cobalt, copper, gadolinium iridium, iron, magnesium, manganese, molybdenum, nickel, niobium, silica, silicon, silver, tantalum, thorium, tin, titanium, tungsten, vanadium, yttrium, zinc, zirconia or zirconium or combinations thereof. Generally, the glass coating is less than 5 wt % based on the weight of the coated particle.

For example, metal particle nuclei can be solution-coated with a glass precursor, such as tetraethyl orthosilicate in ethanol, catalyzed by acetic acid as the deposition catalyst. In an exemplary method, metal particles to be coated are dispersed in an alcohol, such as ethanol, and 20 vol. % acetic acid (99.8%, Sigma Aldrich) can be added as the catalyst for initiation of the tetraethyl orthosilicate hydrolysis. Water is added at a concentration 2 to 4 times in excess of the amount of water calculated to be required for hydrolysis of the tetraethyl orthosilicate. After thoroughly mixing, such as between 5 minutes and 30 minutes, an amount of glass precursor tetraethyl orthosilicate calculated to yield the desired glass coating thickness, is added to the metal particle/acetic acid mixture with constant mixing, and the reaction is allowed to continue until completion, which can be a reaction period of between 30 minutes and 48 hours.

The glass-coated metal particles also can be produced by generation of an aerosol from a liquid containing metal and optionally glass precursor, where the liquid then is subjected to elevated temperatures in a furnace, where liquid in the aerosol droplets is vaporized to permit formation of the desired particles, which can be collected in a particle collector. Glass frit or glass precursors can be included in the liquid stream

The glass coating can be varied to be between several nanometers to tens of nanometers thick, depending on the end application. For example, the glass coating can be between 5 nm and 250 nm thick, and generally can be between 1 nm and 100 nm thick, e.g., 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm and 100 nm.

Solvents

The inventive aerosol printing inks provided herein include a solvent or a combination of solvents. The solvents in the inventive inks are used to form a suspension of coated or uncoated metal particles suitable for aerosol generation. The solvents preferably are a liquid that is capable of stably dispersing untreated coated or uncoated metal particles in a composition containing a dispersant or an anti-agglomeration substance used for stabilizing the metal particles. The solvents also preferably can be a liquid that is capable of stably dispersing surface-treated coated or uncoated metal particles in a composition, where the surface treatment includes a dispersant or an anti-agglomeration substance used for stabilizing the metal particles.

Preferably, the ink will remain stable at room temperature for several days or weeks or months without substantial agglomeration and/or settling of the coated or uncoated metal particles. Therefore, the solvent polarity would preferably be compatible with the anti-agglomeration materials or dispersant in the ink composition or any anti-agglomeration material or dispersant adsorbed on the surface of the coated or uncoated metal particles. For example, a dispersant or an anti-agglomeration substance which contains one or more polar groups is suitable for use with a polar protic solvent, whereas a dispersant or an anti-agglomeration substance which lacks polar groups will preferably be combined with an aprotic, non-polar solvent. The solvent of the present invention ink may contain a mixture of two or more solvents with the ratio adjusted to achieve different properties.

The solvent used in the inventive aerosol jet inks provided herein evaporates after printing. The pneumatic atomization of the aerosol jet inks requires a large volume of gas. Volatile solvents in an ink composition tend to be stripped out quickly, resulting in an aerosol jet ink exhibiting an increasing viscosity, higher ink solid content, lowered output rate and clogging of the atomizer components. Choosing a solvent with high boiling point and low vapor pressure is preferred as these impart good long term printing stability. Solvent with less than about 1 mmHg vapor pressure, preferably less than about 0.1 mmHg vapor pressure, will be more stable and thus preferred for longer print runs. Solvents with vapor pressure higher than 1 mmHg will be stripped more quickly and thus are less preferred choices.

Any solvent having a boiling point of 100° C. or greater and a low vapor pressure, such as 1 mmHg vapor pressure or less, can be used in the aerosol jet ink compositions provided herein. For example, a low vapor pressure solvent having a boiling point of 100° C. or greater, or 125° C. or greater, or 150° C. or greater, or 175° C. or greater, or 200° C. or greater, or 210° C. or greater, or 220° C. or greater, or 225° C. or greater, or 250° C. or greater, can be selected.

Examples of preferred low vapor pressure solvents include but are not limited to diethylene glycol monobutyl ether; 2-(2-ethoxyethoxy)ethyl acetate; ethylene glycol; terpineol; trimethylpentanediol monoisobutyrate; 2,2,4-trimethyl-1,3-pentanediol monoisobutyrate (Texanol); dipropylene glycol monoethyl ether acetate (DOWANOL® DPMA); tripropylene glycol n-butyl ether (DOWANOL® TPnB); propylene glycol phenyl ether (DOWNAL® PPh); dipropylene glycol n-butyl ether (DOWANOL® DPnB); dimethyl glutarate (DBES Dibasic Ester); dibasic ester mixture of dimethyl glutarate and dimethyl succinate (DBE 9 Dibasic Ester); tetradecane, glycerol; phenoxy ethanol (Phenyl Cellosolve®); dipropylene glycol; benzyl alcohol; acetophenone; γ-butyrolactone; 2,4-heptanediol; phenyl carbitol; methyl carbitol; hexylene glycol; diethylene glycol monoethyl ether (Carbitol™); 2-butoxyethanol (Butyl Cellosolve®); 1,2-dibutoxyethane (Dibutyl Cellosolve®); 3-butoxybutanol; and N-methylpyrrolidone.

Some of these solvents also inhibit crystallization compared to high vapor pressure solvents.

Solvents having higher vapor pressure could be used alone or in combination with low vapor pressure solvents. A partial list of higher vapor pressure solvents includes alcohol, such as ethanol or isopropanol; water; amyl acetate; butyl acetate; butyl ether; dimethylamine (DMA); toluene; and N-methyl-2-pyrrolidone (NMP). It is preferred, however, that the solvents in the aerosol jet inks be limited to solvents having a vapor pressure of less than about 1 mmHg vapor pressure, and more preferably less than about 0.1 mmHg vapor pressure.

The amount of solvent, whether present as a single solvent or a mixture of solvents, in the present inventive aerosol jet inks is preferably between 10 to 50% by weight. For example, the aerosol jet inks provided herein can contain an amount of solvent that is 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 20.5%, 21%, 21.5%, 22%, 22.5%, 23%, 23.5%, 24%, 24.5%, 25%, 25.5%, 26%, 26.5%, 27%, 27.5%, 28%, 28.5%, 29%, 29.5%, 30%, 30.5%, 31%, 31.5%, 32%, 32.5%, 33%, 33.5%, 34%, 34.5%, 35%, 35.5%, 36%, 36.5%, 37%, 37.5%, 38%, 38.5%, 39%, 39.5%, 40%, 40.5%, 41%, 41.5%, 42%, 42.5%, 43%, 43.5%, 44%, 44.5%, 45%, 45.5%, 46%, 46.5%, 47%, 47.5%, 48%, 48.5%, 49%, 49.5% or 50% based on the weight of the ink composition.

Additives

Optionally, additives can be incorporated into the inks, e.g., to enhance ink performance. The use of additives is well known in the art of ink formulation and there are many different types of additives that can be included. A partial, non-limiting list of additives that can be used in the present aerosol jet ink compositions includes:
Rheology/viscosity modifiers (some preferred materials include styrene allyl alcohol, ethyl cellulose, 1-methyl-2-pyrrolidone (BYK®410), urea modified polyurethane (BYK®425), modified urea and 1-methyl-2-pyrrolidone (BYK®420), SOLSPERSE™ 21000, polyester, acrylic polymers, carboxyl methyl cellulose, xanthan gum, diutan gum and rhamsan gum);
Adhesion promoters (some preferred materials include silane coupling agents, titanates, organometallic coupling agent, and bismuth nitrate). The adhesion promoter is preferably soluble in the ink solvent. Adhesion promoters can also be applied to the substrate prior to printing by the same printing method or by an alternative method such as spin coating or dip coating. Depending on the substrate and sintering temperature, adhesion promoter may or may not be needed. Exemplary adhesion promoters include silane coupling agents, such as N-2-(aminoethyl)-3-aminopropyl-trimethoxysilane, 3-glycidoxypropyltrimethoxysilane, n-beta-(aminoethyl)-gamma-aminopropyl trimethoxysilane, aminopropyl-triethoxysilane and 3-glycidoxpropyl-trimethoxysilane, bismuth nitrate, titanates, blocked isocyanates, such as Trixene BI 7963, and organo metallic coupling agents, such as multi-functional titanates, zirconates and aluminates such as, e.g., alkyl titanates, and titanium diisopropoxide.
Wetting agents and surfactants for surface tension modification (some preferred materials include polyether modified polydimethylsiloxane (BYK®307), xylene, ethylbenzene, blend of xylene and ethylbenzene (BYK® 310), octamethylcyclo-tetrasiloxane (BYK®331), alcohol alkoxylates (e.g., BYK® DYNWET) and ethoxylates.
Crystallization inhibiters (particularly for larger metal particles)—The crystallization inhibitors prevent crystallization and the associated increase in surface roughness and promote film uniformity during curing at elevated temperatures and/or over extended periods of time. They can also be helpful to increase conductivity. Examples of crystallization inhibitors include polyvinylpyrrolidone (PVP), lactic acid, ethyl cellulose, styrene allyl alcohol and diethylene glycol monobutyl ether.
Biocides—Bacteria and fungus can attack the ink components during the ink storage. The addition of a biocide can increase the shelf life of the ink. The biocide can be selected from among algicide, bactericide, fungicide and a combination thereof. Examples of suitable biocides include consisting of silver and zinc, and salts and oxides thereof, sodium azide, 2-methyl-4-isothiazolin-3-one, 5-chloro-2-methyl-4-isothiazolin-3-one, thimerosal, iodopropynyl butylcarbamate, methyl paraben, ethyl paraben, propyl paraben, butyl paraben, isobutylparaben, benzoic acid, benzoate salts, sorbate salts, phenoxyethanol, triclosan, dioxanes, such as 6-acetoxy-2,2-dimethyl-1,3-dioxane (available as Giv Gard® DXN from Givaudam Corp., Vernier, Switzerland), benzyl alcohol, 7-ethyl-bicyclo-oxazolidine, benzalkonium chloride, boric acid, chloroacetamide, chlorhexidine and combinations thereof.
Binders or resins (preferably lower molecular weight to reduce atomization capacity). Exemplary lower molecular weight resins include ethylcellulose, acrylic polymer, and polyester.
Defoaming agents. Some preferred materials include silicones, such as polysiloxane (BYK 067 A), heavy petroleum naphtha alkylate (BYK®088), and blend of polysiloxanes, 2-butoxyethanol, 2-ethyl-1-hexanol and Stoddard solvent (BYK®020); and silicone-free defoaming agents, such as hydrodesulfurized heavy petroleum naphtha, butyl glycolate and 2-butoxyethanol and combinations thereof (BYK®052, BYK®A510, BYK®1790, BYK®354 and BYK®1752).

It is preferred that additives be used in amounts less than 5% to minimize their effect on conductivity, however they could be used at higher amounts, such as between 5% to 15% based on the weight of the ink composition, in some instances. The amount of additives, when present, generally is between 0.05% to 5% based on the weight of the ink composition. The amount of additives, when present, can be 0.05%, 0.06%, 0.07%, 0.08%, 0.09%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9% or 5.0% based on the weight of the ink composition.

Viscosity of the Inventive Inks

The preferred viscosity of the uncoated or coated metal particle aerosol jet ink compositions, including glass-coated metal particle aerosol jet ink compositions, is less than about 2500 cP (for Optomec M³D single nozzle printer) and less than about 200 cP (for Optomec M³D multi nozzle printer), but the inventive inks provided herein are not limited to this viscosity and could be useful at higher or lower viscosity depending on the printing apparatus and printing conditions. For example, the viscosity of the uncoated or coated metal particle aerosol jet ink compositions, including glass-coated metal particle aerosol jet ink compositions, provided herein can be in the range of at or about 200 cP to 2500 cP, or at or about 250 cP to 2000 cP, or at or about 500 cP to 1500 cP, or at or about 750 cP to 2500 cP, or less than 1000 cP at a shear rate of about 10 sec⁻¹ at room temperature. The viscosity of the uncoated or coated metal particle aerosol jet ink compositions, including glass-coated metal particle aerosol jet ink compositions, provided herein also can be in the range of at or about 50 cP to 500 cP, or at or about 50 cP to 250 cP, or at or about 75 cP to 200 cP, or at or about 100 cP to 250 cP, or less than 500 cP at a shear rate of about 10 sec⁻¹ at room temperature (25° C.). The inventive inks generally have a viscosity that is greater than 20 cP at a shear rate of at or about 10 sec⁻¹ at aerosol jet printing operating temperatures, such as between 30° C. and 100° C. This is in sharp contrast with inkjet inks, which typically have a viscosity of less than about 40 cP, and generally less than 20 cP at a shear rate of about 10 sec⁻¹ at room temperature. Some aerosol jet metal particle ink compositions can be heated prior to deposition to reduce the viscosity of the ink composition.

Surface Tension of the Inventive Inks

The surface tension for the inventive inks is less critical for printing compared to traditional inkjet printing, and is preferably in the range from 1-250 dynes/cm measured at room temperature. For example, the surface tension of the inventive inks provided herein can be between at or about 1 to 250 dynes/cm, or at or about 5 to 225 dynes/cm, at or about 10 to 200 dynes/cm, or at or about 15 to 175 dynes/cm, or at or about 25 to 150 dynes/cm measured at room temperature. This is in sharp contrast with inkjet inks which typically have and often require a surface tension less than 60 dynes/cm.

Storage Stability

The inventive inks described in the present application are formulated specifically for aerosol jet such as M³D printing and preferably exhibit shelf-life up to 1-year or more. With sonication, any uncoated or coated metal particle, e.g., glass-metal particles, that may settle during storage can easily be re-dispersed to their original particle size distribution. When used for aerosol jet printing, such as M³D printing, the inks of the present invention will maintain good printability with good printed line dimension stability for extended print runs (a few hours up to several days, or possibly longer).

Post-Printing Treatments

The aerosol jet uncoated metal particle ink compositions according to the present invention typically are printed and then are converted to conductive lines or features, such as by heat treatment at temperatures between 150 to 200° C. with excellent conductivity, thereby allowing the use of a wide variety of substrates. The heat treatment can be accomplished by treatment with a highly focused laser or other sintering methods known in the art.

The aerosol jet glass-coated metal particle ink compositions of the present invention are preferably printed and then sintered into conductive lines or features at about 700 to 900° C. for about 20-30 minutes to form 10-150 micron lines with very good edge definition, and excellent conductivity. The heat treatment can be accomplished by treatment with a highly focused laser or other sintering methods known in the art.

Substrates

Examples of preferred substrates include: glass; indium tin oxide (ITO); polymer substrates; BT (Resin)—rigid printed circuit boards (PCBs); FR-4 (Flame Resistant 4)—rigid PCBs; Kapton (polyimide film)—flex circuits; molybdenum (Mo) coatings [e.g., on glass or silicon]—flat panel display (FPD) applications; polyethylene terephthalate (PET)—flex circuits; silica (SiO₂)—FPD and semiconductor applications; silicon (Si)—semiconductor applications; silicon nitride (Si₃N₄) coatings [e.g., on glass or silicon]—FPD and semiconductor applications; silicon nitride; and SiNₓ coated multicrystalline and single crystalline wafers.

Polymer substrates can include polyfluorinated compounds, polyimides, epoxies (including glass-filled epoxy), polycarbonates, acrylates, acetates, nylons, polyesters, polyethylenes, polypropylenes, polyvinyl chlorides, acrylonitriles, polyethylene terephthalate, butadiene (ABS), styrene, poly(methyl methacrylate), silicone nitride, polyethylene naphthalate (PEN), polyetherimides, polyamide and polyamide-imides and combinations thereof. The polymer substrate can be present as a coating, such as on a flexible fiber board, a non-woven polymeric fabric, a cloth, a plastic, a metallic foil, a cellulose-based material such as wood or paper, or glass.

Printed Line Width

The uncoated or coated metal particle aerosol jet ink compositions of the present invention can be utilized to form conductive lines or features with good electrical properties, as well as producing seed layer lines, e.g., on solar cell substrates. For example, the uncoated or coated metal particle aerosol jet ink compositions and print methods using the uncoated or coated metal particle aerosol jet ink compositions of the present invention can be utilized to form conductive features on a substrate, wherein the features have a feature size (i.e., average width of the smallest dimension) in a wide range of printed line widths, for example not greater than about 200 micrometers (μm); not greater than about 150 μm; not greater than about 100 μm; not greater than about 75 μm; not greater than about 50 μm; not greater than about 20 μm; not greater than about 15 μm; or not greater than about 10 μm.

In the case of seed layer lines on solar cell substrates, the printed line widths, for example, are not greater than about 40 micrometers (μm), preferably not greater than about 30 μm and most preferably, not greater than about 20 μm.

Aspect Ratio (Height to Width)

For aerosol jet ink deposition, print thickness for a given ink can depend on the printer parameters, including linear print speed, aerosol flow parameters and the size of the nozzle used or combinations thereof. Printed line thickness can be modulated by the formulation of the aerosol jet ink, such as modifying viscosity or solid content or both. The aerosol jet ink also can be modified to control spreading of the ink on the substrate when deposited. Printed line height can be measured using any method known in the art, for example, using an optical or a stylus profilometer (e.g., from Nanovea, Irvine, Calif. USA). Typical thickness for aerosol jet deposition in one pass of the inventive aerosol jet coated or uncoated metal conductive printing inks provided herein, particularly the aerosol jet coated or uncoated silver conductive printing inks, generally had a thickness that was between at or about 0.05 microns and at or about 2.5 microns. For example, one pass deposition of the inventive metal conductive printing inks can result in a print height of 0.05 μm, 0.06 μm, 0.07 μm, 0.08 μm, 0.09 μm, 0.10 μm, 0.15 μm, 0.2 μm, 0.25 μm, 0.3 μm, 0.35 μm, 0.4 μm, 0.45 μm, 0.5 μm, 0.55 μm, 0.6 μm, 0.65 μm, 0.7 μm, 0.75 μm, 0.8 μm, 0.85 μm, 0.9 μm, 0.95 μm, 1 μm, 1.10 μm, 1.15 μm, 1.2 μm, 1.25 μm, 1.3 μm, 1.35 μm, 1.4 μm, 1.45 μm, 1.5 μm, 1.55 μm, 1.6 μm, 1.65 μm, 1.7 μm, 1.75 μm, 1.8 μm, 1.85 μm, 1.9 μm, 1.95 μm, 2 μm, 2.10 μm, 2.15 μm, 2.2 μm, 2.25 μm, 2.3 μm, 2.35 μm, 2.4 μm, 2.45 μm or 2.5 μm. Multiple consecutive passes can achieve total thicknesses of 10 microns and more.

The printed lines formed by the inventive aerosol jet printing inks provided herein provide an aspect ratio (height to width) of from about 0.05:10 and 3:10, and preferably greater than or equal to 0.02, in one pass printed with a 150 micron tip, particularly for lines having a width not greater than 25 microns, preferably 20 microns or less and more preferably for lines less than 15 microns.

Conductivity

The electrically conductive features or lines formed by printing with the metal-particle containing inks of the present invention have excellent electrical properties. By way of a non-limiting example, the printed lines can have a resistivity with good sintering that is not greater than about 5 times, or not greater than about 2 to 5 times the resistivity of the pure bulk metal, particularly when the sintering conditions allow the printed lines to reach resistivity entitlement, i.e., essentially complete sintering. The sheet resistance of the printed silver ink typically is less than 5 ohm/sq, preferably less than 1.5 ohm/sq and most preferably less than 0.75 ohm/sq for fine lines printed via aerosol jet deposition in combination with sintering. The sintering can be achieved using any method known in the art, such as in conduction ovens, IR ovens/furnaces as well as through light (“photonic”) curing processes, including highly focused lasers or using pulsed light sintering systems (e.g., from Xenon Corporation or NovaCentrix; also see U.S. Pat. No. 7,820,097).

Methods of Producing Metal-Particle Containing Inks

The method of producing these inks includes the mixing of metal particles, dispersant, solvent, adhesion promoter and/or additives by a high-speed stirring system such as Dispermat or ultrasonic machine for 5 to 40 minutes depending on the formulation. After mixing, the ink may be filtered by nylon syringe or filter membrane to remove large particles. The time and energy required to reach the desired dispersed metal particle size is dependant on the metal particles and other materials in an individual formula, as well as the amount of each.

### Measurement of Particle Size and Particle Size Distribution

A volume average particle size can be measured by using a Coulter Counter™ particle size analyzer (manufactured by Beckman Coulter Inc.). The median particle size also can be measured using conventional laser diffraction techniques. An exemplary laser diffraction technique uses a Mastersizer 2000 particle size analyzer (Malvern Instruments LTD., Malvern, Worcestershire, United Kingdom), particularly a Hydro S small volume general-purpose automated sample dispersion unit. The mean particle size also can be measured using a Zetasizer Nano ZS device (Malvern Instruments LTD., Malvern, Worcestershire, United Kingdom) utilizing the Dynamic Light Scattering (DLS) method. The DLS method essentially consists of observing the scattering of laser light from particles, determining the diffusion speed and deriving the size from this scattering of laser light, using the Stokes-Einstein relationship.

### Methods of Evaluating Adhesion on Various Substrates

Adhesion can be measured using the adhesion tape test method. In an exemplary method, a strip of Scotch® Cellophane Film Tape 610 (3M, St. Paul, Minn.) is placed along the length of each print and pressed down by thumb twice to ensure a close bond between the tape and the print. While holding the print down with one hand, the tape is pulled off the print at approximately a 180° angle to the print. Adhesion performance is measured by estimating the percent of ink removed from each print by the tape and rating the performance by estimating the amount of ink removed from the print. Adhesion test results can be classified as “Excellent” (no ink removed), “Good” (minimal or slight amount of ink removed), or “Poor” (significant amount of ink removed).

### Methods of Evaluating Printed Line Conductivity

The resistivity of the printed line was measured using a semiconductor parameter analyzer (e.g., a Model 4200-SCS Semiconductor Characterization System from Keithley Instruments, Inc., Cleveland, Ohio USA) connected to a Suss microprobe station to conduct measurements in an I-V mode. The sheet resistance of the conductive track (length L, width W and thickness t) was extracted from the equation

$$R = {R}_{sheet} \times \frac{L}{W}$$

where R is the resistance value measured by the equipment (in Ω), and Rₛₕₑₑₜ is expressed in Ω/square.

C. UV Curable Dielectric Inks

It also is an object of the present invention to provide aerosol jet printable UV curable dielectric ink compositions. It also is an object of the present invention to provide methods of making the aerosol jet printable UV curable dielectric printing inks. It also is an object of the present invention to provide aerosol jet printing methods utilizing the inventive aerosol jet UV curable dielectric inks. Also provided are methods to maintain printed line width across an interface where two different surface energies may exist (e.g., glass and ITO coated glass). Direct printing of dielectric features is advantageous to current methods of lithographic or other processing because of the decreased number of steps required, therefore increasing efficiency and throughput.

The aerosol jet printable UV curable dielectric ink compositions provided herein are preferably optically clear (minimal yellowing or other discoloration) dielectric acrylic-based inks with good adhesion to indium tin oxide (ITO, or tin-doped indium oxide) and glass that preferably maintains optical clarity on exposure to high temperature (for example greater than 200° C.) for exposure times up to 30 minutes. The excellent transparency and retention of transparency (no noticeable discoloration or no visible color formation) upon heat treatment (even when heated for extended periods of time, such as 200° C. for 30 minutes) of the inventive aerosol jet printable UV curable dielectric inks allows for wider line printing without visible loss in optical properties, attributes particularly important in some applications, such as touch screen displays. The transparency of the inventive aerosol jet printable UV curable dielectric inks allows the formation of larger lines in certain applications. For example, touch screen manufacturers can opt to use 100-150 micron wide lines instead of 30 microns. The viscosity and vapor pressure of the aerosol jet printable UV curable dielectric ink compositions are acceptable for aerosol jet printing.

The aerosol jet UV curable dielectric ink compositions of the present invention preferably have very good storage stability, very good printing quality, and very good print stability, thereby enabling the formation of very fine dielectric features on a variety of substrates. The ink compositions can include various combinations of monomer, oligomer, photoinitiator, adhesion promoters and other additives for desired properties. The compositions can be deposited onto a substrate and cured to foam a dielectric having good electrical insulation and adhesion properties.

The dielectric inks of the present application are UV curable formulations that are preferably solvent-free or the compositions are limited to contain small amounts of solvents, preferably containing less than about 2% solvent, more preferably containing less than about 1%, and most preferably containing less than about 0.5%. Small amounts of solvent addition may used to control dry/cured film thickness, ink rheology as well as surface tension properties. The dielectric inks of the present application could also include adhesion promoters and other additives to improve rheology and/or adhesion to substrates.

For certain applications, the addition of a colorant or a UV excitable fluorophore may be desirable in order to visualize/inspect the dielectric layer. The deposited coating at a thickness of about 3 μm is greater than 95% transparent (has a total light transmission grater than 95%), preferably is 99% transparent (has a total light transmission grater than 99%), in the optical spectrum and maintains optical clarity upon exposure to elevated temperatures, such as 200° C. for up to 30 minutes. The ink also has good adhesion to glass and ITO substrates, as well as to metal, such as silver, nanoparticle inks deposited on top of the dielectric. The strong adhesion to both the substrate and the over-printed metal, e.g., silver develops during the thermal cure of the silver ink. The aerosol jet UV curable dielectric ink compositions of the present invention exhibit excellent compatibility with silver ink, particularly the inventive aerosol jet coated or uncoated metal conductive inks provided herein, including the inventive aerosol jet silver inks, to create crossovers that are critical in the manufacturing of printed electronic circuits. The compatibility is measured by the ability to print fine, continuous conductive silver tracks on top of the dielectric with good edge definition. The ink may also be printed on other types of substrates such as thermoplastic substrates (e.g., polyester, polycarbonate, acrylic and polyimide), metals, and laminates (e.g., flame resistant 4 (FR-4) epoxy boards).

In order to improve adhesion or wettability, the substrate may need to be pre-treated through chemical, physical and/or mechanical process. For instance, glass and ITO substrate may require plasma treatment to clean the surface and provide a suitable surface tension for best printing results. Similarly, thermoplastic substrates such as PET may need to be coated with a primer and/or be plasma treated.

Any nitrogen plasma treatment known in the art can be used. In an exemplary nitrogen plasma treatment, nitrogen gas is introduced into a chamber that contains electrodes to produce a nitrogen atmosphere, and high or low frequency voltage is supplied to the electrodes to form a nitrogen plasma. The nitrogen plasma treatment can be performed using decoupled plasma or a remote plasma. The nitrogen atmosphere can include ammonia (NH₃) or a nitric oxide (N₂O or NO).

Though the aerosol jet UV curable dielectric ink compositions of the present invention are described as UV-curable, in an alternate embodiment, they can be thermally cured, preferably at about 150-250° C. for about 30 minutes rather than UV cured. Optionally, the inks would be both UV and thermally cured to enhance performance properties. Tests showed that when thermally cured at 200° C. (with no UV cure), the aerosol jet dielectric ink compositions of the present invention performed similarly for the performance properties described in this application when compared to when the same inks were UV cured. The inks of the present invention can be cured by using both UV and thermal curing means.

Oligomers

The aerosol jet UV curable dielectric ink compositions contain mixtures of acrylic monomers and oligomers with an appropriate UV curing agent (photoinitiator). The acrylic oligomers can be selected from the classes of polyether/polyester acrylates, urethane acrylates, acrylic acrylates, and amine modified acrylates. Examples of these materials are the Ebecryl series of oligomers from Cytec (Woodland Park, N.J. USA). A further non-limiting list of oligomers could be used in the inks of the present application includes: Additol XL 260 Urethane modified acrylic polymer; high MW; nonionic; Additol XL 425 Acrylic copolymer; contains unsaturated group; Bisomer BDDMA 1; 4-Butanediol dimethacrylate; Bisomer BGDMA 1; 3-Butyleneglycol dimethacrylate; Bisomer C13MA Isotridecyl methacrylate; Bisomer DDDMA 1; 10-Decanediol dimethacrylate; Bisomer DEGDMA HI Diethyethyleneglycol dimethacrylate; Bisomer E10BADMA Ethoxylated bisphenol A dimethacrylate; Bisomer E17BADMA Ethoxylated bisphenol A dimethacrylate; Bisomer E2BADMA Ethoxylated bisphenol A dimethacrylate; Bisomer E4BADMA Ethoxylated bisphenol A dimethacrylate; Bisomer EGDMA Ethyleneglycol dimethacrylate; Bisomer EP100DMA Polyalkyleneglycol dimethacrylate; Bisomer EP150DMA Polyalkyleneglycol dimethacrylate; Bisomer EP80DMA Polyalkyleneglycol dimethacrylate; Bisomer S20W HEA; Bisomer IDMA Isodecyl methacrylate; Bisomer PEA6 Polyethyleneglycol [6] acrylate; MethoxyPEG 2000 methacrylate; CD513; Propoxylated [2] Allyl Methacrylate; CD560 Alkoxylated Hexanediol Diacrylate; CD551 Methoxy Polyethylene Glycol (350) Monoacrylate; CD582 Alkoxylated Cyclohexane Dimethanol Diacrylate; CD9087 Alkoxylated Phenol Acrylate; CN118 Epoxy Diacrylate; CN2262 Polyester Tetraacrylate; CN2901 Aromatic Urethane Triacrylate; CN736 Chlorinated Polyester Acrylate oligomer; CN790 in EoTMPTA Acrylated Polyester Oligomer; CN9167US Urethane Acrylate; CN9001 AL Urethane Diacrylate; CN965 Aliphatic 2 func Urethane; CNUVE151 Epoxy Diacrylate; DSX 3256 Polyurethane; E94156 D1 Vehicle Urethane Acrylate; Ebecryl 130 Tricyclodecane dimethylol dimethacrylate; Ebecryl 3608 Fatty Acid Modified Epoxy Acrylate; Genomer 2255 Modified Epoxy Acrylate; Genomer 2280 Mod Bis-A Epoxy Acrylate; Genomer 4297 Aliphatic Urethane Dimethacrylate; Genomer 4316 Aliphatic 3 func Urethane; Genomer 5161 Acrylated Amine Synergist; Genomer 6050/TM Modified Polyester in TMPTA; IRR 606 non-chlorinated polyester; Laromer LR 8800 polyester triacrylate; Laromer LR 8987 aliphatic urethane acrylate in 30% HDDA; Laromer LR 9023 aromatic modified epoxy acrylate (f=2.4) in 15% DPDGA; Laromer UA 9029 V aliphatic urethane diacrylate in 30% butyl acetate; Miramer M281 PEG400 Dimethacrylate; Modaflow 2100 acrylic copolymer; low MW; FDA; Neorez U395; Omnirez 2084; Paraloid DM-55 Copolyacrylate (MMA/IBMA/proprietary monomers) dispersing resin; Photomer 3015 Bisphenol A epoxy diacrylate; Photomer 3016-40RF Bisphenol A epoxy diacrylate diluted with TPGDA; Photomer 3660 Amine modified epoxy acrylate; Photomer 4017F HDDA (hexanediol diacrylate); Photomer 4039F Phenol [2; 5 EO] acrylate; Photomer 4155 Trimethylolpropane [7 EO] triacrylate; Photomer 5662F Amine modified polyether acrylate; Photomer 6184 Aliphatic urethane triacrylate; RD698 Joncryl 611 styrene acrylic in TMPTA; SR201Allyl Methacrylate; SR101Ethoxylated Bisphenol A Dimethacrylate; SR209Tetraethylene Glycol Dimethacrylate; SR239 1; 6 Hexanediol Dimethacrylate; SR268Tetraethylene Glycol Diacrylate; SR340 2-Phenoxyethyl Methacrylate; SR454HP High Purity Ethoxylated3 Trimethylolpropane Triacrylate; SR540Ethoxylated (4) Bisphenol A Dimethacrylate; Texaphor SF73 Modified polyurethane; Laromer BDDA (butanediol diacrylate); Laromer EDGA Ethyldiglycol acrylate; Urethane Acrylate 98-283/W Aliphatic Urethane Triacrylate.

The amount of oligomer, whether present as a single oligomer or a mixture of oligomers, in the inventive UV curable aerosol jet inks generally is between at or about 50% to at or about 95% by weight of the ink composition, preferably between 60% to 95% by weight of the ink composition. For example, the UV curable aerosol jet inks provided herein can contain an amount of oligomer that is 50%, 50.5%, 51%, 51.5%, 52%, 52.5%, 53%, 53.5%, 54%, 54.5%, 55%, 55.5%, 56%, 56.5%, 57%, 57.5%, 58%, 58.5%, 59%, 59.5%, 60%, 60.5%, 61%, 61.5%, 62%, 62.5%, 63%, 63.5%, 64%, 64.5%, 65%, 65.5%, 66%, 66.5%, 67%, 67.5%, 68%, 68.5%, 69%, 69.5%, 70%, 70.5%, 71%, 71.5%, 72%, 72.5%, 73%, 73.5%, 74%, 74.5%, 75%, 75.5%, 76%, 76.5%, 77%, 77.5%, 78%, 78.5%, 79%, 79.5%, 80%, 80.5%, 81%, 81.5%, 82%, 82.5%, 83%, 83.5%, 84%, 84.5%, 85%, 85.5%, 86%, 86.5%, 87%, 87.5%, 88%, 88.5%, 89%, 89.5% 90%, 90.5%, 91%, 91.5%, 92%, 92.5%, 93%, 93.5%, 94%, 94.5%, or 95% based on the weight of the ink composition.

Monomers

Monomers that can be included in the inventive aerosol jet UV curable dielectric ink compositions can be selected from common diluent monomers commonly used and can contain acrylate functionalities from 1 to 6 or greater. Exemplary monomers include isobornyl acrylate (IBOA), dipropylene glycol diacrylate (DPDGA), hexanediol diacrylate (HDDA), tripropylene glycol diacrylate (TPGDA), trimethylol propane triacrylate (TMPTA), ethoxylated trimethylol propane triacrylate (EOTMPTA), dipentaerythritol hexaacrylate (DPHA), and pentaerythritol tetraacrylate (PETA).

A further non-limiting list of monomers that could be used in the inks of the present application includes: CD278; DEG methyl ether acrylate; CD420; 3,3,5-trimethyl cyclohexyl acrylate; CD501; 6PO-TMPTA; CN132; CD278; DEG methyl ether acrylate; DPGDA (SR508); Ebecryl 113; aliphatic monoacrylate; Ebecryl 114; phenoxyethyl-acrylate; Ebecryl 140; DiTMPTA; Ebecryl 1039; urethane monoacrylate; Ebecryl 1040; Ebecryl 3212; low viscosity epoxy acrylate; Ebecryl 8201; aliphatic urethane triacrylate; Ebecryl 8500 (MLK); FlexRez 10845; FlexRez 4584AD; NPG(PO)2DA; Octadecyl-vinylether; ODA-N; Photomer 4072; TMP-(PO)3-TA; Photomer 4127; NPG-(PO)2-DA; Photomer 5432; Photomer 6230; Photomer 8061; TPG-Monomethyl Ether-Acrylate; Photomer 8127; PO-NPG-monomethyl ether acrylate; SR238; HDODA; SR256; EOEOEA; SR306; TRPGDA; SR339; PEA; SR351; TMPTA; SR440; isooctyl acrylate; SR454; EO-TMPTA; SR484; octyldecyl acrylate; SR489D; tridecyl acrylate; SR492; 3PO-TMPTA; SR506; IBOA; SR508; DPGDA; SR531; cyclic trimethylolpropane formal acrylate; SR833S; tricyclodecane dimethanol diacrylate; TPGDA (SR306); di-PETA; EO-HDDA (Photomer 4011F) EO-TMPTA (SR454); GPTA; OTA-480 (SR9020); HDDA (SR238); PPTTA (Photomer 4171); PPTTA (Photomer 4172F) TMPTA (SR351); DiTMPTA (Ebecryl 140); acResin A 204 UV (BASF); acResin A 260 UV (BASF); acResin DS 3532 (BASF); BE-112 DP10 (Bomar); BR-7432G (Bomar); CN131; epoxy acrylate; CN131B; epoxy acrylate; CN307; polybutadiene diacrylate; CN309; polybutadiene diacrylate; CN996; aliphatic urethane acrylate; CN9021; CN9893; urethane acrylate oligomer; Dodecylvinylether; Ebecryl 230; aliphatic urethane diacrylate; Ebecryl 265; aliphatic urethane triacrylate+15% HDDA; Ebecryl 270; aliphatic urethane diacrylate; Ebecryl 2870; Polyester Acrylate (fatty acid modified); Ebecryl 303; hydrocarbon resin in HDDA; Ebecryl 3420; Ebecryl 3500; Ebecryl 4827; aromatic urethane acrylate—high elongation; low TS; high viscosity; Ebercryl 4849; 25% HDODA; Ebecryl 4866; aliphatic triacrylate+30% TPGDA; Ebecryl 657; Ebecryl 809; modified polyester acrylate; Ebecryl 811; Ebecryl 860; Ebecryl 870; Polyester hexaacrylate (fatty acid modified); Ebecryl 871; low cost version of Ebecryl 870 polyester hexaacrylate (fatty acid modified); Ebecryl 8296 (MLK) available only in EMEA; AP; Ebecryl 8402; aliphatic urethane diacrylate; high elongation; Ebecryl 8411; aliphatic urethane diacrylate+20% IBOA; Genomer 1122; Aliphatic urethane monoacrylate; Genomer 4188/EHA; Aliphatic urethane acrylate; Genomer 4215; Aliphatic urethane acrylate; Genomer 4217; Genomer 4267; Genomer 4269/M22; Aliphatic urethane acrylate; Genomer 5142; Acrylated Amine; Genomer 6043/1122; Genomer 6083/ETM; Genomer 7151; Hypro 2000×168 VTB; IRR538; KS-214 (Kustom); KS-336 (Kustom); KS-369 (Kustom); Miramer M216; NPG-(PO)2-DA; Miramer M360; TMP-(PO)3-TA; TMP-(PO)6-TA; NeoCryl B813; thermoplastic acrylic resin; 100% EMA; NeoCryl B890; thermoplastic acrylic resin; BMA/MMA; NeoCryl DJ-1156C; thermoplastic acrylic resin; MMA/BMA; NeoCryl DJ-803B; thermoplastic acrylic resin; EMA/MA; Omnimer 2084; urethane acrylate (same as Genomer 1122); Oppanol B 10 SFN (BASF); Oppanol B 30 SF (BASF); Oppanol B 80 (BASF); Paraloid B66; thermoplastic acrylic resin; Photomer 4067; Photomer 4967; Aliphatic Amine Acrylate; Photomer 6230; PRO11362; PRO11752 (Sartomer); Reactol 1717; Reactol 1717H; Reactol 110; Reactol 180; Resanon 90 (Resine Italiane); Resanon 110 (Resine Italiane); Resanon 121 (Resine Italiane); Resanon 121 (Resine Italiane); Rhoplex 1-1955 resin dispersion; RX05027; thermoplastic varnish developmental product; Cytec; RX13303; hydrocarbon resin in NPG(PO)2DA; Solmer Soltech SU5225; Solus 2100 high solids; low viscosity CAB; Tego VariPlus 1201; Tego VariPlus SK; Tego VariPlus CA; Tego VariPlus TC; Viaset 240; Vistanex LM polyisobutylene resin (BASF Oppanol; Glissopal PIB).

The amount of monomer, when present in the inventive ink, whether present as a single monomer or a mixture of monomers, in the inventive UV curable aerosol jet inks generally is between at or about 0.1% to at or about 25% by weight of the ink composition, preferably between 0.5% to 20% by weight of the ink composition. For example, the UV curable aerosol jet inks provided herein can contain an amount of monomer that is 0.1%, 0.2%, 0.3%, 0.4%, 0.5%, 0.6%, 0.7%, 0.8%, 0.9%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, 10%, 10.25%, 10.5%, 10.75%, 11%, 11.25%, 11.5%, 11.75%, 12%, 12.25%, 12.5%, 12.75%, 13%, 13.25%, 13.5%, 13.75%, 14%, 14.25%, 14.5%, 14.75%, 15%, 15.25%, 15.5%, 15.75%, 16%, 16.25%, 16.5%, 16.75%, 17%, 17.25%, 17.5%, 17.75%, 18%, 18.25%, 18.5%, 18.75%, 19%, 19.25%, 19.5%, 19.75% or 20% based on the weight of the ink composition.

Curing Agents

Curing agents that can be included in the aerosol jet UV curable dielectric ink compositions can be selected from those commonly used in UV curable acrylate systems. Exemplary curing agents include polymerization initiators known in the art, including photoinitiators. Typical photoinitiators are disclosed in U.S. Pat. No. 4,615,560, herein incorporated by reference in its entirety. Examples of curing agents include the Irgacure and Darocur product lines from CIBA as well as the Omnirad product line from IGM Resins. Exemplary curing agents include 1-hydroxy-cyclohexyl-phenyl-ketone, 2,4,6-trimethyylbenzoyl-diphenyl phosphine oxide, 2-hydroxy-2-methyl-1-phenylpropanone, 2-benzyl-2-(dimethylamino)-1-(4-morpholinophenyl)-1-butanone, 2,2-dimethoxy-2-phenylacetophenone, 9,10-anthraquinone, 2-methylanthraquinone, 2-ethylanthraquinone, 2-tert-butylanthraquinone, octamethylanthraquinone, 1,4-naphthoquinone, 9,10-phenanthrenequinone, benz (a) anthracene-7,12-dione, 2,3-naphthacene-5,12-dione, 2-methyl-1,4-naphthoquinone, 1,4-dimethyl-anthraquinone, 2,3-dimethylanthraquinone, 2-phenylanthraquinone, 2,3-diphenylanthraquinone, retenequinone, 7,8,9,10-tetrahydro-naphthracene-5,12-dione, and 1,2,3,4-tetra-hydrobenz(a)anthracene-7,12-dione, benzophenone and derivatives thereof.

The amount of curing agent in the UV curable aerosol jet ink composition generally is between 0.5% to 10% based on the weight of the composition, and can be between 1% to 5% based on the weight of the composition. The amount of curing agent in the UV curable aerosol jet ink composition can be 0.5%, 0.55%, 0.6%, 0.65%, 0.7%, 0.75%, 0.8%, 0.85%, 0.9%, 0.95%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.1%, 5.2%, 5.3%, 5.4%, 5.5%, 5.6%, 5.7%, 5.8%, 5.9% or 6.0%, 6.1%, 6.2%, 6.3%, 6.4%, 6.5%, 6.6%, 6.7%, 6.8%, 6.9% or 7.0%, 7.1%, 7.2%, 7.3%, 7.4%, 7.5%, 7.6%, 7.7%, 7.8%, 7.9% or 8.0%, 8.1%, 8.2%, 8.3%, 8.4%, 8.5%, 8.6%, 8.7%, 8.8%, 8.9% or 9.0%, 9.1%, 9.2%, 9.3%, 9.4%, 9.5%, 9.6%, 9.7%, 9.8%, 9.9% or 10.0% based on the weight of the ink composition.

Additives

Optionally, additives can be incorporated into the inks to enhance performance. The use of additives is well known in the art of ink formulation and there are many different types. A partial, non-limiting list of additives that can be used in the present formulations includes:
Rheology, viscosity modifiers. Some preferred materials include, e.g., 1-methyl-2-pyrrolidone (BYK®410), and UV curable transparent oligomer, such as highly reactive amine modified polyetheracrylate oligomers, e.g., Sartomer CN551.
Adhesion promoters. Some preferred materials include silane coupling agents, titanates, organometallic coupling agent, and bismuth nitrate). The adhesion promoter is preferably soluble in the ink solvent. Adhesion promoters can also be applied to the substrate prior to printing by the same printing method or by an alternative method such as spin coating or dip coating. Depending on the substrate and sintering temperature, adhesion promoter may or may not be needed.
Wetting agents and surfactants for surface tension modification or pigment dispersion. Some preferred materials include alkylammonium salts of high molecular weight copolymers (BYK®9076), high molecular weight copolymer with pigment affinic groups (BYK®9077), phosphoric acid polyester (BYK®111), high molecular weight block copolymer with pigment affinic groups (BYK®168), BYK®2009, mixture of 2-butoxyethanol, 1-methoxy-2-propanol and 1-methoxy-2-propanol (BYK®2001), polyether modified polydimethylsiloxane (BYK®377), polyether modified acryl functional polydimethylsiloxane (BYK®UV3500), octamethylcyclotetrasiloxane (BYK®307), polyether modified polydimethylsiloxane (BYK®333), polyether modified acryl functional polydimethylsiloxane (BYK®UV3510) and ionic polyacrylate (BYK®381).
Leveling agents. Some preferred materials include polyacrylate in solvent naphtha (BYK®354), acrylic copolymer (BYK®381), octamethylcyclotetrasiloxane (BYK® 307), polyether modified polydimethylsiloxane (BYK®333 and BYK®345), and polyacrylate (BYK®361N).
Scratch resistance agents. Some preferred materials include silicones and waxes, such as polyether modified polydimethylsiloxane (BYK®UV3510, BYK®377, BYK®302 and BYK®333), polyether modified acryl functional polydimethylsiloxane (BYK®UV3500), and BYK®351; and wax, such as micronized wax: micronized modified HD polyethylene wax (CERAFLOUR® 950), micronized Fischer Tropsch wax (CERAFLOUR®940), oxidized HD polyethylene wax (AQUAMAT® 263) and micronized organic polymer (CERAFLOUR® 920).
Defoaming agents. Some preferred materials include silicones, such as polysiloxane (BYK®067 A), heavy petroleum naphtha alkylate (BYK®088), and blend of polysiloxanes, 2-butoxyethanol, 2-ethyl-1-hexanol and Stoddard solvent (BYK®020); and silicone-free defoaming agents, such as hydrodesulfurized heavy petroleum naphtha, butyl glycolate and 2-butoxyethanol and combinations thereof (BYK®052, BYK®A510, BYK®1790, BYK®354 and BYK®1752).
Biocides—Bacteria, yeast and fungus can attack the ink components during the ink storage. By the addition of biocide, it can increase the shelf life of the ink. The biocide can be selected from among algicide, bactericide, fungicide and a combination thereof. Examples of suitable biocides include consisting of silver and zinc, and salts and oxides thereof, sodium azide, 2-methyl-4-isothiazolin-3-one, 5-chloro-2-methyl-4-isothiazolin-3-one, thimerosal, iodopropynyl butylcarbamate, methyl paraben, ethyl paraben, propyl paraben, butyl paraben, isobutylparaben, benzoic acid, benzoate salts, sorbate salts, phenoxyethanol, triclosan, dioxanes, such as 6-acetoxy-2,2-dimethyl-1,3-dioxane (available as Giv Gard® DXN from Givaudam Corp., Vernier, Switzerland), benzyl alcohol, 7-ethyl-bicyclo-oxazolidine, benzalkonium chloride, boric acid, chloroacetamide, chlorhexidine and combinations thereof.
Binders or resins (preferably lower molecular weight oligomer to reduce atomization capacity). Exemplary lower molecular weight resins include ethylcellulose, acrylic polymer and polyester.
Crystallization Inhibitors. The crystallization inhibitors prevent crystallization and the associated increase in surface roughness and promote film uniformity during curing at elevated temperatures and/or over extended periods of time. They can also be helpful to increase conductivity. Examples of crystallization inhibitors include polyvinylpyrrolidone (PVP), lactic acid, ethyl cellulose, styrene allyl alcohol and diethylene glycol monobutyl ether.
Stabilizers for shelf-life stability.

It is preferred that additives be used in amounts less than 5% to minimize their effect on conductivity, however they could be used at higher amounts, such as between 5% to 15% based on the weight of the ink composition, in some instances. The amount of additives, when present, generally is between 0.05% to 5% based on the weight of the ink composition. The amount of additives, when present, can be 0.05%, 0.06%, 0.07%, 0.08%, 0.09%, 0.1%, 0.15%, 0.2%, 0.25%, 0.3%, 0.35%, 0.4%, 0.45%, 0.5%, 0.55%, 0.6%, 0.65%, 0.7%, 0.75%, 0.8%, 0.85%, 0.9%, 0.95%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9% or 5.0% based on the weight of the ink composition.

Colorants

The aerosol jet UV curable dielectric ink compositions provided herein optionally can contain colorants. Suitable colorants include, but are not limited to, dyes, organic pigments and inorganic pigments. The dyes include but are not limited to azo dyes, anthraquinone dyes, xanthene dyes, azine dyes, combinations thereof and the like. Organic pigments can be one pigment or a combination of pigments, such as for instance Pigment Yellow Numbers 12, 13, 14, 17, 74, 83, 114, 126, 127, 174, 188; Pigment Red Numbers 2, 22, 23, 48:1, 48:2, 52, 52:1, 53, 57:1, 112, 122, 166, 170, 184, 202, 266, 269; Pigment Orange Numbers 5, 16, 34, 36; Pigment Blue Numbers 15, 15:3, 15:4; Pigment Violet Numbers 3, 23, 27; and/or Pigment Green Number 7. Inorganic pigments can include one of the following non-limiting pigments: iron oxides, titanium dioxides, chromium oxides, ferric ammonium ferrocyanides, ferric oxide blacks, Pigment Black Number 7 and/or Pigment White Numbers 6 and 7. Other organic and inorganic pigments and dyes also can be employed, as well as combinations of dyes and pigments that achieve the colors desired.

In addition to or in place of visible colorants, the ink may contain UV fluorophores which are excited in the UV range and emit light at a higher wavelength (typically 400 nm and above). Examples of UV fluorophores include but are not limited to materials from the coumarin, benzoxazole, rhodamine, napthalimide, perylene, benzanthrones, benzoxanthones or benzothiaxanthones families. The addition of a UV fluorophore (such as an optical brightener for instance) could help maintain maximum visible light transmission while providing a way to inspect the printed layers for pinholes or other defects or as an indirect method to measure layer thickness. The amount of colorant, when present, generally is between 0.05% to 5% or between 0.1% and 1% based on the weight of the ink composition.

### Exemplary Aerosol Jet UV Curable Dielectric Ink Composition

An exemplary aerosol jet UV curable dielectric ink composition includes a mixture of amine modified polyether acrylate oligomers (e.g., Sartomer CN551, CN550, CN501); monofunctional monomer tetrahydrofurfuryl acrylate (e.g., Sartomer SR285); and non-yellowing photoinitiator curing agents, such as 1-hydroxy-cyclohexyl-phenyl-ketone (e.g., IGM Omnirad 481 or Ciba Irgacure 184). The aerosol jet UV curable dielectric ink composition also can contain stabilizers for shelf-life stability (e.g., Florstab UV-2 from Kromachem, Inc., Farmingdale, N.J. USA). When present, a stabilizer can be present in an amount of from at or about 0.05% to at or about 2.5% based on the weight of the ink composition.

Viscosity

The viscosity of aerosol jet UV curable dielectric ink compositions provided herein are preferably tailored to aerosol jet printing. A preferred viscosity range is 1-1,000 cP, and more preferably 30-500 cP as tested using parallel plate geometry in a TA AR2000ex rheometer at a 25° C. at a shear rate of 10 sec⁻¹. One particular end-use application for the dielectric inks is touch screen display devices. In such devices, optical clarity of the ink is very important. The particular use of this ink is to create a “jumper” where two patterned ITO pads must be electronically connected, however there is a conducting path that lies between them that must not be shorted. This is illustrated in FIG. 2. The dielectric ink should print without defects across the glass/ITO interface and must have good adhesion to both the underlying substrate and the over-printed conducting metal ink, e.g., silver ink, while maintaining optical clarity upon thermal curing of the metal ink, e.g., silver ink.

In order to ensure even printing across the glass/ITO interface, surface treatment may be used. Examples of two such treatments are: (1) sonication of the substrate in an appropriate solvent (e.g., isopropyl alcohol or IPA) for 5 minutes; and (2) the use of nitrogen plasma for 5 minutes. Actual treatment times may vary depending on the starting substrate. Without treatment procedures, the contact angle of the ink on the ITO and glass may be sufficiently different to cause severe spreading (>10%) in the glass regions while straight lines are observed in the ITO region.

The aerosol jet UV curable dielectric ink compositions provided herein generally are formulated so that at least about 95% of the components in the ink have vapor pressure less than 1 mmHg (1 Torr) at atmospheric pressure. In exemplary aerosol jet UV curable dielectric ink compositions, at least about 95% of the components in the ink have vapor pressure less than 0.5 mmHg, or 0.25 mmHg, or 0.1 mmHg.

Aspect Ratio (Height to Width)

Typical thickness for aerosol jet deposition in one pass of the inventive aerosol jet UV curable dielectric printing inks provided herein, generally had a thickness that was between at or about 0.1 microns and at or about 5 microns. For example, one pass deposition of the inventive metal conductive printing inks can result in a print height of 0.10 μm, 0.2 μm, 0.3 μm, 0.4 μm, 0.5 μm, 0.6 μm, 0.7 μm 0.8 μm, 0.9 μm, 1 μm, 1.10 μm, 1.2 μm, 1.3 μm, 1.4 μm, 1.5 μm, 1.6 μm, 1.7 μm, 1.8 μm, 1.9 μm, 2 μm, 2.10 μm, 2.2 μm, 2.3 μm, 2.4 μm, 2.5 μm, 2.6 μm, 2.7 μm, 2.8 μm, 2.9 μm, 3 μm, 3.10 μm, 3.2 μm, 3.3 μm, 3.4 μm, 3.5 μm, 3.6 μm, 3.7 μm, 3.8 μm, 3.9 μm, 4 μm, 4.10 μm, 4.2 μm, 4.3 μm, 4.4 μm, 4.5 μm, 4.6 μm, 4.7 μM, 4.8 μM, 4.9 μm and 5 μm. Multiple consecutive passes can achieve total thicknesses of 10 microns. 20 microns and more.

The printed lines formed by the inventive aerosol jet UV curable dielectric printing inks provided herein provide an aspect ratio (height to width) of from about 0.1:20 and 5:10, and preferably greater than or equal to 0.02, in one pass printed with a 150 micron tip, particularly for lines having a width not greater than 25 microns, preferably 20 microns or less and more preferably for lines less than 15 microns.

### EXAMPLES

The following examples illustrate specific aspects of the present invention and are not intended to limit the scope thereof in any respect and should not be so construed.

### Example 1

A. Preparation of conductive metal ink formulations containing dispersants

Eight metal conductive ink formulations were prepared according to the formulas shown below in Table 1. The ink formulations were prepared by combining one or more dispersants (polycarboxylate ether dispersant Ethyacryl G (Coatex, Chester, S.C.), SunFlo P92-25193 (JD-5, Sun Chemical, Parsippany, N.J.) and/or polymeric dispersant SOLSPERSE™ 35000 (Lubrizol, Wickliffe, Ohio)) with solvent (either diethylene glycol monobutyl ether (DEGBE; Sigma-Aldrich, St. Louis, Mo.) or Texanol™ ester alcohol (2,2,4-trimethyl-1,3-pentanediolmono(2-methylpropanoate); Sigma-Aldrich)), Ames Goldsmith S20-30 silver particles (diameter=30 nm, D50 particle distribution=38 nm, D90 particle distribution=168 nm; South Glens Falls, N.Y.), and Trixene BI 7963 adhesion promoter (Baxenden Chemical, Lancashire, England) in a vessel and mixing in a 3000W ultrasonic machine (Hielscher, Teltow, Germany) for 30 minutes. The ink formulations then were filtered using a 0.5 μm nylon membrane filter to give the finished ink formulation.

TABLE 1
Conductive metal ink formulations containing dispersants

| Formulation | | | | | | | |
|---|---|---|---|---|---|---|---|
| 1 | 2 | 3 | 4 | 5 | 6 | 7 | 8 |

Dispersant

| | | | | | | | | |
|---|---|---|---|---|---|---|---|---|
| Ethacryl G | 5.0 | 5.0 | 5.0 | — | — | 5.0 | 2.5 | — |
| SunFlo | — | — | — | 5.0 | — | — | — | — |
| P92-25193 | | | | | | | | |
| Solsperse | — | — | — | — | 5.0 | — | 2.5 | 5.0 |
| TM35000 | | | | | | | | |

Solvent

| | | | | | | | | |
|---|---|---|---|---|---|---|---|---|
| DEGBE | 29.5 | 24.5 | 64.5 | 24.5 | 24.5 | — | 24.5 | — |
| Texanol | — | — | — | — | — | 24.5 | — | 24.5 |

Silver particle

| | | | | | | | | |
|---|---|---|---|---|---|---|---|---|
| Ames | 65.0 | 70.0 | 30.0 | 70.0 | 70.0 | 70.0 | 70.0 | 70.0 |
| Goldsmith | | | | | | | | |
| S20-30 | | | | | | | | |

Adhesion promoter

| | | | | | | | | |
|---|---|---|---|---|---|---|---|---|
| Trixene | 0.5 | 0.5 | 0.5 | 0.5 | 0.5 | 0.5 | 0.5 | 0.5 |
| BI7963 | | | | | | | | |
| Total | 100.0 | 100.0 | 100.0 | 100.0 | 100.0 | 100.0 | 100.0 | 100.0 |

B. Properties of Conductive Metal Ink Formulations Containing Dispersants

Formulation 1 was assessed for viscosity, storage stability, extended print run stability, substrate compatibility, printed line dimension, adhesion to substrates, printed line conductivity, printing capability, print quality, and printed line.

1. Viscosity

Viscosity was measured by an AR2000 cone and plate rheometer (TA Instruments, New Castle, Del.) at room temperature immediately after mixing and again one week after mixing. Formulation 1 had a viscosity of 46 cP at 10 s⁻¹ shear rate immediately after mixing and again one week after mixing.

2. Ink Storage Stability

Ink storage stability of Formulation 1 was determined at room temperature and at an elevated temperature (50° C.) by measuring the amount of sediment generated over time using gravimetric analysis. The initial solids content of Formulation 1 was 65%.

To determine the storage stability at room temperature, Formulation 1 was stored in a sealed glass bottle at room temperature for 14 weeks. The solids content did not change over the first four weeks and remained at 65%. After 4 weeks the solids content decreased by 1% (1% precipitation was observed) then remained constant for the next 10 weeks (through 14 weeks total). A total sediment generation of 1% over a 14 week period is a minimal change and did not affect the particle size distribution of the formulation. The sediment in suspension was eliminated and the metal particles were completely re-dispersed by ultrasonic mixing to provide the same particle size distribution as measured before settling.

The stability at accelerated (elevated) temperature was determined by storing Formulation 1 at 50° C. in a sealed glass bottle for one week. After one week the solids content was measured. The solids content did not change and remained at 65%.

Viscosity and metal particle size distribution were also measured to further assess the ink storage stability at an elevated temperature. Formulation 1 retained the viscosity of 46 cP at 10 s⁻¹ shear rate one week after storage at 50° C.

Metal particle size distribution was measured by a light scattering measurement. The mean particle size also can be measured using a Zetasizer Nano ZS device (Malvern Instruments LTD., Malvern, Worcestershire, United Kingdom) utilizing the Dynamic Light Scattering (DLS) method. The DLS method essentially consists of observing the scattering of laser light from particles, determining the diffusion speed and deriving the size from this scattering of laser light, using the Stokes-Einstein relationship. Particularly of interest as metrics are D50 (50% particle size distribution) and D90 (90% particle size distribution). The D50 and D90 values represent the median, or the 50th percentile and the 90th percentile of the particle size distribution, respectively, as measured by volume. That is, the D50 is a value on the distribution such that 50% of the particles have a particle size of this value or less and the D90 is a value on the distribution such that 90% of the particles have a particle size of this value or less.

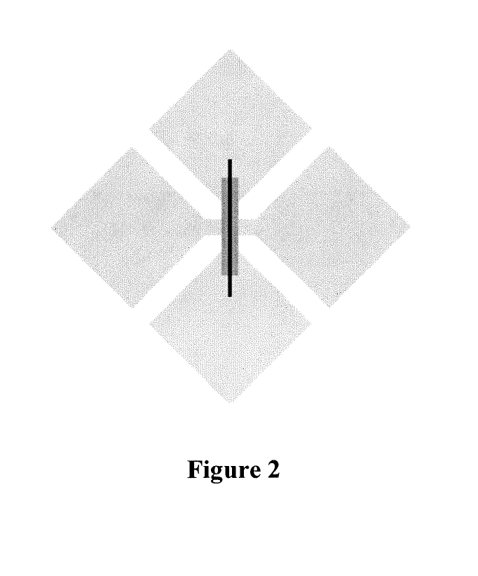

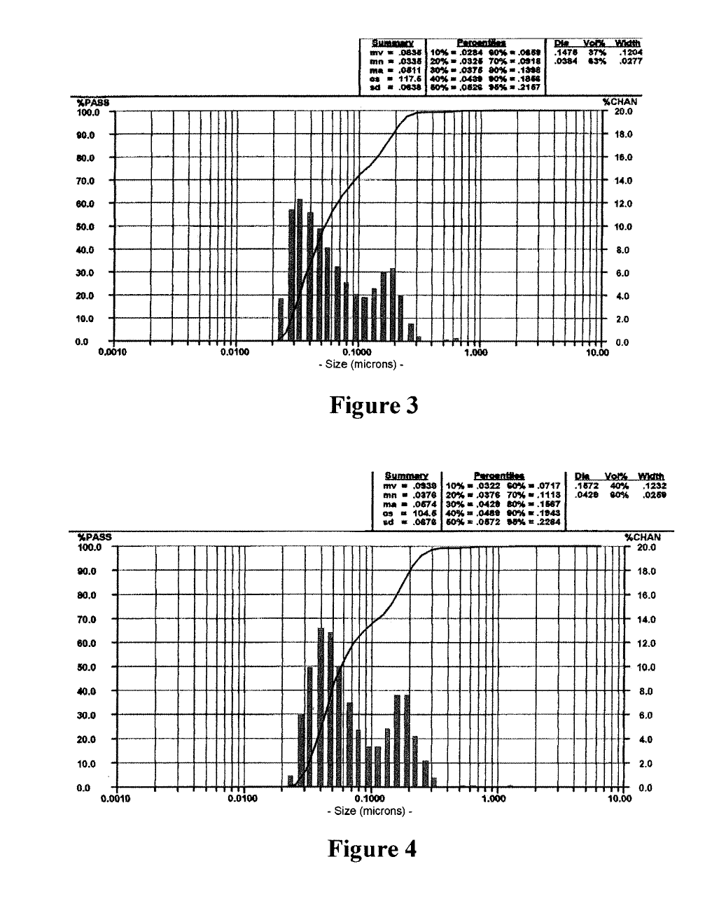

The D50 and D90 values of Formulation 1 before and after storage at 50° C. for one week exhibited minimal change, as shown in Table 2 below. FIGS. 3 and 4 illustrate the results of the metal particle size distribution measurements taken before storage and after one week of storage at 50° C. Minimal changes of D50 and D90 are seen after aging for one week, which demonstrates good stability of the inventive inks.

TABLE 2
Particle size distribution of Formulation 1

| | D50 | D90 |
|---|---|---|
| Before storage | 52 nm | 186 nm |
| After storage at 50° C. for one week | 57 nm | 194 nm |

Long-term ink storage stability of Formulation 1 was determined by assessing printed line dimension and conductivity after storing Formulation 1 at room temperature in a sealed glass bottle for 12 months. The formulation was sonicated for 30 minutes before printing to check line dimension and conductivity. There was no significant conductivity or print dimension change after 12 months of storage at room temperature. Formulation 1 had good storage stability and chemical shelf life at room temperature and elevated temperature as indicated by the lack of substantial sediment generation and unchanging viscosity and particle size distribution. Formulation 1 also had good long term storage stability as indicated by the conductivity and print width after 12 months.

3. Extended Print Run Ink Stability

The stability of Formulation 1 during an extended print trial was determined by measuring the solids content, metal particle size distribution and viscosity before and after a continuous 10 hour print run on an aerosol jet printer. An Optomec M³D single nozzle printer (Albuquerque, N. Mex.) equipped with a pneumatic atomization system was used for the printing trial. The Optomec aerosol jet printer operated with three gas flow rate settings: sheath gas (to focus the aerosol), exhaust (excess gas volume taken off of the atomizer), and atomizer (gas used to “atomize” the fluid into aerosol droplets).

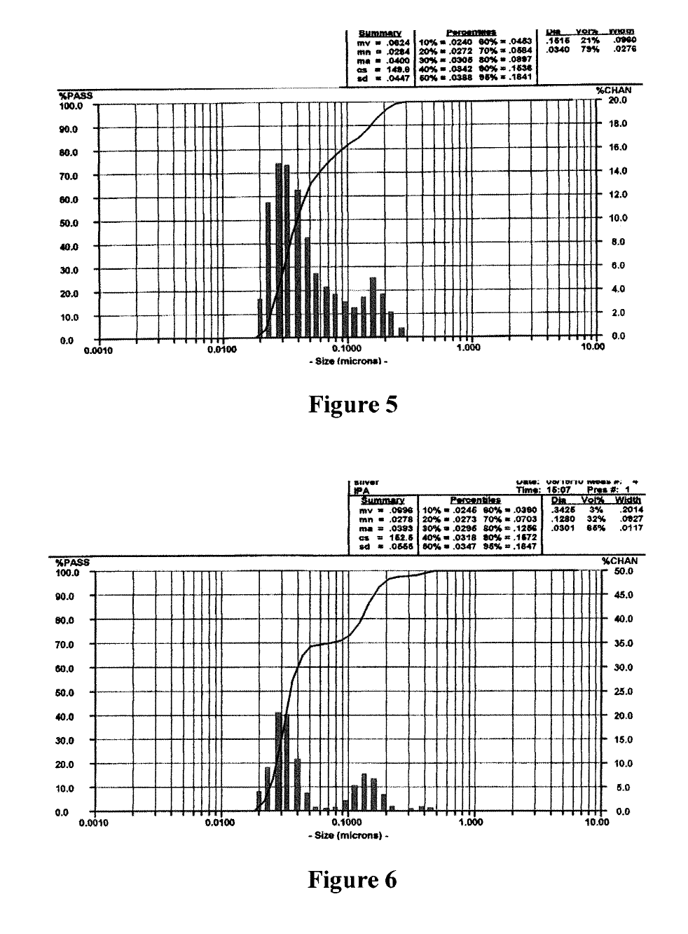

FIGS. 5 and 6 illustrate the results of the metal particle size distribution measurements taken before printing and after printing for 10 hours. There was minimal change in the metal particle size distribution after printing for 10 hours. There was also minimal change in solids content and viscosity after 10 hours of continuous printing, as shown in Table 3 below. These results show that Formulation 1 exhibits good ink stability during an extended print run.

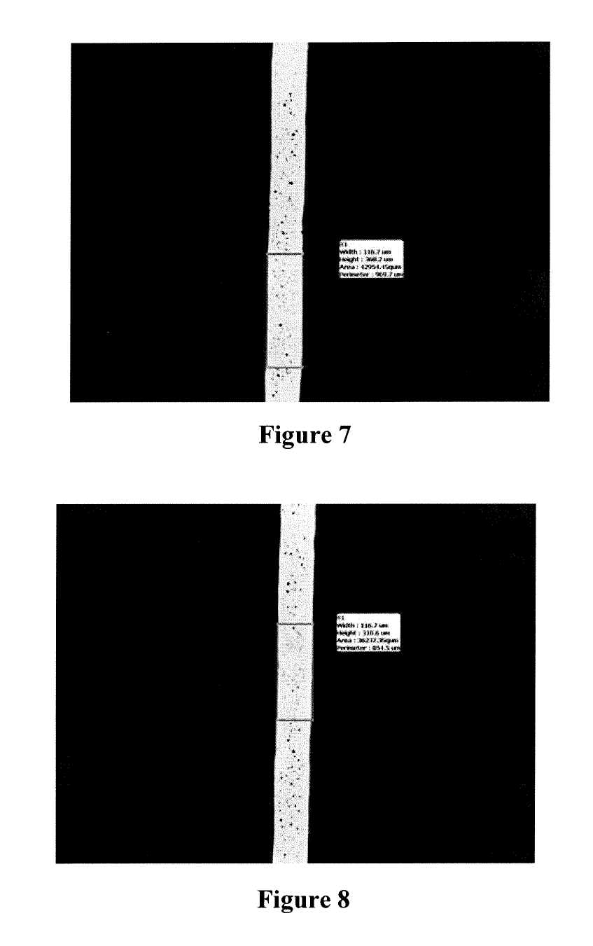

Printed line dimension of Formulation 1 was also measured after 10 minutes and 10 hours of continuous printing. Formulation 1 was printed on UV curable dielectric polymer-coated glass using an Optomec M³D aerosol jet printer equipped with a 150 μm tip at 22° C. The printing parameters were set at a sheath flow rate of 60 sccm, exhaust flow rate of 750 sccm, atomizer flow rate of 760 sccm, and print speed of 80 mm/s (actual parameters: sheath flow rate=58 sccm, exhaust flow rate=748 sccm, atomizer flow rate=760 sccm, print speed=80 mm/s). FIGS. 7 and 8 show that there was minimal change in printed line dimension after continuous printing for 10 minutes (117 μM wide line) as compared to 10 hours (118 μm wide line), respectively.

TABLE 3
Extended print run properties of Formulation 1

| | Start of printing | t = 10 hours |
|---|---|---|
| Solids content | 65% | 65% |
| Viscosity | 46 cP · s | 46 cP · s |
| D50 | 38 nm | 35 nm |
| D90 | 163 nm | 167 nm |
| Printed line width | 117 μm | 118 μm |

4. Substrate Compatibility

Using an Optomec M³D aerosol jet printer, Formulation 1 was printed on glass coupon (slide), indium tin oxide (ITO) coupon, various polymer substrates, UV curable acrylic polymer-coated glass coupon, silicon wafer, silicon nitride (SiN)-coated wafer, bismaleimide triazine (BT) resin rigid printed circuit board (PCB), flame resistant 4 (FR-4) rigid PCB, Kapton® (polyimide film) flex circuits, and polyethylene terephthalate (PET) flex circuits. Formulation 1 was shown to be compatible with each substrate on which it was printed.

5. Printed Line Dimensions

Formulation 1 was printed on glass coupon, ITO coupon and UV curable acrylic polymer-coated glass coupon using various printing parameters. After printing, the printed lines were sintered in a 150-200° C. oven for 30 minutes. The dimensions of the printed lines were measured by a high power microscope. The printed line dimensions were between 10 to 200 μm depending on the printing parameters, as shown in Table 4.

TABLE 4
Printed line widths of Formulation 1 on various substrates

| | | UV-curable acrylic polymer- | |
|---|---|---|---|
| | Glass coupon | coated glass coupon | ITO coupon |
| Width | 10.6 μm | 10.6 μm | 13.6 μm |

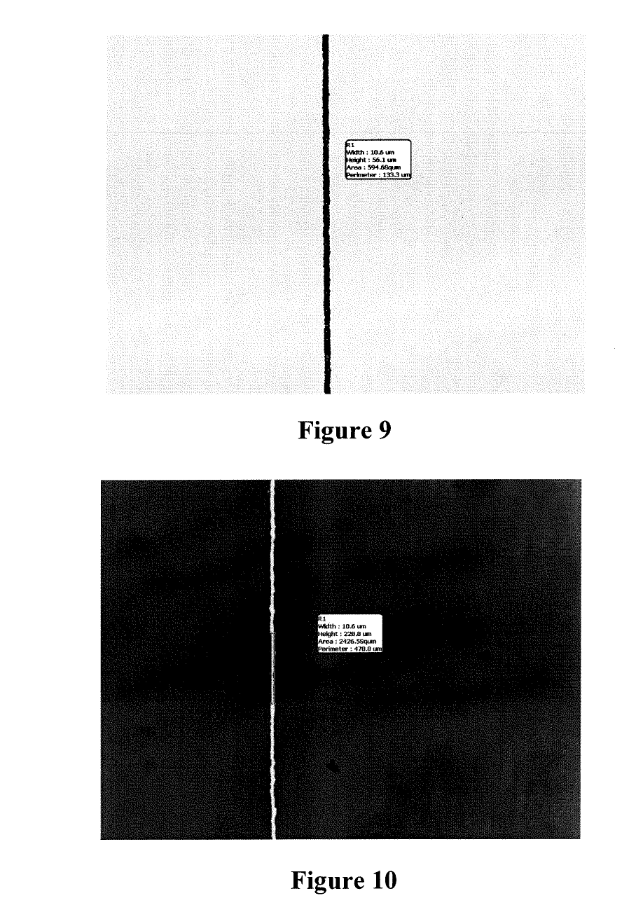

FIG. 9 illustrates the results of printing Formulation 1 on glass coupon using an Optomec M³D aerosol jet printer equipped with a 10 μm wide, 100 μm tip at 25° C. The printing parameters were set at a sheath flow rate of 10 sccm, exhaust flow rate of 500 sccm, atomizer flow rate of 530 sccm, and print speed of 40 mm/s (actual parameters: sheath flow rate=9 sccm, exhaust flow rate=506 sccm, atomizer flow rate=526 sccm, print speed=40 mm/s), resulting in a printed line that was 10.6 μm wide.

FIG. 10 illustrates the results of printing Formulation 1 on UV-curable acrylic polymer-coated glass coupon using an Optomec M³D aerosol jet printer equipped with a 10 μm wide, 100 μm tip at 25° C. The printing parameters were set at a sheath flow rate of 10 sccm, exhaust flow rate of 500 sccm, atomizer flow rate of 533 sccm, and print speed of 40 mm/s (actual parameters: sheath flow rate=9 sccm, exhaust flow rate=506 sccm, atomizer flow rate=529 sccm, print speed=40 mm/s), resulting in a printed line that was 10.6 μm wide.

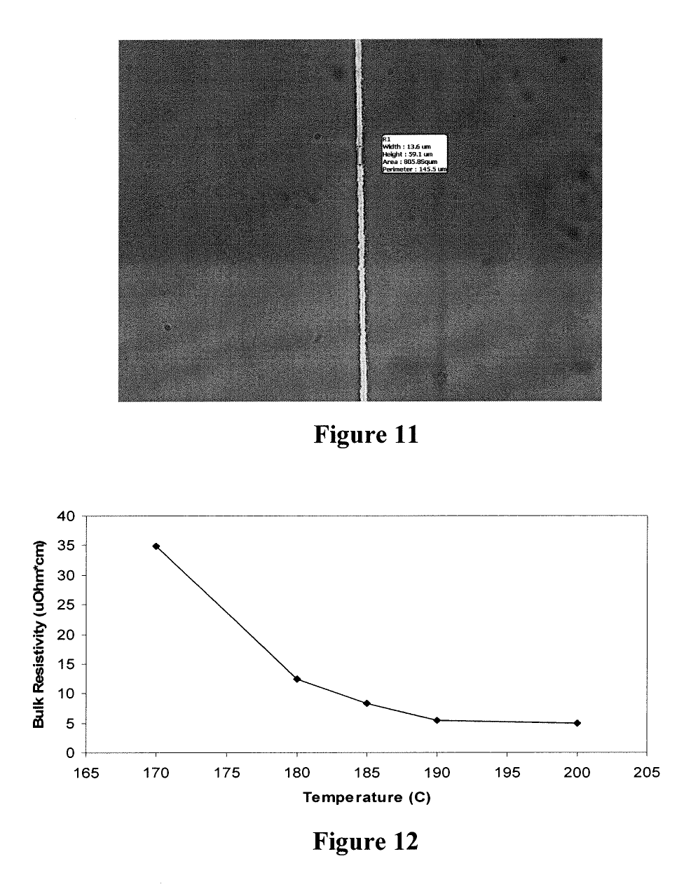

FIG. 11 shows the results of printing Formulation 1 on ITO coupon using an Optomec M³D aerosol jet printer equipped with a 14 μm wide, 100 μm tip at 25° C. The printing parameters were set at a sheath flow rate of 10 sccm, exhaust flow rate of 500 sccm, atomizer flow rate of 535 sccm, and print speed of 40 mm/s (actual parameters: sheath flow rate=9 sccm, exhaust flow rate=506 sccm, atomizer flow rate=535 sccm, print speed=40 mm/s), resulting in a printed line that was 13.6 μm wide.

FIGS. 9, 10 and 11 demonstrate that Formulation 1 can produce good quality printed lines on various substrates using various printing parameters.

6. Adhesion

Adhesion of Formulation 1 to various substrates was tested at various temperatures and compared to variations of Formulation 1 in which one formulation did not contain Trixene BI 7963 adhesion promoter (Formulation 9) and another formulation contained twice the amount of Trixene BI 7963 adhesion promoter as Formulation 1 (Formulation 10). Formulations 1 (0.5% adhesion promoter), 9 (no adhesion promoter) and 10 (1% adhesion promoter) were printed on glass coupon, ITO coupon, UV-curable acrylic polymer-coated glass coupon, and a glass/ITO combined coupon using an Optomec M³D single nozzle aerosol jet printer with a pneumatic atomization system. After printing, the lines were sintered in a 150-200° C. oven for 30 minutes.

Adhesion was measured using the adhesion tape test method. A strip of Scotch® Cellophane Film Tape 610 (3M, St. Paul, Minn.) was placed along the length of each print and pressed down by thumb twice to ensure a close bond between the tape and the print. While holding the print down with one hand, the tape was pulled off the print at approximately a 180° angle to the print. Adhesion performance was measured by estimating the percent of ink removed from each print by the tape and rating the performance by estimating the amount of ink removed from the print. Adhesion test results were classified as either “Excellent” (no ink removed), “Good” (minimal or slight amount of ink removed), or “Poor” (significant amount of ink removed).

The formulations that contained Trixene BI 7963 adhesion promoter (Formulations 1 and 10) exhibited excellent adhesion to all of the substrates tested at all of the temperatures tested, while the formulation that did not contain any adhesion promoter (Formulation 9) only exhibited good adhesion. The formulations that contained adhesion promoter demonstrated better adhesion to the substrates tested, though the formulation that did not contain any adhesion promoter was still able to adhere to the substrates. The results are shown in Table 5.

TABLE 5
Adhesion of formulations with and without adhesion promoter
on various substrates at various temperatures

| | Formulation 1 | Formulation 9 | Formulation 10 |
|---|---|---|---|
| | (0.5% adhesion | (no adhesion | (1% adhesion |
| | promoter) | promoter) | promoter) |
| Glass | Excellent (150-180° C.) | Good (150-170° C.) | Excellent (150-185° C.) |
| ITO | Excellent (150-200° C.) | Good (150-170° C.) | Excellent (150-200° C.) |
| UV-curable | Excellent (150-200° C.) | Good (150-170° C.) | Excellent (150-200° C.) |
| dielectric polymer | | | |
| Glass/ITO | Excellent (150-195° C.) | Good (150-170° C.) | Excellent (150-195° C.) |

7. Printed Line Conductivity

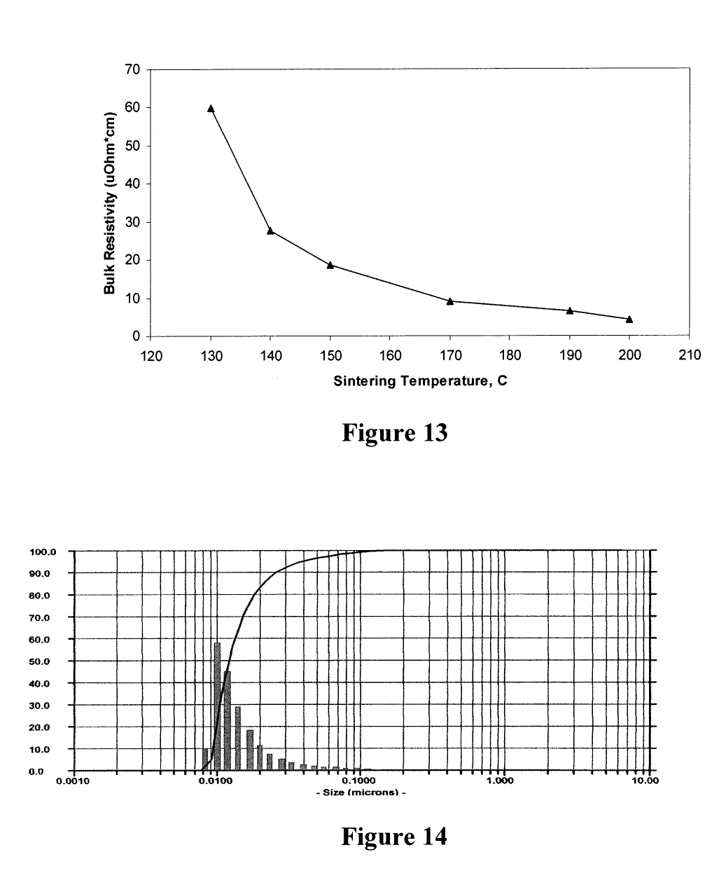

Formulations 1 and 10 ink were printed on glass substrates using an Optomec M³D single nozzle aerosol jet printer with a pneumatic atomization system. The printed lines were sintered at 150-200° C. for 30 minutes. The resistivity of the lines was measured using the two-point probe measurement. For Formulation 1 ink, resistivity decreased with increasing temperature (from about 5 μΩcm at 200° C. to 35 μΩcm at 170° C.) as shown in FIG. 12. For Formulation 10 ink, resistivity decreased with increasing temperature (from about 5 μΩcm at 200° C. to about 60 μΩcm at 130° C.) as shown in FIG. 13.

These results show that the conductivity of Formulation 1 printed lines compared very favorably to the conductivity of best in class commercial silver inkjet ink products, such as SunTronic Nanosilver Ink from Sun Chemical Corporation (Parsippany, N.J. USA), as well as conductive nanosilver inkjet ink products available from InkTec Corporation (Gyeonggi-do, Korea) and Nanomas Technologies, Inc. (Endicott, N.Y. USA).

C. Comparison to Ink Formulations Containing High Vapor Pressure Solvents

A series of conductive metal ink formulations were prepared that contained high vapor pressure solvents commonly used in inkjet inks. Eight ink formulations were prepared in which the DEGBE solvent (low vapor pressure) of Formulation 1 was replaced by either ethanol, isopropyl alcohol (IPA), water, butyl acetate, butyl ether, dimethylacetamide (DMA), toluene or n-methylpyrrolidone (NMP), as shown below in Table 6. A silver ink formulation containing 30-40% ethanol, a high vapor pressure solvent, also was prepared as described in Example 3 of U.S. Pat. Pub. 2006/0189113.

TABLE 6
Conductive metal inks containing high vapor pressure solvents

| Formulation | | | | | | | |
|---|---|---|---|---|---|---|---|
| 11 | 12 | 13 | 14 | 15 | 16 | 17 | 18 |

Dispersant

| | | | | | | | | |
|---|---|---|---|---|---|---|---|---|
| Ethacryl G | 5.0 | 5.0 | 5.0 | 5.0 | 5.0 | 5.0 | 5.0 | 5.0 |

Solvent

| | | | | | | | | |
|---|---|---|---|---|---|---|---|---|
| Ethanol | 29.5 | — | — | — | — | — | — | — |
| Isopropyl | — | 29.5 | — | — | — | — | — | — |
| alcohol | | | | | | | | |
| Water | — | — | 29.5 | — | — | — | — | — |
| Butyl acetate | — | — | — | 29.5 | — | — | — | — |
| Butyl ether | — | — | — | — | 29.5 | — | — | — |
| Dimethyl- | — | — | — | — | — | 29.5 | — | — |
| acetamide | | | | | | | | |
| Toluene | — | — | — | — | — | — | 29.5 | — |
| n-Methyl- | — | — | — | — | — | — | — | 29.5 |
| pyrrolidone | | | | | | | | |

Silver particle

| | | | | | | | | |
|---|---|---|---|---|---|---|---|---|
| Ames | 65.0 | 65.0 | 65.0 | 65.0 | 65.0 | 65.0 | 65.0 | 65.0 |
| Goldsmith | | | | | | | | |
| S20-30 | | | | | | | | |

Adhesion promoter

| | | | | | | | | |
|---|---|---|---|---|---|---|---|---|
| Trixene | 0.5 | 0.5 | 0.5 | 0.5 | 0.5 | 0.5 | 0.5 | 0.5 |
| B17963 | | | | | | | | |
| Total | 100.0 | 100.0 | 100.0 | 100.0 | 100.0 | 100.0 | 100.0 | 100.0 |

Each formulation was tested by printing with an Optomec M³D single nozzle printer (Albuquerque, N. Mex.) for 3 hours. Two commercially available silver conductive inkjet inks containing high vapor pressure solvents were also tested (SunTronic Jettable Silver U5714 and U5603, Sun Chemical). The solvent loss rate of each ink formulation was much more significant than the solvent loss rate of Formulation 1 over the same period of printing time, ranging from 10-80% during the 3 hour print trial. The high solvent loss rates resulted in increased ink viscosity, increased ink solids content, and decreased printing rate due to printability problems. These results demonstrate that inkjet inks or other inks that contain large amounts of high vapor pressure solvents are not well suited for aerosol jet printing, especially when used for extended print runs.

### Example 2

A. Preparation of Conductive Metal Ink Formulations not Containing Dispersants

Three metal conductive ink formulations were prepared according to the formulas shown below in Table 7. The ink formulations were prepared by combining pre-coated Cabot CSN 10 silver particles (diameter=10 nm, D50 particle distribution=12 nm, D90 particle distribution=22 nm; PVP-capped, produced according to the methods described in U.S. Pat. Nos. 7,824,466; 7,749,299; and 7,575,621 and related families; Cabot Corporation, Boston, Mass.) with solvents ethylene glycol, glycerol and diethylene glycol monobutyl ether (DEGBE; Sigma-Aldrich, St. Louis, Mo.), surfactant (DuPont™ Zonyl® FSO-100 fluorosurfactant (Dupont Chemical Solutions, Wilmington, Del. USA) and Trixene BI 7963 adhesion promoter (Baxenden Chemical, Lancashire, England) in a vessel and mixing in a 3000W ultrasonic machine (Hielscher, Teltow, Germany) for 30 minutes. The ink formulations were then filtered using a 0.5 μm nylon membrane filter to give the finished ink formulation.

TABLE 7
Conductive metal ink formulations

| | Formulation | | |
|---|---|---|---|
| | 19 | 20 | 21 |
| Cabot CSN 10 silver particle | 46.00 | 20.00 | 40.00 |
| Ethylene glycol | 32.85 | 49.05 | 36.60 |
| Glycerol | 10.30 | 15.40 | 11.50 |
| DEGBE | 9.80 | 14.50 | 10.85 |
| Surfactant (Zonyl FSO-100, Dupont) | 0.05 | 0.05 | 0.05 |
| Trixene BI 7963 adhesion promoter | 1.00 | 1.00 | 1.00 |
| Total | 100.00 | 100.00 | 100.00 |

B. Properties of Conductive Metal Ink Formulations Containing Dispersants

Formulation 19 was assessed for viscosity, storage stability, extended print run stability, substrate compatibility, printed line dimension, adhesion to substrates, printed line conductivity, printing capability, print quality, and printed line.

1. Viscosity

Viscosity was measured by an AR2000 cone and plate rheometer (TA Instruments, New Castle, Del.) at room temperature immediately after mixing and again one week after mixing. Formulation 19 had a viscosity of 35 cP at 10 s⁻¹ shear rate immediately after mixing and again one week after mixing.

2. Ink Storage Stability

Ink storage stability of Formulation 19 was determined at room temperature and at an elevated temperature (50° C.) by measuring the amount of sediment generated over time using gravimetric analysis. The initial solids content of Formulation 19 was 46%.

To determine the storage stability at room temperature, Formulation 19 was stored in a sealed glass bottle at room temperature for 6 weeks. The solids content did not change over the entire 6 weeks and remained at 46%. The sediment in suspension was eliminated and the metal particles were completely re-dispersed by ultrasonic mixing to provide the same particle size distribution as measured before settling.

The stability at accelerated (elevated) temperature was determined by storing Formulation 19 at 50° C. in a sealed glass bottle for one week. After one week the solids content was measured. The solids content did not change and remained at 46%.

Viscosity and metal particle size distribution were also measured to further assess the ink storage stability at an elevated temperature. Formulation 19 retained the viscosity of 35 cP at 10 s⁻¹ shear rate one week after storage at 50° C.

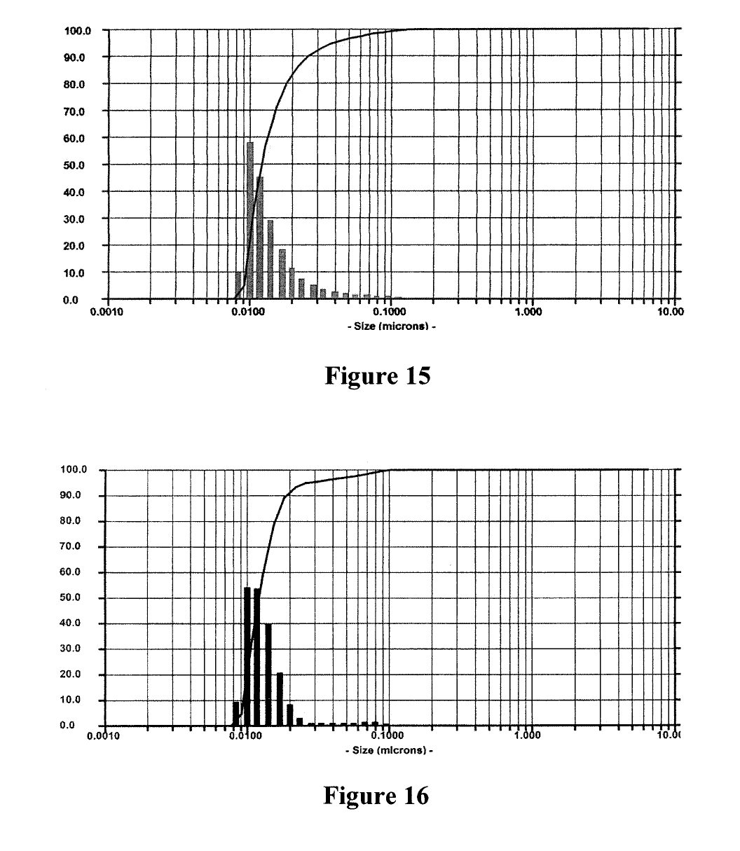

Metal particle size distribution at D50, D90 and D100 was measured by the light scattering measurement described in Example 1 above. The D50, D90 and D100 values of Formulation 19 before and after storage at 50° C. for one week exhibited minimal change, as shown in Table 8 below. FIGS. 14 and 15 illustrate the results of the metal particle size distribution measurements taken before storage and after one week of storage at 50° C. There was minimal change in the particle size distribution after storage for one week at 50° C.

TABLE 8
Particle size distribution of Formulation 19

| | D50 | D90 | D100 |
|---|---|---|---|
| Before storage | 14 nm | 25 nm | 38 nm |
| After storage at 50° C. | 12 nm | 22 nm | 36 nm |
| for one week | | | |

Long-term ink storage stability of Formulation 19 was determined by assessing printed line dimension and conductivity after storing Formulation 19 at room temperature in a sealed glass bottle for 12 months. The formulation was sonicated for 30 minutes before printing to check line dimension and conductivity. There was no significant conductivity or print dimension change after 12 months of storage at room temperature.

Formulation 19 had good storage stability and chemical shelf life at room temperature and elevated temperature as indicated by the lack of substantial sediment generation and unchanging viscosity and particle size distribution. Formulation 19 also had good long term storage stability as shown by the conductivity and print dimension after 12 months.

3. Extended Print Run Ink Stability

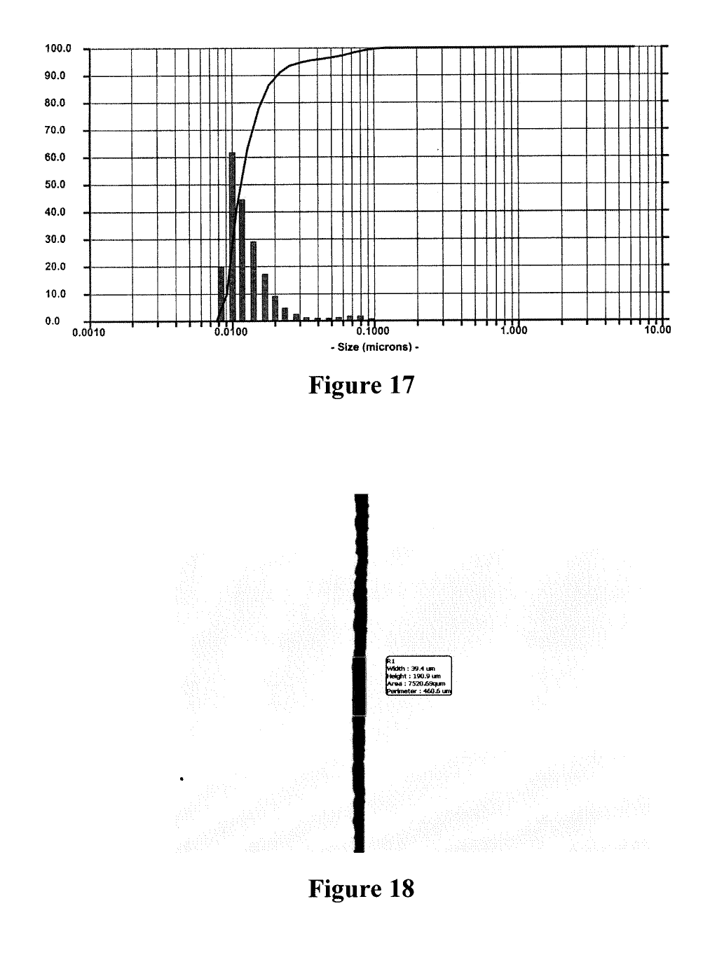

The stability of Formulation 19 during an extended print trial was determined by measuring the solids content, metal particle size distribution and viscosity before and after a continuous 10 hour print run on an aerosol jet printer. An Optomec M³D single nozzle printer (Albuquerque, N. Mex.) equipped with a pneumatic atomization system was used for the printing trial. FIGS. 16 and 17 illustrate the results of the metal particle size distribution measurements taken before printing and after printing for 10 hours. There was minimal change in the metal particle size distribution after printing for 10 hours. There was also minimal change in solids content and viscosity after 10 hours of continuous printing, as shown in Table 9 below. These results show that Formulation 19 exhibits good ink stability during an extended print run.

TABLE 9
Extended print run properties of Formulation 19

| | |
|---|---|
| Start of printing | t = 10 hours |

| | | |
|---|---|---|
| Solids content | 46% | 46% |

| | | | | |
|---|---|---|---|---|
| Viscosity | 35 | cP | 35 | cP |
| D50 | 15 | nm | 13 | nm |
| D90 | 25 | nm | 27 | nm |
| D100 | 38 | nm | 39 | nm |
| Printed line width | 39.4 | μm | 39.4 | μm |

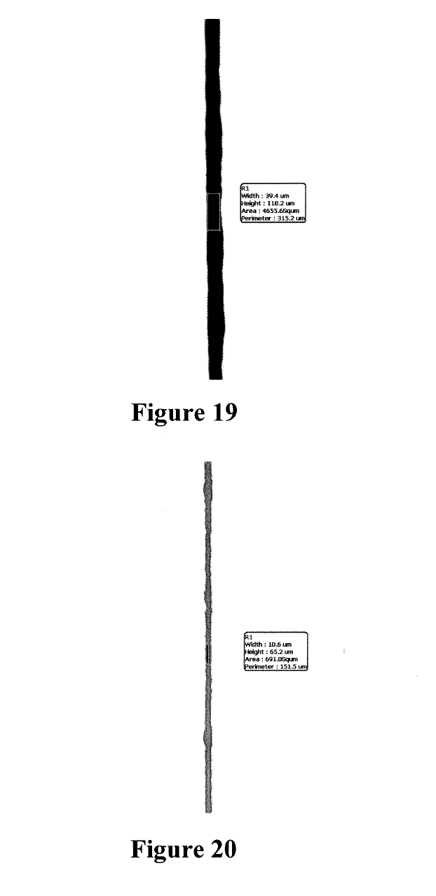

Printed line dimension of Formulation 19 was also measured after 10 minutes and 10 hours of continuous printing. Formulation 19 was printed on UV-curable acrylic polymer-coated glass using an Optomec M³D aerosol jet printer equipped with a 150 μm tip at 22° C. The printing parameters were set at a sheath flow rate of 35 sccm, exhaust flow rate of 650 sccm, atomizer flow rate of 670 sccm, and print speed of 20 mm/s (actual parameters: sheath flow rate=34 sccm, exhaust flow rate=656 sccm, atomizer flow rate=670 sccm, print speed=20 mm/s). FIGS. 18 and 19 show that there was no change in printed line dimension after continuous printing for 10 minutes (39.4 μm wide line) as compared to 10 hours (39.4 μm wide line), respectively.

4. Substrate Compatibility

Using an Optomec M³D aerosol jet printer, Formulation 19 was printed on glass coupon (slide), indium tin oxide (ITO) coupon, various polymer substrates, UV curable acrylic polymer-coated glass coupon, silicon wafer, silicon nitride (SiN)-coated wafer, bismaleimide triazine (BT) resin rigid printed circuit board (PCB), flame resistant 4 (FR-4) rigid PCB, Kapton® (polyimide film) flex circuits, and polyethylene terephthalate (PET) flex circuits. Formulation 19 was shown to be compatible with each substrate that it was printed on.

5. Printed Line Dimensions

Formulation 19 was printed on glass coupon, UV-curable polymer coupon, ITO coupon and UV-curable dielectric polymer using various printing parameters. After printing, the printed lines were sintered in a 150-200° C. oven for 30 minutes. The dimensions of the printed lines were measured by a high power microscope. The printed line dimensions were between 10 to 200 μm depending on the printing parameters, as shown below in Table 10.

TABLE 10
Printed line widths of Formulation 19 on various substrates

| | | UV-curable acrylic | |
|---|---|---|---|
| | Glass coupon | polymer coupon | ITO coupon |
| Width | 10.6 μm | 10.6 μm | 39.4 μm |

FIG. 20 illustrates the results of printing Formulation 19 on glass coupon using an Optomec M³D aerosol jet printer equipped with a 10 μm wide, 100 μm tip at 25° C. The printing parameters were set at a sheath flow rate of 35 sccm, exhaust flow rate of 650 sccm, atomizer flow rate of 670 sccm, and print speed of 35 mm/s (actual parameters: sheath flow rate=34 sccm, exhaust flow rate=656 sccm, atomizer flow rate=670 sccm, print speed=35 mm/s), resulting in a printed line that was 10.6 μm wide.

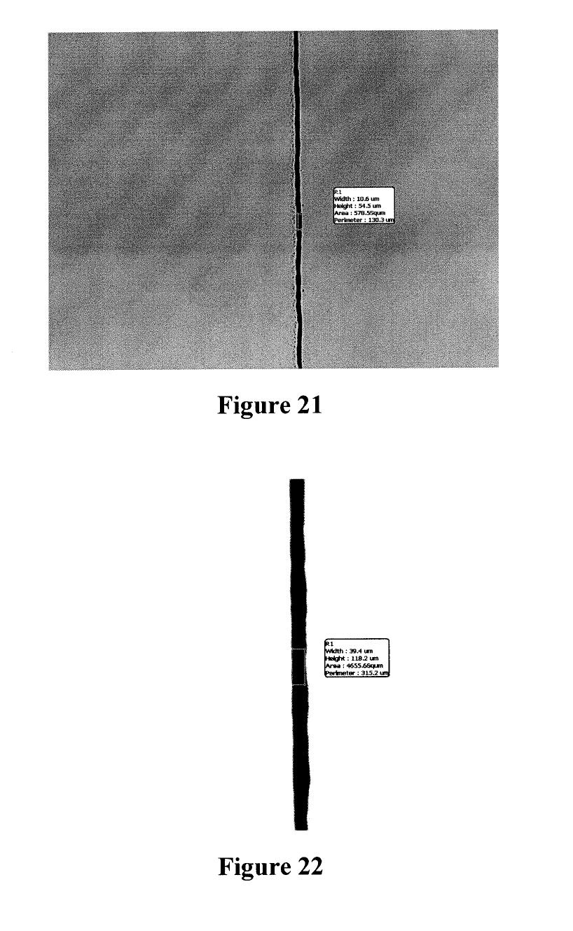

FIG. 21 shows the results of printing Formulation 19 on UV-curable polymer coupon using an Optomec M³D aerosol jet printer equipped with a 10 μm wide, 100 μm tip at 25° C. The printing parameters were set at a sheath flow rate of 35 sccm, exhaust flow rate of 650 sccm, atomizer flow rate of 670 sccm, and print speed of 35 mm/s (actual parameters: sheath flow rate=34 sccm, exhaust flow rate=656 sccm, atomizer flow rate=670 sccm, print speed=35 mm/s), resulting in a printed line that was 10.6 μm wide.

FIG. 22 illustrates the results of printing Formulation 19 on ITO coupon using an Optomec M³D aerosol jet printer equipped with a 40 μm wide, 150 μm tip at 25° C. The printing parameters were set at a sheath flow rate of 35 sccm, exhaust flow rate of 650 sccm, atomizer flow rate of 670 sccm, and print speed of 20 mm/s (actual parameters: sheath flow rate=34 sccm, exhaust flow rate=656 sccm, atomizer flow rate=670 sccm, print speed=20 mm/s), resulting in a printed line that was 39.4 μm wide.

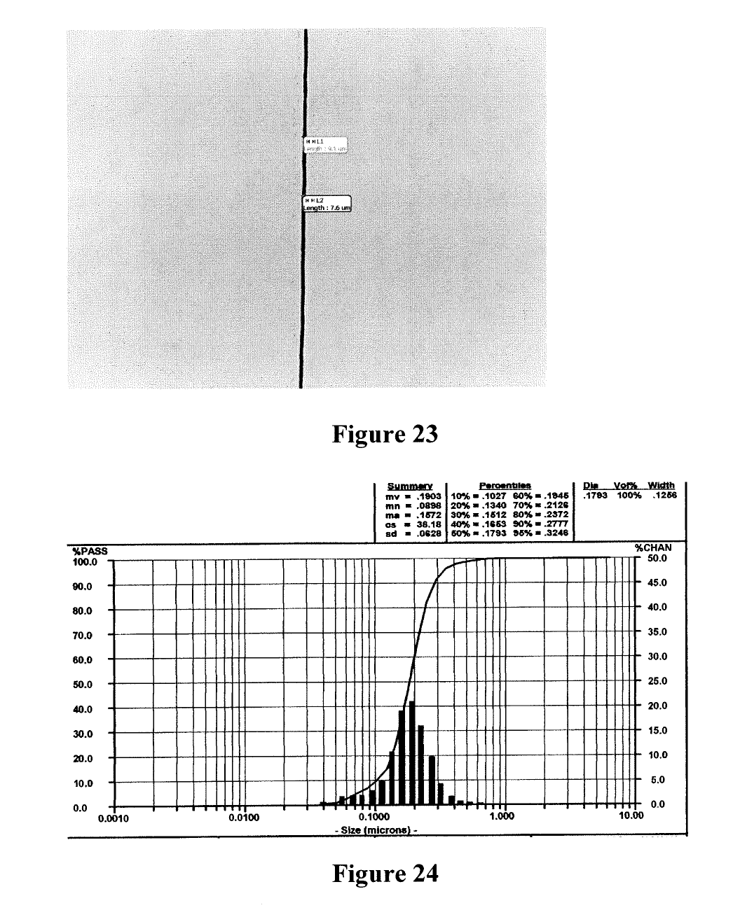

FIG. 23 shows the results of printing Formulation 19 on UV-curable dielectric polymer using an Optomec M³D aerosol jet printer equipped with a 10 μm wide, 100 μm tip at 25° C. The printing parameters were set at a sheath flow rate of 35 sccm, exhaust flow rate of 650 sccm, atomizer flow rate of 670 sccm, and print speed of 35 mm/s (actual parameters: sheath flow rate=34 sccm, exhaust flow rate=656 sccm, atomizer flow rate=670 seem, print speed=35 mm/s), resulting in a printed line that was 9.1 microns at its thickest width and 7.6 microns at its thinnest width, confirming that the aerosol jet ink compositions provided herein are capable of printing lines under 10 microns in width.

FIGS. 20, 21, 22 and 23 show that Formulation 19 can produce good quality printed lines on various substrates using various printing parameters.

6. Adhesion

Adhesion of Formulation 19 to various substrates was tested at various temperatures and compared to variations of Formulation 19 in which one formulation did not contain Trixene BI 7963 adhesion promoter (Formulation 22) and another formulation contained an additional amount of Trixene BI 7963 adhesion promoter as compared to Formulation 19 (Formulation 23). Formulations 19 (1% adhesion promoter), 22 (no adhesion promoter) and 23 (1.5% adhesion promoter) were printed on glass coupon, ITO coupon, UV-curable acrylic polymer-coated glass coupon, and a glass/ITO combined coupon using an Optomec M³D single nozzle aerosol jet printer with a pneumatic atomization system. After printing, the lines were sintered in a 150-200° C. oven for 30 minutes.

Adhesion was measured using the adhesion tape test method as described in Example 1 above. Adhesion test results were classified as either “Excellent” (no ink removed), “Good” (minimal or slight amount of ink removed), or “Poor” (significant amount of ink removed).

The formulations that contained Trixene BI 7963 adhesion promoter (Formulations 19 and 23) exhibited excellent adhesion to all of the substrates tested at all of the temperatures tested, while the formulation that did not contain any adhesion promoter (Formulation 22) only exhibited good adhesion. The formulations that contained adhesion promoter demonstrated better adhesion to the substrates tested, though the formulation that did not contain any adhesion promoter was still able to adhere to the substrates. The results are shown in Table 11.

TABLE 11
Adhesion of formulations with and without adhesion promoter
on various substrates at various temperatures

| | Formulation 19 | Formulation 22 | Formulation 23 |
|---|---|---|---|
| | (1% adhesion | (no adhesion | (1.5% adhesion |
| | promoter) | promoter) | promoter) |
| Glass | Excellent (150-180° C.) | Good (150-170° C.) | Excellent (150-185° C.) |
| ITO | Excellent (150-200° C.) | Good (150-170° C.) | Excellent (150-200° C.) |
| UV-curable | Excellent (150-200° C.) | Good (150-170° C.) | Excellent (150-200° C.) |
| dielectric polymer | | | |
| Glass/ITO combined | Excellent (150-195° C.) | Good (150-170° C.) | Excellent (150-195° C.) |

7. Printed Line Conductivity

Formulation 19 was printed on glass substrate using an Optomec M³D single nozzle aerosol jet printer with a pneumatic atomization system. The printed lines were sintered at 150-200° C. for 30 minutes. The resistivity of the lines was measured using the two-point probe measurement as described above in Example 1. Resistivity decreased with increasing temperature (from 4.2 to 18 μΩcm at 140-200° C.). These results demonstrate that the conductivity of Formulation 19 printed lines compared very favorably to the conductivity of best in class commercial silver inkjet ink products, such as SunTronic Nanosilver Ink from Sun Chemical Corporation (Parsippany, N.J. USA), as well as conductive nanosilver inkjet ink products available from InkTec Corporation (Gyeonggi-do, Korea) and Nanomas Technologies, Inc. (Endicott, N.Y. USA).

### Example 3

A. Preparation of Conductive Glass-Coated Metal Ink Formulations

Eight conductive ink formulations containing glass-coated metal were prepared according to the formulas shown below in Table 12.

TABLE 12
Conductive glass-coated metal ink formulations

| Formulation | | | | | | | |
|---|---|---|---|---|---|---|---|
| 24 | 25 | 26 | 27 | 28 | 29 | 30 | 31 |

Dispersant

| | | | | | | | | |
|---|---|---|---|---|---|---|---|---|
| SunFlo ® | 5 | 5 | 5 | 5 | — | — | — | — |
| P92-25193 (JD-5) | | | | | | | | |
| SunFlo ® | — | — | — | — | 5 | 5 | 5 | 5 |
| SSDR255 (JI-5) | | | | | | | | |

Solvent

| | | | | | | | | |
|---|---|---|---|---|---|---|---|---|
| DEGBE | 25 | — | 25 | — | 25 | — | 25 | — |
| Texanol | — | 25 | — | 25 | — | 25 | — | 25 |

Glass-coated silver

| | | | | | | | | |
|---|---|---|---|---|---|---|---|---|
| Cabot CSN17 | 70 | 70 | — | — | 70 | 70 | — | — |
| Cabot CSN27 | — | — | 70 | 70 | — | — | 70 | 70 |
| Total | 100 | 100 | 100 | 100 | 100 | 100 | 100 | 100 |

The ink formulations were prepared by combining dispersant (either SunFlo® P92-25193 or SunFlo® SSDR255; Sun Chemical, Parsippany, N.J.), solvent (either diethylene glycol monobutyl ether (DEGBE; Sigma-Aldrich, St. Louis, Mo.) or Texanol™ ester alcohol (2,2,4-trimethyl-1,3-pentanediolmono(2-methylpropanoate); Sigma-Aldrich)), and glass-coated silver particles (either CSN17 or CSN27 silver particles (Cabot, Boston, Mass.) in a vessel and mixing in a 3000W ultrasonic machine (Hielscher, Teltow, Germany) for 30 minutes. The ink formulations were then filtered using a nylon membrane filter to give the finished ink formulation.

B. Properties of Conductive Glass-Coated Metal Ink Formulations

The ink formulations were assessed for storage stability, extended print run stability, substrate compatibility, printed line dimension, contact resistivity, printing capability, and print quality.

1. Particle Size Distribution

Metal particle size distribution at D50 and D90 of Formulations 25 and 26 was measured by the light scattering measurement explained in Example 1 above. The results are shown in Table 13.

TABLE 13
Particle size distribution of the ink formulations

Formulation

| | 25 | 26 |
|---|---|---|
| D50 | 160 nm | 178 nm |
| D90 | 230 nm | 277 nm |

2. Ink Storage Stability

The storage stability of Formulations 24-27 was determined at room temperature and at an elevated temperature (50° C.) by measuring the amount of sediment generated over time using gravimetric analysis. The initial solids content of Formulations 24-27 was 70%.

To determine the storage stability at room temperature, Formulations 24-27 were stored in a sealed glass bottle at room temperature for 42 days. The solids content did not change over that time and remained at 70%. The sediment in suspension was eliminated and the metal particles were completely re-dispersed by ultrasonic mixing.

The stability at accelerated (elevated) temperature of Formulations 26 and 27 was determined by storing each formulation at 50° C. in a sealed glass bottle for one week. After one week the solids content was measured. The solids content did not change and remained at 70%.

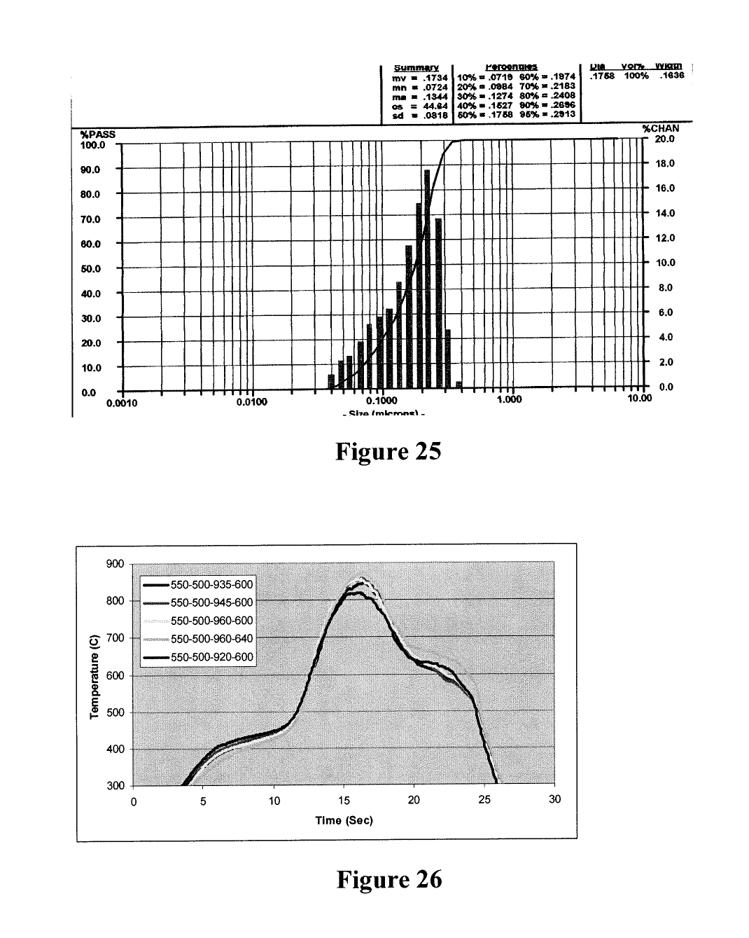

Metal particle size distribution of Formulations 26 and 27 was also measured to further assess the ink storage stability at an elevated temperature. Metal particle size distribution at D50 and D90 was measured by the light scattering measurement explained in Example 1 above. The D50 and D90 values of Formulations 26 and 27 before and after storage at 50° C. for one week exhibited minimal change. FIGS. 24 and 25 illustrate the results of the metal particle size distribution measurements taken before storage and after one week of storage at 50° C. There was minimal change in the particle size distribution after storage for one week at 50° C.

The ink formulations had good storage stability and chemical shelf life at room temperature and elevated temperature as indicated by the lack of substantial sediment generation and unchanging particle size distribution.

3. Solar Cell Wafer Compatibility

Formulations 25 and 27 were printed by an Optomec M³D printer on multicrystalline and single crystalline SiNₓ-coated solar cell wafer. The printed lines were dried and sintered based on the sintering profile shown in FIG. 26. Compatibility of the ink formulations with the solar cell wafer was determined by assessing wet printing rates, dry printing rates, and printed line dimensions.

The wet printing rate of Formulation 25 was measured by balance for collecting printed samples in 30 minute intervals over an 8 hour period. The wet printing rate of Formulation 25 remained at an average rate of 0.019 mg/minute during the 8 hour print run.

The dry printing rates of Formulation 25 was measured by balance for drying collecting printed samples in 30 minute intervals in a 120° C. oven over an 8 hour period. The dry printing rate of Formulation 25 remained at an average rate of 0.015 mg/minute without significant change over 8 hours of printing.

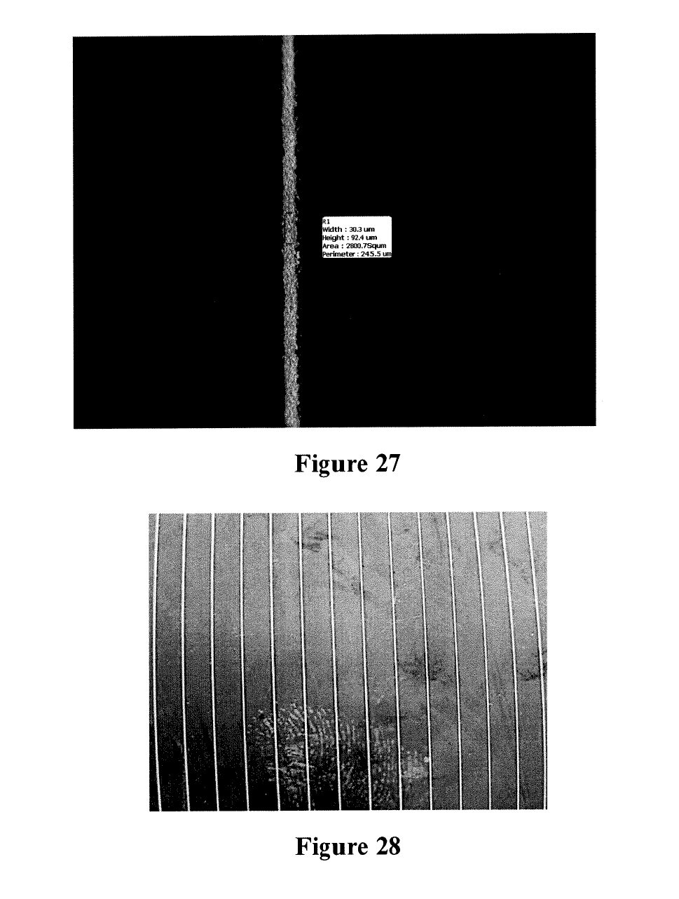

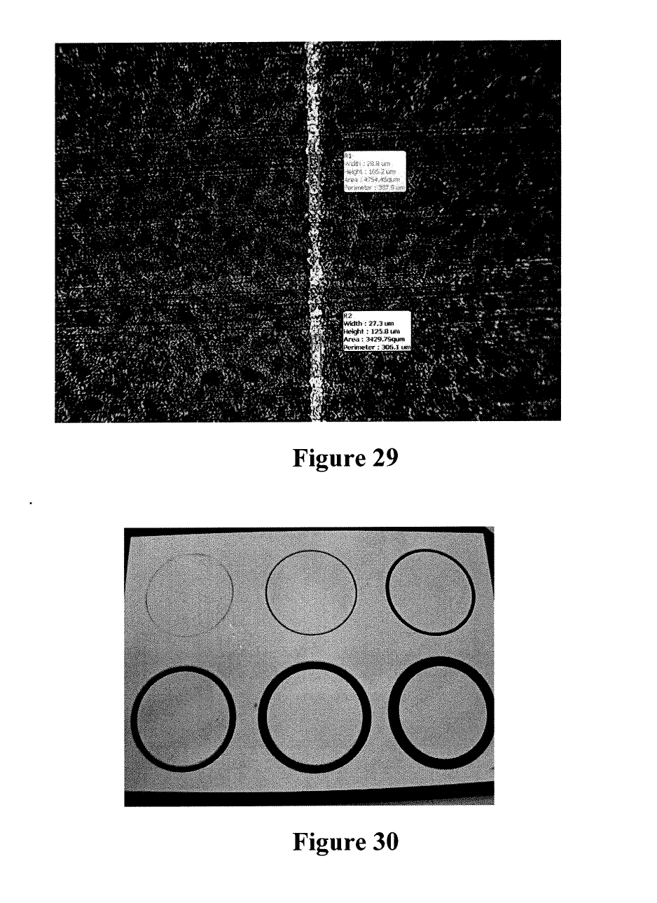

The dimension of the printed lines of Formulations 25 and 27 on multicrystalline SiNₓ-coated wafer were measured by a high powered microscope after sintering. FIGS. 27 and 28 show print examples of Formulation 25 on multicrystalline SiNₓ-coated wafer using a 200 μm tip with printing parameters set at: sheath flow rate=40 sccm, exhaust flow rate=950 sccm, atomizer flow rate=1100 sccm, print speed=105 mm/s. These parameters resulted in printed lines that were 30 μm wide. FIG. 29 shows a print example of Formulation 27 on multicrystalline SiNₓ-coated wafer using a 250 μm tip with printing parameters set at: sheath flow rate=70 sccm, exhaust flow rate=750 sccm, atomizer flow rate=775 sccm, print speed=60 mm/s. These parameters resulted in a printed line that was 29 μm wide.

The results show that Formulations 25 and 27 were compatible with multicrystalline and single crystalline SiNₓ-coated solar cell wafers. Formulations 25 and 27 result in printed lines with good edge definition and print quality and are suitable for use in extended printing periods.

4. Printed Line Conductivity

Formulations 27 and 28 were printed by a screen printer on multicrystalline wafer to form a transition line method (TLM) pattern as shown in FIG. 30. The printed TLM were dried and sintered using the sintering profile shown in FIG. 26. The contact resistivity of the silver paste printed TLM pattern was calculated by standard equations (e.g., see Stavitski et al., IEEE Transactions on Electronic Devices 55(5): 1170-1176 (2008) and Stavitski et al., IEEE International Conference on Microelectronic Test Structures, 1: 13-17 (2006)). Specific contact resistance measurements of metal-semiconductor junctions. 2006 IEEE International Conference on Microelectronic Test Structures, no. 1: 13-17. In measuring resistance with the four-point-probe or van der Pauw methods, 4 contacts (2 for current, 2 for voltage) were used to determine the sheet resistance of a layer while minimizing effects of contact resistance. The average specific contact resistivity was 21 mΩ·cm². This result is very close to the value of commercially available solar cell front side screen printing silver paste.

C. Comparison to Conductive Glass-Coated Metal Ink Formulations Using Different Dispersants

The effect of dispersant on the storage and printing properties of the conductive inks containing glass-coated metal was investigated by substituting the dispersants used in Formulations 24-31 with alternate dispersants. Formulations were prepared by combining dispersant (either BYK 2008, BYK 2009, BYK 2115, Ethacryl G, Ethacryl M, Ethacryl 1000, Ethacryl HF or Ethacryl 1030), solvent (either diethylene glycol monobutyl ether (DEGBE; Sigma-Aldrich, St. Louis, Mo.) or Texanol™ ester alcohol (2,2,4-trimethyl-1,3-pentanediolmono(2-methyl-propanoate); Sigma-Aldrich)), and glass-coated silver particles (either CSN17 or CSN27 silver particles (Cabot, Boston, Mass.)) in a vessel and mixing in a 3000W ultrasonic machine (Hielscher, Teltow, Germany) for 30 minutes. The ink formulations were then filtered using a nylon membrane filter to give the finished ink formulation.

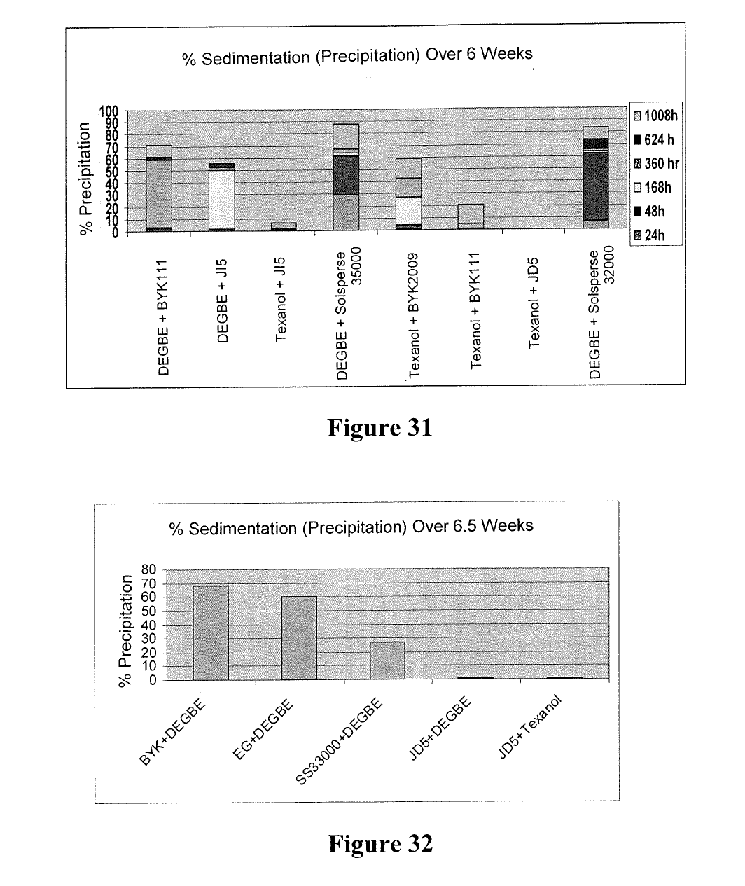

The storage stability of these formulation was determined by storing each formulation in a sealed glass bottle at room temperature and measuring the amount of sediment generated over time using gravimetric analysis. Formulations containing a combination of DEGBE and BKY®111, DEGBE and Solsperse® 35000, DEGBE and Solsperse® 32000 quickly showed significant precipitation, resulting in very viscous formulations that were not suitable for use without the addition of further additives. The amount of sediment generated over the tested time period is illustrated in FIGS. 31 and 32.

### Example 4

A. Preparation of UV-Curable Dielectric Ink Compositions

Three UV-curable dielectric ink formulations were prepared by mixing an acrylic oligomer, amine-modified polyether acrylate oligomer CN551, with either a second acrylic oligomer, amine-modified polyether acrylate oligomer CN501, or an acrylic monomer, tetrahydrofurfuryl acrylate SR285, and a photoinitiator (Omnirad 481) and stabilizer (Florstab UV-2) for one hour at 50° C. to achieve complete dissolution and homogeneity of the formulations. The exact formulations are shown below in Table 14.

TABLE 14
UV-curable dielectric ink formulations

| | Formulation | | |
|---|---|---|---|
| Material | 32 | 33 | 34 |
| Acrylic oligomer - CN551 | 77.37 | 83.87 | 69.76 |
| Acrylic oligomer - CN501 | — | — | 23.26 |
| Acrylic monomer - SR285 | 15.48 | 8.39 | — |
| Photoinitiator - Omnirad 481 | 6.50 | 7.04 | 6.51 |
| Stabilizer - Florstab UV-2 | 0.65 | 0.70 | 0.47 |
| Total | 100.00 | 100.00 | 100.00 |

B. Properties of the UV-Curable Dielectric Ink Formulations

Formulation 1 was assessed for storage stability, extended print run stability, substrate compatibility and print quality, adhesion, and printed line thermal stability for optical clarity.

1. Ink Storage Stability

Ink storage stability of Formulations 32-34 was determined by storing each formulation in a sealed glass bottle at room temperature in the dark for 3 months. The viscosity, UV-curability and printability was assessed during that time period to determine stability.

Viscosity was measured using parallel plate geometry in an AR2000ex rheometer (TA Instruments, New Castle, Del.) at 25° C. at a 10 s⁻¹ shear rate immediately after mixing and again 3 months after mixing. There was minimal viscosity change (<10%) during the 3 month storage period for each of the formulations.

UV-curability was tested before and after storage for 3 months at room temperature using the methylethyl ketone (MEK) double rub test (ASTM D5402). A cotton swab was dipped into MEK and double rubs (back and forth equals one double rub) were performed on the surface of the substrate coated with the ink until the coating began to break. A minimum of 10 rubs is required to be considered to be an acceptable cure. In the MEK rub test, 20 rubs is considered a very good cure, and 30 rubs or more is considered an excellent cure. The inventive UV curable dielectric aerosol jet printing inks tested cured with a UVA (400-315 nm) irradiation at an energy (mJ/cm²) of 200 or greater exhibited very good or excellent cure using the MEK rub test. Increasing the curing energy generally produced more robust coatings. There was no change in UV-curability over the 3 month period.

Printability was assessed in two ways. First from atomizer output which was determined gravimetrically, and second by printed line dimensions which were determined by optical microscopy.

The minimal or no change in viscosity, UV curability and printing characteristics over a 3 month storage period indicated that UV-curable dielectric ink formulations 32-34 have good storage stability and shelf life.

2. Extended Print Run Stability

The stability of Formulations 32-34 during an extended print run was evaluated by analyzing the deposition rate and the printed line dimensions of the formulations before and after a continuous 10 hour print run on an aerosol jet printer. Formulations 32-34 were printed on glass coupon using an Optomec M³D single nozzle printer (Albuquerque, N. Mex.) equipped with a pneumatic atomization system (150 μm tip).

The deposition rate of Formulation 32 was measured over a 10 hour print run by gravimetric method. The printing parameters were set at a sheath flow rate of 70 sccm, exhaust flow rate of 680 sccm and atomizer flow rate of 700 sccm. The wet deposition rate was determined by dividing the ink output weight by the print time. There was no significant deposition rate change (<10%) of Formulation 32, as the rate remained at 0.025 mg/minute throughout the 10 hours of testing.

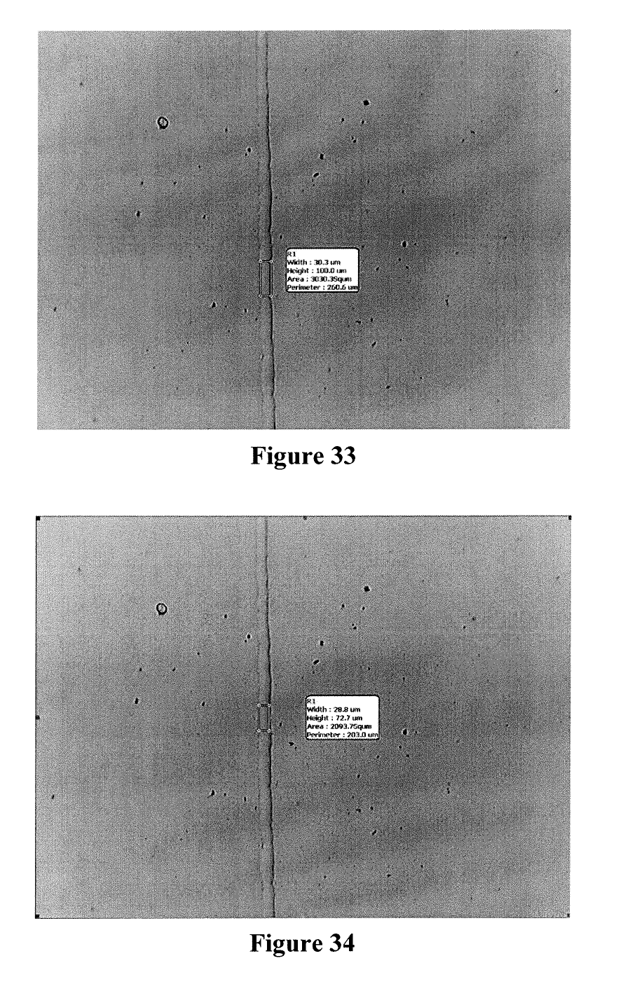

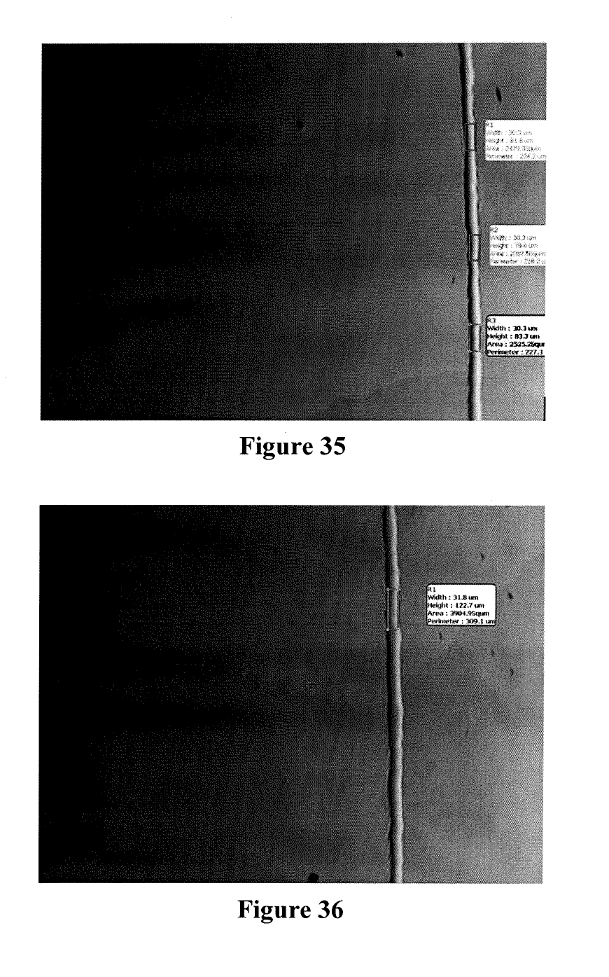

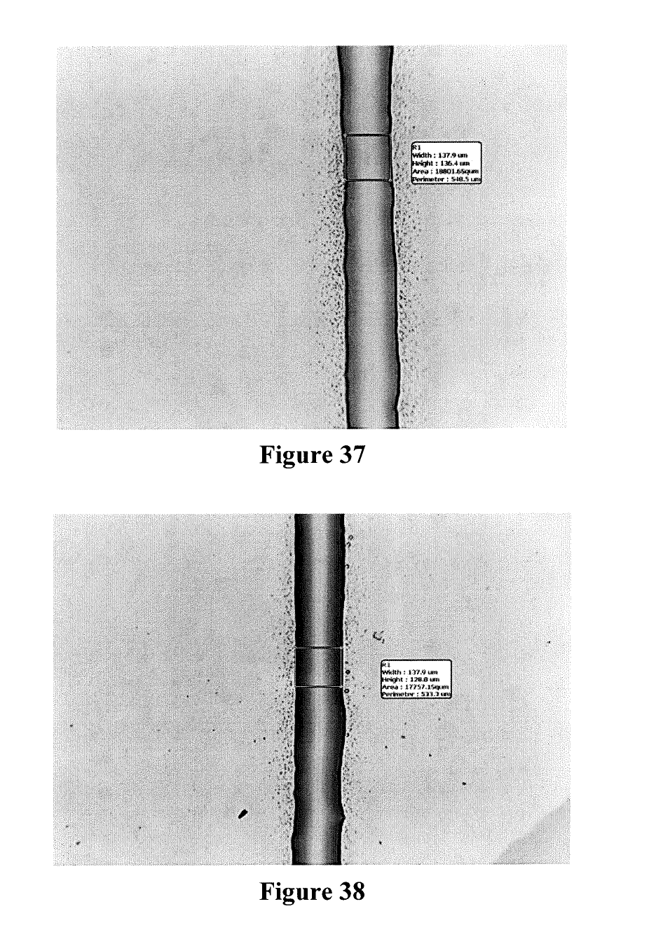

The printed line dimensions on glass coupon were measured after 10 minutes and 10 hours of continuous printing using Formulations 32-34. The printed line dimensions were measured by optical microscopy and show that there was no significant change (<10%) between measurements at 10 minutes and 10 hours for each formulation. Table 15 and FIGS. 33 and 34 (Formulation 32; printing parameters: sheath flow rate=45 sccm, exhaust flow rate=750 sccm, atomizer flow rate=850 sccm, print speed=18 mm/s), FIGS. 35 and 36 (Formulation 33; printing parameters: sheath flow rate=50 sccm, exhaust flow rate=1020 sccm, atomizer flow rate=1085 sccm, print speed=22 mm/s), and FIGS. 37 and 38 (Formulation 34; printing parameters: sheath flow rate=20 sccm, exhaust flow rate=950 sccm, atomizer flow rate=1000 sccm, print speed=4 mm/s), show the results for each formulation after printing for 10 minutes and 10 hours, respectively.

TABLE 15
Printed line widths of Formulations 32-34 after
10 minutes and 10 hours of continuous printing

| | Formulation 32 | | Formulation 33 | | Formulation 34 | |
|---|---|---|---|---|---|---|
| | 10 | 10 | 10 | 10 | 10 | 10 |
| | minutes | hours | minutes | hours | minutes | hours |
| Width | 30.3 μm | 28.8 μm | 30.3 μm | 31.8 μm | 137.9 μm | 137.9 μm |

The results (less than 10% change in line dimensions during 10 hours of continuous printing) demonstrate that Formulations 32-34 had good print stability. The minimal change in line dimension is due to the minimal change in viscosity, atomizer output and compositional integrity (i.e. the materials in the ink were maintained within 10% of their original wt %) of the formulations over the extended print run.

3. Substrate Compatibility and Print Quality

Using an Optomec M³D aerosol jet printer, Formulations 32-34 were printed on glass substrate, indium tin oxide (ITO) substrate, and a combined glass/ITO substrate. The printed lines were UV-cured using a Fusion UV Systems Light Hammer 6 equipped with an H lamp. The UV system was run at 75% power with a total cure time of 10 seconds. The dimensions of the printed lines were measured by optical microscope. Formulations 32-34 were shown to be compatible with each substrate by assessing the adhesion and printed line dimensions after printing on each substrate.

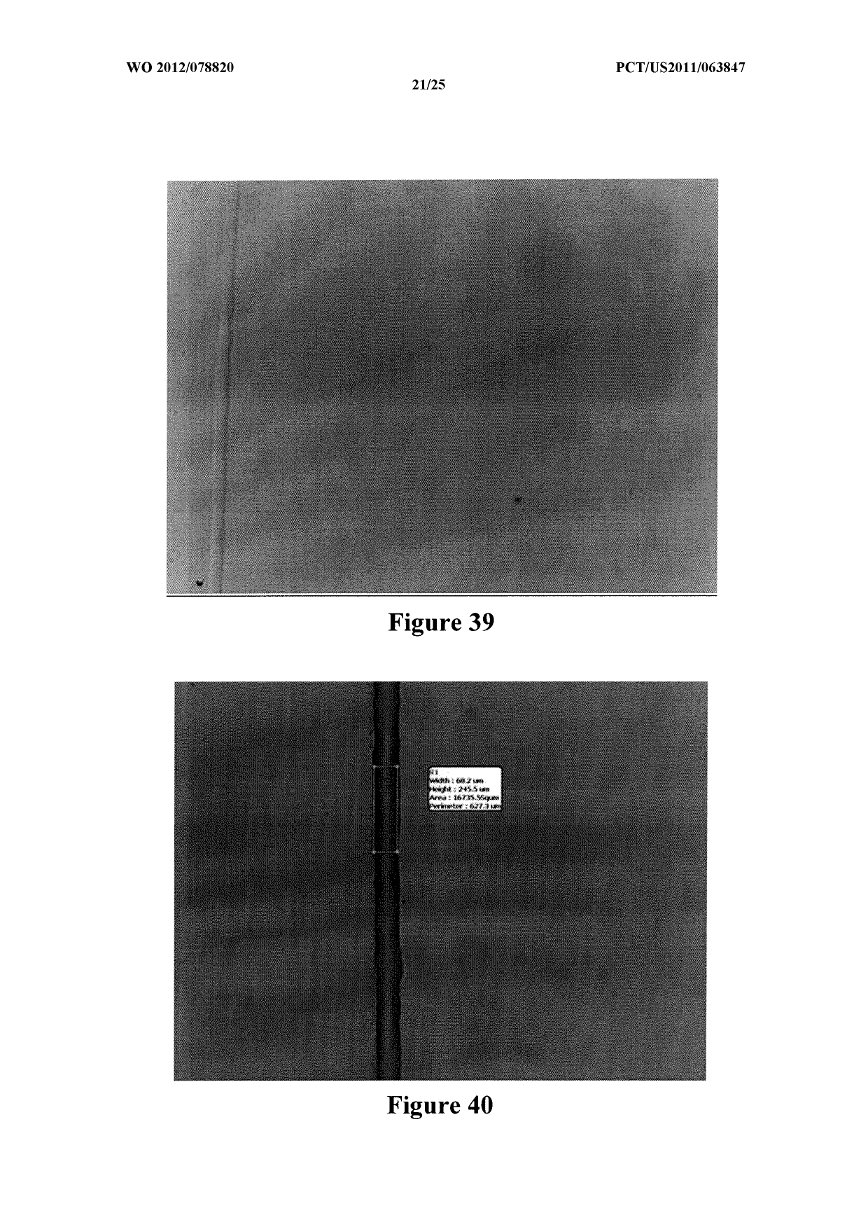

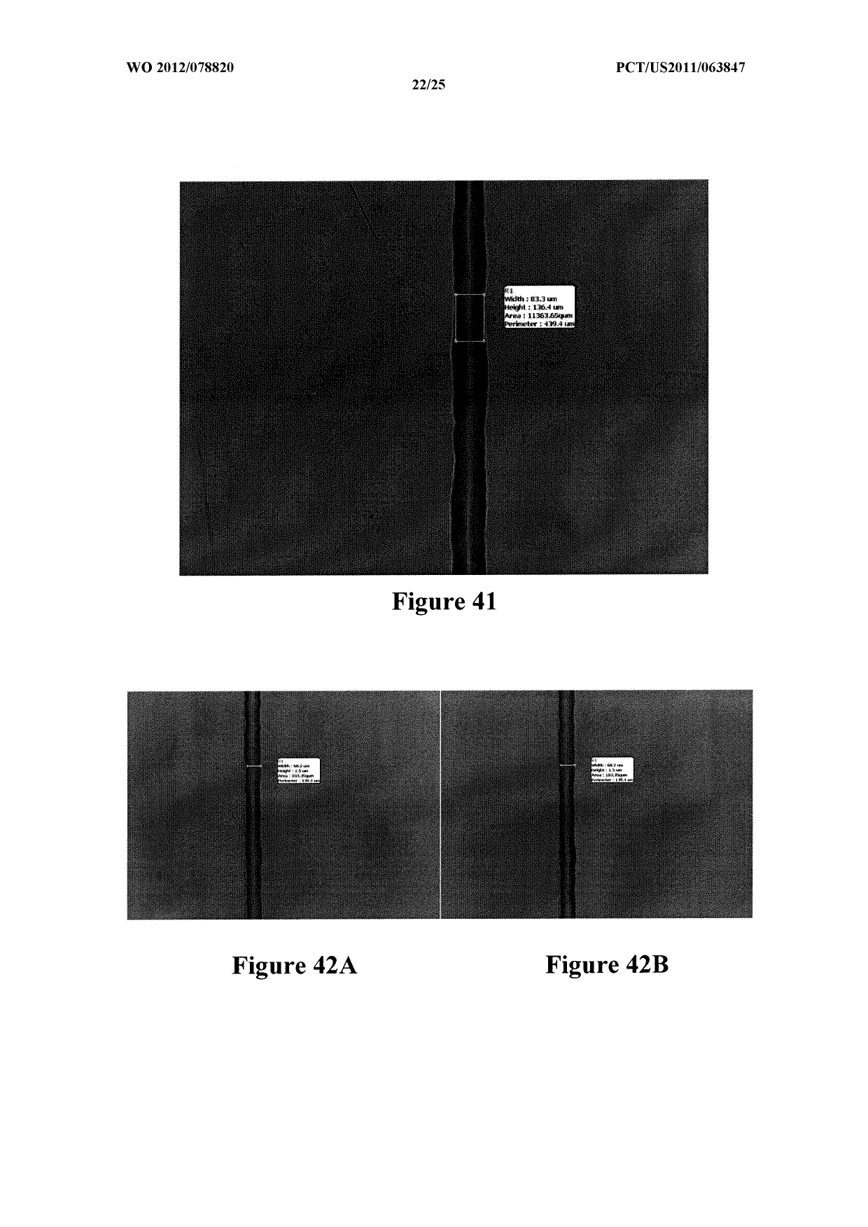

FIGS. 39-41 illustrate the results of printing Formulation 32-34, respectively, on ITO substrate using an Optomec M³D aerosol jet printer equipped with a 150 μm tip. The printing parameters, for Formulations 32-34, respectively, were set at: sheath flow rate=45/68/25 sccm, exhaust flow rate=750/1250/950 sccm, atomizer flow rate=850/1300/1000 sccm, and print speed=18/30/10 mm/s. The printed line widths are shown below in Table 16. The results demonstrated the fine line printing capability and good edge definition of Formulations 32-34. The printed lines had less than 10% variation in line width over the length of the printed trace.

TABLE 16
Printed line widths of Formulations 32-34 on ITO substrate

| | Formulation | | |
|---|---|---|---|
| | 32 | 33 | 34 |
| Width | 30 μm | 68.2 μm | 83.3 μm |

4. Adhesion

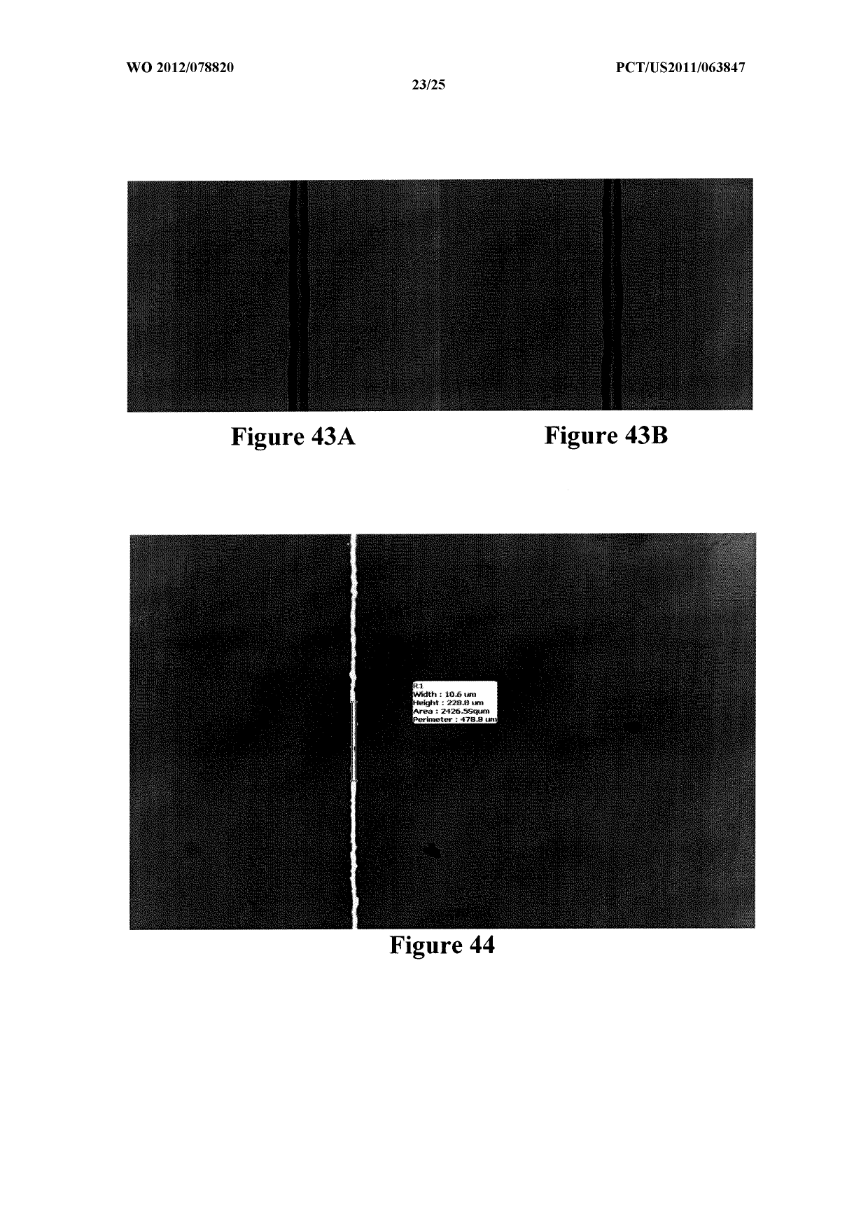

UV-curable dielectric ink Formulations 32-34 were printed on glass, ITO, and glass/ITO combined substrates by an Optomec M³D aerosol jet printer. The printed lines were UV-cured and thermally treated in a 150-250° C. oven for 30 minutes to simulate the silver sintering process. The adhesion of Formulations 32-34 on each substrate was measured using the adhesion tape test method (ASTM D3359-08). A strip of Scotch® Cellophane Film Tape 610 (3M, St. Paul, Minn.) was placed along the length of each print and pressed down by thumb twice to ensure a close bond between the tape and the print. While holding the print down with one hand, the tape was pulled off the print at approximately a 180° angle to the print. Adhesion performance was measured by estimating the percent of ink removed from each print by the tape and rating the performance by estimating the amount of ink removed from the print. Adhesion test results were classified as either “Excellent” (no ink removed), “Good” (minimal or slight amount of ink removed), or “Poor” (significant amount of ink removed). The adhesion of the printed dielectric material on each substrate up to 250° C. was very good, and the results are shown below in Table 17. Pictures of coupons before and after the tape test for Formulation 32 are shown in FIG. 42 and for Formulation 34 are shown in FIG. 43.

TABLE 17
Adhesion of Formulations 32-34 on various substrates

Formulation

| Substrate | 32 | 33 | 34 |
|---|---|---|---|
| Glass | Good adhesion | Good adhesion | Good adhesion |
| ITO | Good adhesion | Good adhesion | Good adhesion |
| Glass/ITO | Good adhesion | Good adhesion | Good adhesion |

5. Thermal Stability

UV-curable dielectric ink Formulations 32-34 were printed on glass substrate by an Optomec M³D aerosol jet printer. The printed lines were UV-cured and thermally treated in a 150-250° C. oven for 5-30 minutes to simulate the silver sintering process. Thermal stability with respect to optical clarity was evaluated by visually assessing the resistance to discoloration, especially yellowing, at various time points and various temperatures. The results were classified as either “Good” (no color change), “Fair” (light yellow), or “Poor” (dark yellow). The results are shown below in Tables 18-20.

TABLE 18
Thermal stability of Formulation 32 on glass substrate

| | 200° C. | 230° C. | 250° C. |
|---|---|---|---|
| 5 min | Good | Good | Good |
| 10 min | Good | Good | Fair |
| 20 min | Good | Poor | Poor |
| 30 min | Good | Poor | Poor |

TABLE 19
Thermal stability of Formulation 33 on glass substrate

| | 200° C. | 230° C. | 250° C. |
|---|---|---|---|
| 5 min | Good | Good | Good |
| 10 min | Good | Good | Fair |
| 20 min | Good | Poor | Poor |
| 30 min | Good | Poor | Poor |

TABLE 20
Thermal stability of Formulation 34 on glass substrate

| | 200° C. | 230° C. | 250° C. |
|---|---|---|---|
| 5 min | Good | Good | Good |
| 10 min | Good | Good | Good |
| 20 min | Good | Good | Good |
| 30 min | Good | Poor | Poor |

The results showed that all formulations were thermally stable at 200° C. for up to 30 minutes. Formulations 32 and 33 were thermally stable at 230° C. for up to 10 minutes and at 250° C. for up to 5 minutes. Formulation 34 was thermally stable at 230° C. and 250° C. for up to 20 minutes.

6. Compatibility with Aerosol Jet Silver Conductive Inks

The compatibility of UV-curable dielectric ink Formulations 32-34 with aerosol jet silver conductive inks was assessed on glass substrate, ITO substrate and glass/ITO substrate by measuring adhesion and print quality. Formulations 32-34 were printed on glass substrate by a 1 ml coating bar, followed by UV cure. A silver conductive aerosol jet ink, Sun Chemical's U6700, was printed by an Optomec M³D aerosol jet printer on the glass substrate on top of the UV-cured dielectric glass substrate, followed by sintering at 150-250° C. in an oven.

Adhesion of the printed silver line to the dielectric-coated substrate was measured using the adhesion tape test method (ASTM D3359-08) described above. The adhesion of the printed silver lines on the glass substrate coated with Formulations 32, 33 or 34 was very good.

The dimensions of the printed silver lines were measured by an optical microscope. The printed silver line dimension was between 10-200 μm, depending on the printing parameters. Table 21 and FIGS. 44-46 show the printed line dimensions of the silver lines printed on top of glass substrate coated with Formulations 32-34, respectively, using various printing parameters. FIG. 44 shows the results from printing Sun Chemical U6700 silver conductive ink on top of UV-curable dielectric Formulation 32 on glass substrate using an Optomec M³D aerosol jet printer equipped with a 100 μm tip. The printing parameters were set at a sheath flow rate of 10 sccm, exhaust flow rate of 500 sccm, atomizer flow rate of 533 sccm, and print speed of 40 mm/s (actual parameters: sheath flow rate=9 sccm, exhaust flow rate=506 sccm, atomizer flow rate=529 sccm, print speed=40 mm/s).

TABLE 21
Printed line widths of silver conductive ink U6700
on glass substrate coated with Formulations 32-34

| | Formulation | | |
|---|---|---|---|
| | 32 | 33 | 34 |
| Width | 10.6 μm | 10.6 μm | 15.2 μm |

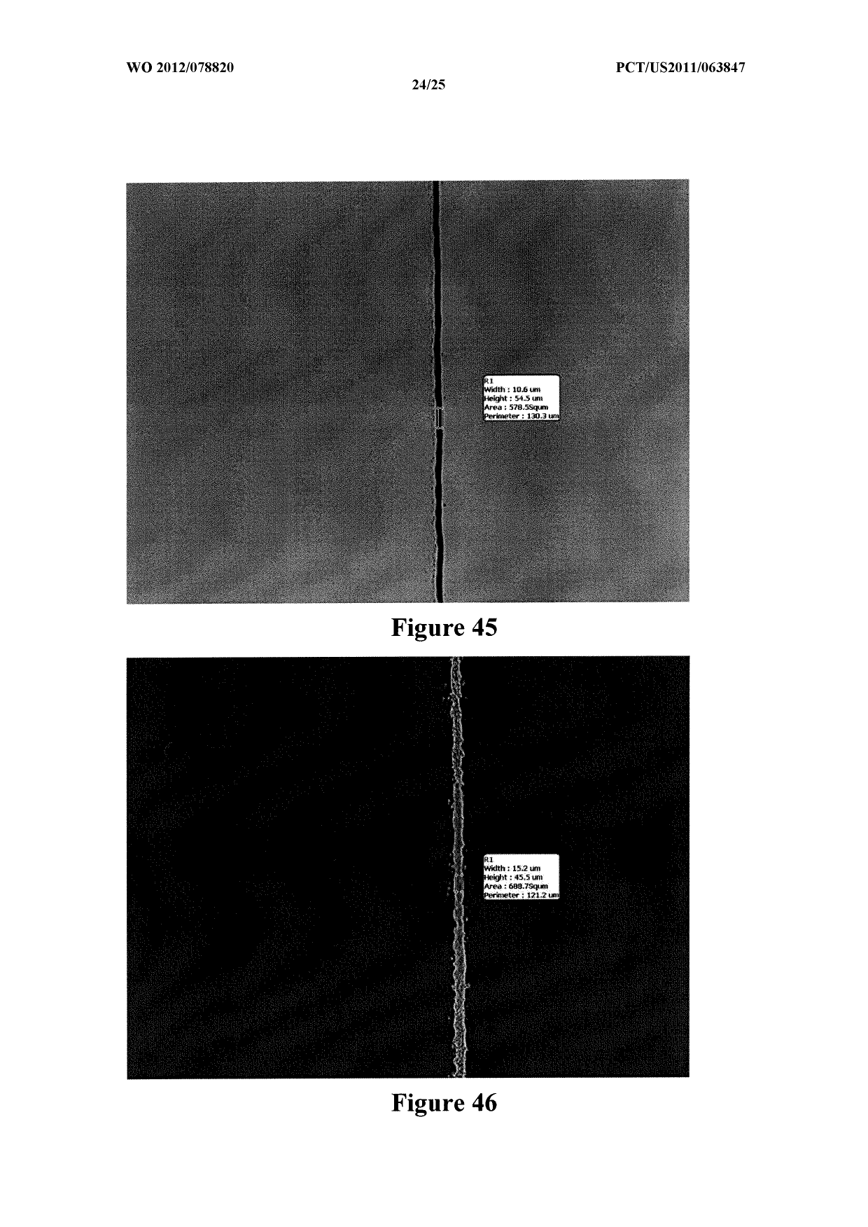

FIG. 45 illustrates the results from printing Sun Chemical U6700 silver conductive ink on top of UV-curable dielectric Formulation 33 on glass substrate using an Optomec M³D aerosol jet printer equipped with a 100 μm tip. The printing parameters were set at a sheath flow rate of 35 sccm, exhaust flow rate of 650 sccm, atomizer flow rate of 670 sccm, and print speed of 35 mm/s (actual parameters: sheath flow rate=34 sccm, exhaust flow rate=656 sccm, atomizer flow rate=670 sccm, print speed=45 mm/s).

FIG. 46 shows the results from printing Sun Chemical U6700 silver conductive ink on top of UV-curable dielectric Formulation 34 on glass substrate using an Optomec M³D aerosol jet printer equipped with a 150 μm tip. The printing parameters were set at a sheath flow rate of 75 sccm, exhaust flow rate of 600 seem, atomizer flow rate of 610 sccm, and print speed of 60 mm/s.

The edge definition, print quality and adhesion of the printed silver lines on the dielectric ink-coated substrate are very good (i.e. good resolution and smooth edge), indicating that Formulations 32-34 are compatible with aerosol jet silver conductive inks, such as those used for displays and touch screen applications.

7. Effect of Surface Treatment

Print quality can be dramatically and deleteriously affected by a significant difference in the surface energies of adjacent substrates when printing on substrates made of two distinct materials (e.g., combination glass/ITO substrates). The surface energies of glass and ITO and contact angles of fluids on the substrates were assessed before and after surface treatment. The contact angles of water, diiodomethane and Formulation 32 were measured on glass and ITO using a FIBRO DAT 1100 dynamic absorption and contact angle tester (Thwing-Albert, West Berlin, N.J.). The measured contact angle values were used to calculate the total surface energy, a combination of dispersion energy and polar energy, using the Owens and Wendt model (Owens and Wendt, J. Appl. Polymer Sci. 13:1741 (1979)). Contact angles were measured before and after surface treatment via ultrasonic cleaning in isopropanol for 5 minutes or plasma treatment with a simple vacuum N₂ discharge which provided both radical bombardment of the surface and significant ultraviolet light exposure. Plasma treatment was done using a Plasma Etch PE-050 system (Carson City, Nev. USA) using nitrogen gas and a power setting of 100 W for 3 to 5 minutes. Printing should directly follow application of the plasma treatment without rinsing the substrate. If rinsing is necessary, rinsing may be done with an alcohol, such as a C₁-C₄ alcohol, e.g., isopropanol, but rinsing with water should be avoided.

The surface energies and contact angles of the various fluids are shown below in Table 22.

TABLE 22
Surface energies and contact angles of glass
and ITO before and after surface treatment

| | |
|---|---|
| | Treated by IPA/ |
| Untreated | ultrasonic cleaning |

| | ITO | Glass | ITO | Glass |
|---|---|---|---|---|
| Contact Angle | | | | |
| Water | 82° ± 4 | 26° ± 4 | 57° ± 3 | 39° ± 5 |
| Diiodomethane | 51° ± 4 | 52° ± 4 | 37° ± 5 | 34° ± 1 |
| Formulation 32 | 39° ± 3 | 14° ± 1 | 11° ± 1 | 10° ± 1 |
| Surface energy | | | | |
| (dyne/cm) | | | | |
| Polar | 3.8 | 34.9 | 13.6 | 23.1 |
| Dispersive | 34 | 33.4 | 41.3 | 42.4 |
| Total | 37.4 | 68.3 | 54.9 | 65.5 |

Table 22 shows that ITO and glass had dramatically different surface energies before surface treatment. After treating the surface by IPA/ultrasonic cleaning, the surface energies of the glass and ITO substrates were much more closely matched. After treatment with N₂ discharge the surface energies were unity.

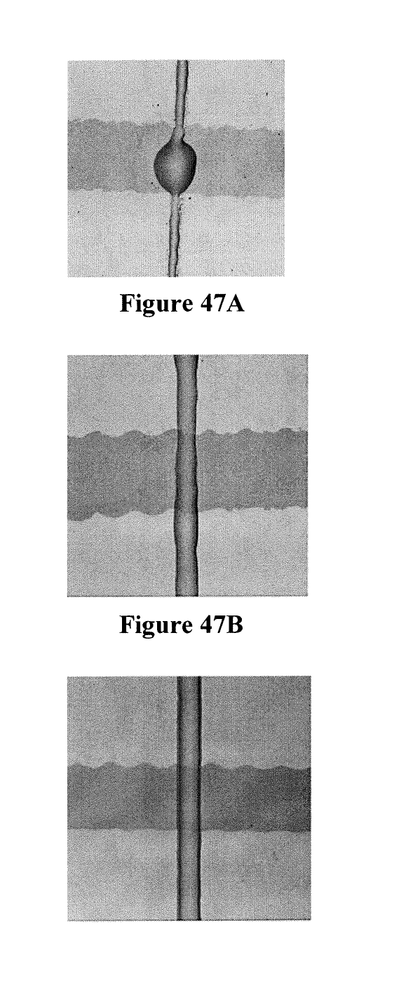

The wetting (spreading) properties of the untreated and treated substrates were measured by printing Formulation 32 on untreated and treated glass/ITO substrate using a fourteen jet/nozzle array at 5 mm nozzle-to-nozzle pitch. After deposition, the printed lines were UV-cured using a Fusion UV System Light Hammer 6. FIG. 47A shows the results of printing on untreated glass/ITO substrate. Because of the significant difference in polarity of the glass and ITO, the ITO caused a slight pull-back of the ink after deposition, but significant spreading of the same ink on the glass portion. After 5 minutes of IPA/ultrasonic treatment, as shown in FIG. 47B, the surface energies of the glass and ITO substrates were more closely matched, which resulted in a significant decrease in spreading. Treatment with N2 plasma gave the best results, as shown in FIG. 47C. The spreading ratio of the ink on the glass versus the ITO portions were unity.

C. Comparison to Commercial Dielectric Inks

A series of commercially available dielectric inks were assessed over an 8 hour extended print run using an Optomec M³D aerosol jet printer equipped with a pneumatic atomization system. Commercially available dielectric inks Kerimid and Matimid (DuPont, Wilmington, Del.); Suntronic Solisys UN-curable dielectric CFSN6052 and CFSN6057, with and without pigment (Sun Chemical, Parsippany, N.J.); SMP polyimide precursor (SMP Corporation, Covington, Ga.); and CA1000, BS1000 and BS2000 (undisclosed suppliers) were tested for performance indicators such as transparency, print quality, extended print time and adhesion to various substrates. Many of these inks are commercial inks optimized for inkjet printing.

The tested comparative commercial dielectric inks were not suitable for printing with an aerosol jet printer, in contrast to Formulations 32-34. At the beginning of the print trial, it was very difficult or not possible to produce printed lines with a thickness less than 50 microns with the tested commercial comparative because of ink spread due to the low viscosity of the inks, even with inks containing 40 wt % silver. During the 8 hour print trial, the comparative commercial inks lost a significant amount of solvent or monomer (>10%), significantly increasing the viscosity and printed dimension (>10%), which resulted in the inks drying out. The solvent loss and viscosity increase may be attributed to the presence of low boiling point and high vapor pressure solvents or monomers.

The present invention has been described in detail, including the preferred embodiments thereof, but is more broadly applicable as will be understood by those skilled in the art. It will be appreciated that those skilled in the art, upon consideration of the present disclosure, may make modifications and/or improvements on this invention that fall within the scope and spirit of the invention. Since modifications will be apparent to those of skill in this art, it is intended that this invention be limited only by the scope of the following claims.

1. An aerosol jet metal conductive ink for aerosol jet printing, comprising:
coated or uncoated metal particles; and
a high boiling point and low vapor pressure solvent or mixture of solvents;
wherein the viscosity of the ink is not greater than 1000 cP at a shear rate of at or about 10 sec⁻¹ at 25° C.

2. The aerosol jet metal conductive ink of claim 1, wherein the viscosity of the ink is greater than 20 cP at a shear rate of at or about 10 sec⁻¹ at 25° C.

3. The aerosol jet metal conductive ink of claim 1, wherein the viscosity of the ink is greater than 20 cP at a shear rate of at or about 10 sec⁻¹ at aerosol jet printing operating temperature.

4. The aerosol jet metal conductive ink of claim 1, wherein the metal particles are coated with a glass layer or metal layer or metal oxide layer or a combination thereof.

5. The aerosol jet metal conductive ink of claim 1, further comprising a dispersant or mixture of dispersants.

6. The aerosol jet metal conductive ink of claim 1, further comprising an adhesion promoter.

7. The aerosol jet metal conductive ink of claim 1, further comprising an additive.

8. The aerosol jet metal conductive ink of claim 1, wherein the solvent has a vapor pressure lower than 1 mmHg or lower than 0.1 mmHg at room temperature.

9. The aerosol jet metal conductive ink of claim 1, wherein the solvent have a vapor pressure lower than 0.1 mmHg at room temperature.

10. The aerosol jet metal conductive ink of claim 1, wherein the metal particles contain a metal selected from among silver, gold, copper, gallium, nickel, palladium, cobalt, chromium, platinum, tantalum, indium, tungsten, tin, zinc, lead, chromium, ruthenium, iron, rhodium, iridium and osmium and combinations thereof.

11. The aerosol jet metal conductive ink of claim 1, wherein the viscosity of the ink is not greater than 200 cP at a shear rate of about 10 sec⁻¹ at room temperature.

12. The aerosol jet metal conductive ink of claim 1 having a surface tension of from 1 dynes/cm to 250 dynes/cm.

13. The aerosol jet metal conductive ink of claim 1, wherein the metal particles have an average particle diameter ranging from 1 nm to 1000 nm or from 5 nm to 500 nm.

14. The aerosol jet metal conductive ink of claim 1, wherein the metal particles have a shape selected from among cubes, flakes, granules, cylinders, rings, rods, needles, prisms, disks, fibers, pyramids, spheres, spheroids, prolate spheroids, oblate spheroids, ellipsoids, ovoids and random non-geometric shapes.

15. The aerosol jet metal conductive ink of claim 1, wherein the metal particles are spherical or flake shaped with a particle size distribution that is a single or a bimodal distribution.

16. The aerosol jet metal conductive ink of claim 1, wherein the particle size distribution has a D50 of less than 1 micron.

17. The aerosol jet metal conductive ink of claim 1, wherein the particle size distribution has a D90 of less than 1 micron.

18. The aerosol jet metal conductive ink of claim 1, wherein the metal particles contain on their surface an organo-coating that is a reducing agent.

19. The aerosol jet metal conductive ink of claim 18, wherein the reducing agent is polyvinylpyrrolidone.

20. The aerosol jet metal conductive ink of claim 1, wherein the metal particles contain on their surface an organic substance or a polymer or both.

21. The aerosol jet metal conductive ink of claim 1, wherein the metal particles contain on their surface a dispersant or an anti-agglomeration agent or both.

22. The aerosol jet metal conductive ink of claim 1, wherein the metal particles are present at a concentration of 10-90% based on the weight of the ink.

23. The aerosol jet metal conductive ink of claim 1, wherein the solvent or solvents are present in an amount of not more than 90% based on the weight of the ink.

24. The aerosol jet metal conductive ink of claim 1, wherein the solvent is selected from among diethylene glycol monobutyl ether; 2-(2-ethoxyethoxy)ethyl acetate; ethylene glycol; terpineol; trimethylpentanediol monoisobutyrate; 2,2,4-trimethyl-1,3-pentanediol monoisobutyrate (texanol); dipropylene glycol monoethyl ether acetate; tripropylene glycol n-butyl ether; propylene glycol phenyl ether; dipropylene glycol n-butyl ether; dimethyl glutarate; dibasic ester mixture of dimethyl glutarate and dimethyl succinate; tetradecane, glycerol; phenoxy ethanol; dipropylene glycol; benzyl alcohol; acetophenone; 2,4-heptanediol; gamma-butyrolactone; phenyl carbitol; methyl carbitol; hexylene glycol; diethylene glycol monoethyl ether; 2-butoxyethanol; 1,2-dibutoxy ethane; 3-butoxybutanol; and N-methylpyrrolidone

25. The aerosol jet metal conductive ink of claim 1, further comprising a high vapor pressure solvent in an amount of not more than 5% based on the weight of the ink.

26. The aerosol jet metal conductive ink of claim 5, wherein the dispersant is present in an amount ranging from 1% to 10% based on the weight of the ink.

27. The aerosol jet metal conductive ink of claim 5, wherein the dispersant is a phosphoric acid polyester, a structured acrylic copolymer, a solid polyethyleneimine core grafted with polyester hyperdispersant, a polycarboxylate ether or a poly(alkylene oxide)amine in which the alkylene oxide group contains 1 to 5 carbon atoms and a polyether backbone based on propylene oxide, ethylene oxide or both, and combinations of these dispersants.

28. The aerosol jet metal conductive ink of claim 5, wherein the dispersant is at least one reaction product of at least one dianhydride with at least two different reactants, each of which reactants contains a primary or secondary amino, hydroxyl or thiol functional group, and at least one of which reactants is polymeric.

29. The aerosol jet metal conductive ink of claim 5, wherein the dispersant is: 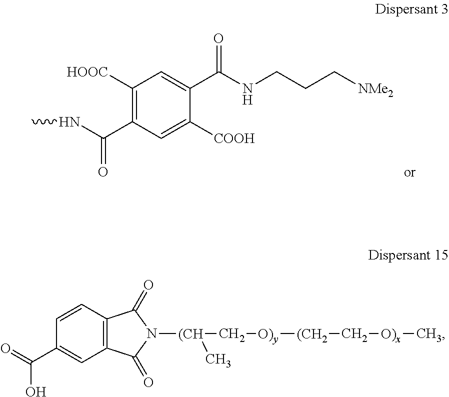
wherein:
the moiety 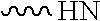
represents: 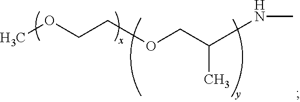
x=0 to 60;
y=0 to 60; and
x+y is between 5 and 60.

30. The aerosol jet metal conductive ink of claim 6, wherein the adhesion promoter is present in an amount ranging from 0.1% to 5% based on the weight of the ink.

31. The aerosol jet metal conductive ink of claim 4, wherein the adhesion promoter is selected from among a silane coupling agent, bismuth nitrate, a titanate, a blocked isocyanate, a multi-functional zirconate, a multi-functional aluminate and titanium diisopropoxide.

32. The aerosol jet metal conductive ink of claim 7, wherein the additive is selected from among a surfactant, a rheology modifier, a biocide, a defoaming agent, a crystallization inhibitor and combinations thereof.

33. The aerosol jet metal conductive ink of claim 7, wherein the additive is present in an amount from 0.1% to 5% based on the weight of the ink.

34. The aerosol jet metal conductive ink of claim 3, wherein the metal particles are:
silver and are coated in glass;
have a diameter from 1 nm to 1000 nm; and
are present in an amount that is a range of from 10% to 90% by weight of the ink.

35. The aerosol jet metal conductive ink of claim 3, wherein: the metal particles are silver and are coated in glass;
the metal particles have a diameter from 1 nm to 500 nm;
the metal particles are present in an amount that is in a range of from 50% to 90% by weight of the ink; and
the dispersant is present in an amount that is in a range of from 1% to 10% based on the weight of the ink.

36. A method of preparing the aerosol jet metal conductive ink of claim 1, comprising:
selecting as ingredients a coated or uncoated metal particle, a high boiling point and low vapor pressure solvent or mixture of solvents, and optionally a dispersant or mixture of dispersants, an adhesion promoter, and additive or combinations thereof; and mixing the ingredients until combined to yield the aerosol jet metal conductive ink.

37. The method of claim 36, further comprising filtering the aerosol jet metal conductive ink.

38. A method of aerosol jet printing, comprising:
aerosol jet application of an aerosol jet metal conductive ink of claim 1 to a substrate to form an ink layer on the substrate.

39. The method of claim 38, further comprising the step of heating the ink layer.

40. The method of claim 39, wherein the step of heating of the ink layer is performed by sintering in an oven or treating with a photonic curing process or by induction.

41. The method of claim 40, wherein the oven is a conduction oven, a furnace, a convection oven or an IR oven.

42. The method of claim 40, wherein the photonic curing process includes treatment using a highly focused laser or a pulsed light sintering system.

43. The method of claim 38, wherein the substrate is a part of a photovoltaic device.

44. The method of claim 38, wherein photovoltaic device includes as a component an amorphous silicon, a crystalline silicon, a CIGS (copper, indium, gallium, selenium) thin film, cadmium telluride, polyphenylene vinylene, a ruthenium metallo-organic dye or combinations thereof.

45. The method of claim 38, wherein the substrate is a solar cell wafer.

46. The method of claim 38, wherein the substrate is selected from among glass, indium tin oxide (ITO), a polymer substrate, BT (Resin)—rigid printed circuit boards (PCBs), FR-4 (Flame Resistant 4)—rigid PCBs, polyimide film—flex circuits, a molybdenum (Mo) coating—flat panel display (FPD), polyethylene terephthalate (PET)—flex circuits, silica (SiO₂)—FPD, silicon (Si)—semiconductors, silicon nitride (Si₃N₄), SiNₓ coated multicrystalline and single crystalline wafers, polyethylene naphthalate (PEN), polyetherimides, polyamides, and polyamide-imides copolymers.

47. The method of claim 46, wherein the polymer substrate is selected from among a polyfluorinated compounds, polyimides, epoxies, polycarbonates, acrylates, acetates, nylons, polyesters, polyethylenes, polypropylenes, polyvinyl chlorides, acrylonitriles, polyethylene terephthalate, butadiene (ABS), styrene, poly(methyl methacrylate), silicone nitride, polyethylene naphthalate (PEN), polyetherimides, polyamide and polyamide-imides and combinations thereof.

48. The method of claim 46, wherein the polymer substrate is present as a coating on an object.

49. The method of claim 48, wherein the object is selected from among glass, a flexible fiber board, a non-woven polymeric fabric, a cloth, a plastic, a metallic foil, and a cellulose-based material.

50-98. (canceled)
